(19) United States
(12) Patent Application Publication
(10) Pub. No.: US 2026/0075279 A1
(43) Pub. Date: Mar. 12, 2026

(54) METHOD, DISPLAY SYSTEM, AND INFORMATION PROCESSING APPARATUS

(71) Applicants: Taira Oyama, KANAGAWA (JP); Susumu Fujioka, KANAGAWA (JP)

(72) Inventors: Taira Oyama, KANAGAWA (JP); Susumu Fujioka, KANAGAWA (JP)

(73) Assignee: Ricoh Company, Ltd., Tokyo (JP)

(21) Appl. No.: 19/317,615

(22) Filed: Sep. 3, 2025

(30) Foreign Application Priority Data
Sep. 9, 2024 (JP) 2024-154862
Mar. 11, 2025 (JP) 2025-038242

(51) Int. Cl. H04N 21/431; G06F 3/0482; G06F 3/0485; H04N 21/442; H04N 21/81

(52) U.S. Cl. CPC H04N 21/4314; G06F 3/0482; G06F 3/0485; H04N 21/44222; H04N 21/8146

(57) ABSTRACT

A method includes displaying contents input to a display extension region in response to scrolling of a display region, extracting one or more contents from the contents input to the display extension region based on one or more types of the contents, and aggregating the one or more contents in the display region.

### CROSS-REFERENCE TO RELATED APPLICATIONS

This patent application is based on and claims priority pursuant to 35 U.S.C. § 119 (a) to Japanese Patent Application Nos. 2024-154862, filed on Sep. 9, 2024 and 2025-038242, filed on Mar. 11, 2025, in the Japan Patent Office, the entire disclosure of which is hereby incorporated by reference herein.

### BACKGROUND

### Technical Field

The present disclosure relates to a method, a display system, and an information processing apparatus.

### Related Art

In an information processing apparatus such as an electronic whiteboard that allows a user to input handwriting, a technique has been proposed in which a content input to a display region is moved to outside the display region and a region larger than the display region (referred to as a display extension region in the following description) is made available. Also, another technique has been proposed in which a search result for contents is collectively displayed on a single electronic whiteboard. For example, one technique is disclosed in which an electronic whiteboard divides each electronic whiteboard sheet subjected to searching into multiple areas and extracts one or more of the multiple areas that satisfy the search condition. Then, the electronic whiteboard causes a client communication terminal that is a searching request source to display a screen on which the extracted areas are presented in a list.

### SUMMARY

The present disclosure described herein provides a method including displaying contents input to a display extension region in response to scrolling of a display region, extracting one or more contents from the contents input to the display extension region based on one or more types of the contents, and aggregating the one or more contents in the display region.

The present disclosure described herein provides a display system that includes a first information processing apparatus including first circuitry to display contents input to a display extension region in response to scrolling of a display region and a second information processing apparatus communicable with the first information processing apparatus via a network. The second information processing apparatus includes second circuitry to display a virtual whiteboard synchronized with the display region and a virtual space in which the contents moved to the display extension region are arranged. The second circuitry is further to extract one or more contents from the contents arranged in the virtual space based on one or more types of the contents and aggregate the one or more contents on the virtual whiteboard. The first circuitry is further to receive display data of the one or more contents aggregated on the virtual whiteboard from the second information processing apparatus and display the one or more contents based on the display data.

The present disclosure described herein provides an information processing apparatus including circuitry to display contents input to a display extension region in response to scrolling of a display region, extract one or more contents from the contents input to the display extension region based on one or more types of the contents, aggregate the one or more contents in the display region, and cause the one or more contents to be displayed.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overview of aggregation display;

FIG. 2 is a schematic diagram illustrating a configuration of a display system;

FIG. 3 is a block diagram illustrating a hardware configuration of an electronic whiteboard;

FIG. 4 is a block diagram illustrating a hardware configuration of a tablet personal computer (PC);

FIG. 5 is a block diagram illustrating function configurations of an electronic whiteboard and a tablet PC included in a display system;

FIG. 6 is a diagram illustrating a correspondence between a display extension region and a display region;

FIG. 7 is a diagram illustrating a method for copying a screen of a PC connected to an electronic whiteboard to the electronic whiteboard;

FIG. 8 is a diagram illustrating a screen of an electronic whiteboard when a part of a screen of a PC is copied to the electronic whiteboard;

FIG. 9 is a diagram illustrating a display extension region in which multiple contents are arranged;

FIG. 10 is a schematic diagram illustrating a content management table that a content management unit manages in a data storage unit;

FIG. 11 is a diagram illustrating a condition setting screen;

FIG. 12 is a diagram illustrating a content to be displayed in a display region when a graph is selected in a type-designation field;

FIG. 13 is a diagram illustrating an arrangement rule using contents A to F;

FIG. 14 is a diagram illustrating the arrangement rule using the contents A to F;

FIG. 15 is a diagram illustrating an example of the contents A to F after the reduction of the sizes;

FIG. 16 is a diagram illustrating another example of the contents A to F after the reduction of the sizes;

FIG. 17 is a diagram illustrating how contents are arranged;

FIG. 18 is a diagram illustrating the coordinates of contents before the reduction of the sizes;

FIG. 19 is a diagram illustrating contents whose sizes are reduced by a reduction ratio;

FIG. 20 is a flowchart of a process performed by an electronic whiteboard to aggregate and display contents;

FIG. 21 is a schematic diagram illustrating a configuration of a virtual conference system;

FIG. 22 is a block diagram illustrating a hardware configuration of virtual reality (VR) goggles;

FIG. 23 is a block diagram illustrating a hardware configuration of a VR operation controller;

FIG. 24 is a block diagram illustrating a hardware configuration of a virtual conference server;

FIG. 25 is a block diagram illustrating functional configurations of a virtual conference server and an electronic whiteboard;

FIG. 26 is a block diagram illustrating functional configurations of a virtual conference server, a PC, VR goggles, and a VR operation controller;

FIG. 27 is a diagram illustrating a display example of a virtual conference space displayed on VR goggles;

FIG. 28 is a sequence diagram illustrating a process for drawing handwriting performed by a VR operation controller;

FIG. 29 is a sequence diagram illustrating a process for drawing handwriting in an electronic whiteboard;

FIG. 30A is a diagram illustrating a display example of an electronic whiteboard;

FIG. 30B is a diagram illustrating a display example of a virtual conference space;

FIG. 31 is a diagram illustrating a virtual conference space in which a content is moved to the left;

FIG. 32 is a diagram illustrating a content management table that a content management unit manages;

FIG. 33 is a diagram illustrating a screen image of virtual PC screen data in a virtual conference space;

FIG. 34 is a diagram illustrating a content on a screen image of virtual whiteboard (data) displayed by an electronic whiteboard;

FIG. 35 is a diagram illustrating contents and a screen image of virtual PC screen data present in a virtual conference space;

FIG. 36 is a diagram illustrating a virtual conference space in which a content that was on a virtual whiteboard has been moved upward;

FIG. 37 is a diagram illustrating a content management table managed by a content management unit for contents in the virtual conference space of FIG. 36;

FIG. 38 is a diagram illustrating a content that is handwriting on an electronic whiteboard;

FIG. 39 is a diagram illustrating a screen image of a virtual whiteboard in a virtual conference space, which is synchronized with drawing data of handwriting on an electronic whiteboard;

FIG. 40 is a diagram illustrating a content management table managed by a content management unit for contents in the virtual conference space of FIG. 39;

FIG. 41 is a diagram illustrating a screen image of a virtual whiteboard on which a content is arranged on the upper side and another content is arranged on the lower side;

FIG. 42A is a diagram illustrating a screen image of a virtual whiteboard after the reduction of the sizes of contents;

FIG. 42B is a diagram illustrating contents that an electronic whiteboard displays on a display;

FIG. 43 is a sequence diagram illustrating processes or operations performed by a virtual conference system;

FIG. 44 is a schematic diagram illustrating a configuration of a display system according to a third embodiment;

FIG. 45 is a block diagram illustrating a functional configuration of a conference server according to the third embodiment;

FIG. 46 is a block diagram illustrating a functional configuration of an electronic whiteboard according to the third embodiment;

FIG. 47 is a block diagram illustrating a functional configuration of a tablet PC according to the third embodiment;

FIG. 48 is a sequence diagram illustrating a process for starting a remote conference among an electronic whiteboard and two tablet PCs via a conference server;

FIG. 49 is a diagram illustrating an example of a screen that an electronic whiteboard causes a display to display;

FIG. 50 is a diagram illustrating another example of a screen that an electronic whiteboard causes a display to display;

FIG. 51 is a sequence diagram illustrating a synchronization process among an electronic whiteboard and tablet PCs;

FIG. 52 is a diagram illustrating an example of contents arranged in a display extension region;

FIG. 53 is a diagram illustrating another example of contents arranged in a display extension region;

FIG. 54 is a sequence diagram illustrating a process for arranging multiple contents in a whiteboard region;

FIG. 55 is a flowchart of operations performed by a conference server after the conference server receives a content that is a bar graph from an electronic whiteboard;

FIG. 56 is a sequence diagram illustrating a transmission process using an edit flag;

FIG. 57 is a diagram illustrating an example of a screen that an electronic whiteboard causes a display to display;

FIG. 58 is a diagram illustrating a content that an electronic whiteboard causes a display to display;

FIG. 59 is a diagram illustrating a thumbnail in which a whiteboard region of a tablet PC is presented in a reduced size;

FIG. 60 is a sequence diagram illustrating a process for erasing an edit flag;

FIG. 61 is a diagram illustrating how contents are arranged in a display extension region;

FIG. 62 is a diagram illustrating contents that an electronic whiteboard displays in a whiteboard region;

FIG. 63 is a diagram illustrating a condition setting screen that an electronic whiteboard displays;

FIG. 64 is a sequence diagram illustrating a process for transmitting contents to an electronic whiteboard and tablet PCs;

FIG. 65 is a diagram illustrating contents that an electronic whiteboard displays in a whiteboard region;

FIG. 66 is a block diagram illustrating a functional configuration of a conference server according to a fifth embodiment;

FIG. 67 is a diagram illustrating examples of correspondence between instruction sentences used for instruction tuning and outputs (tasks) corresponding to the instruction sentences; and

FIG. 68 is a flowchart of a process performed by a conference server when receiving an instruction of aggregation display by voice.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An electronic whiteboard and a display method performed by the electronic whiteboard are described below with reference to the drawings.

### Overview of Aggregation Display

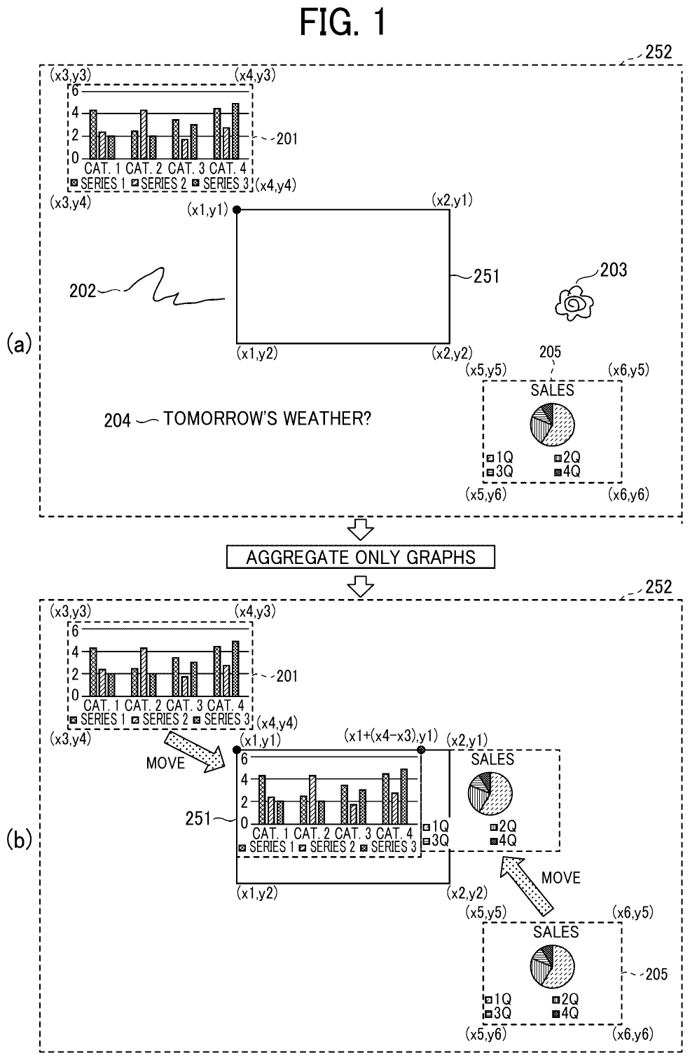

FIG. 1 is a diagram illustrating an overview of aggregation display. An electronic whiteboard according to one aspect of the present disclosure aggregates and displays on the screen only the types of content that a user desires to see. As illustrated in part (a) of FIG. 1, multiple contents 201 to 205 are present in a display extension region 252. These contents may be contents handwritten (hand drafted) or may be contents imported from a personal computer (PC) connected to the electronic whiteboard.

When the contents in the display extension region 252 are to be aggregated and displayed, the user is allowed to set the type of content to be aggregated and displayed. For example, it is assumed that the user selects a content type of “graph (image).” The electronic whiteboard automatically determines the type of each content. As illustrated in part (b) of FIG. 1, the electronic whiteboard extracts the contents 201 and 205 that are determined to be graphs and arranges the contents 201 and 205 in order from the upper-left corner of a display region 251. When the contents 201 and 205 do not fit within the display region 251, the electronic whiteboard reduces the sizes of the contents accordingly.

As described above, the electronic whiteboard according to one aspect of the present disclosure aggregates and displays in the display region 251 only the type of content that the user desires to see. Thus, even when many contents are present in the display extension region 252, each content can be prevented from becoming excessively small. Accordingly, the screen becomes easier to view compared to the conventional approach.

### Terminology

A device may be any device that displays a content such as an image based on drawing data. Examples of the device include, but are not limited to, an electronic whiteboard, a tablet personal computer (PC), a laptop PC, a smartphone, and a projector.

The content refers to data that is input to or displayed in a display region of the electronic whiteboard. The content includes, for example, drawing data of handwriting, text data (a font), a figure, screen data, and an image, and may be any data that can be displayed. The drawing data refers to one or more writing lines created by handwriting. The drawing data may be referred to as handwritten data.

The electronic whiteboard is a device that displays, as an image on a display in real time, drawing data of handwriting made using a touch panel of a figure that is formatted. The electronic whiteboard may have, for example, a function of connecting to a network and a function of converting handwritten text into font data using optical character recognition (OCR).

The display region refers to a region corresponding to a single screen on which the device displays contents. The display extension region refers to a region obtained by extending the display region and is larger than the display region.

### First Embodiment

### Configuration of System

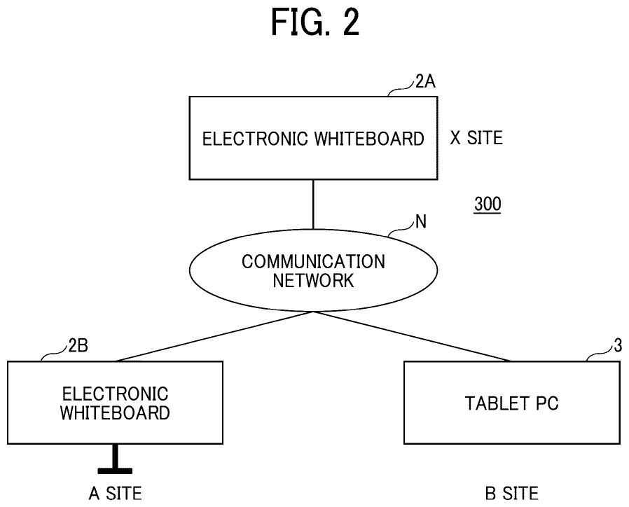

With reference to FIG. 2, a configuration of a display system 300 is described below. FIG. 2 is a schematic diagram illustrating the configuration of the display system 300. An electronic whiteboard 2A is located at an X site, an electronic whiteboard 2B is located at an A site, and a tablet PC 3 is located at a B site. In the display system 300, the devices at the respective sites are communicably connected to the electronic whiteboard 2A through a communication network N. The devices are the electronic whiteboard 2B and the tablet PC 3, which are given by way of example.

The communication network N is, for example, the Internet, but may be an on-premises network such as an in-house network. The number of devices and the number of sites are merely examples, and the electronic whiteboard 2A may be provided alone. The number of devices may be two or more, and multiple devices may be located at a single site. The electronic whiteboard 2A (an example of a first information processing apparatus) is an example of an information processing apparatus that aggregates and displays contents in one aspect of the present disclosure. The electronic whiteboard 2B has substantially the same functions as those of the electronic whiteboard 2A. The electronic whiteboard 2A and the electronic whiteboard 2B may be collectively referred to as “electronic whiteboards 2” and each of which may be referred to as an “electronic whiteboard 2.” The electronic whiteboard 2A manages, for example, conference information. The electronic whiteboard 2A also manages, for example, the start and end of a conference and the login of participants. The service provided by a conference application executed on the electronic whiteboard 2A is referred to as a conference service.

The electronic whiteboard 2B (an example of a second information processing apparatus) and the tablet PC 3 are examples of information processing apparatuses operated by the participants (users) of the conference. The information processing apparatus is not limited to the electronic whiteboard 2B or the tablet PC 3, but may be any information processing apparatus that has a communication function and executes the conference application, such as a PC, a smartphone, or a personal digital assistant (PDA).

The electronic whiteboard 2 and the tablet PC 3 each preferably include a touch panel. The user can handwrite on the touch panel using an electronic pen or a fingertip. Even when the electronic whiteboard 2 does not include a touch panel, the user can handwrite using a pointing device such as a mouse. The electronic whiteboard 2 and the tablet PC 3 display, in addition to a content representing drawing data of handwriting, other contents such as text converted from drawing data, text input by voice, a figure, and a screen of a PC, and these contents can also be shared among the devices at the respective sites.

The electronic whiteboard 2B and the tablet PC 3 are connectable to the electronic whiteboard 2A. In other words, the display system 300 can be used for online conferencing. Since the contents input to the electronic whiteboards 2A and 2B and the tablet PC 3 are combined in a single screen, the contents can be shared among the devices at the respective sites. The internet protocol (IP) address and password of the electronic whiteboard 2A are preset in the electronic whiteboard 2B and the tablet PC 3, or are distributed to the participants in advance, for example, by e-mail.

When the electronic whiteboards 2A and 2B and the tablet PC 3 participate in an online conference, the electronic whiteboard 2A transmits the display data of the content and the audio data input to the electronic whiteboard 2A to the electronic whiteboard 2B and the tablet PC 3. Similarly, the display data of the content and the audio data input to the electronic whiteboard 2B are transmitted to the electronic whiteboard 2A. Then, the electronic whiteboard 2A transmits the display data of the content and the audio data to the tablet PC 3. The tablet PC 3 displays the received content and outputs the received audio data. Similarly, the display data of the content and the audio data input to the tablet PC 3 are transmitted to the electronic whiteboard 2A. Then, the electronic whiteboard 2A transmits the display data of the content and the audio data to the electronic whiteboard 2B. The electronic whiteboard 2B displays the content based on the received display data and outputs the received audio data. The electronic whiteboard 2B and the tablet PC 3 repeat these processes to execute the online conference.

### Hardware Configuration

### Electronic Whiteboard

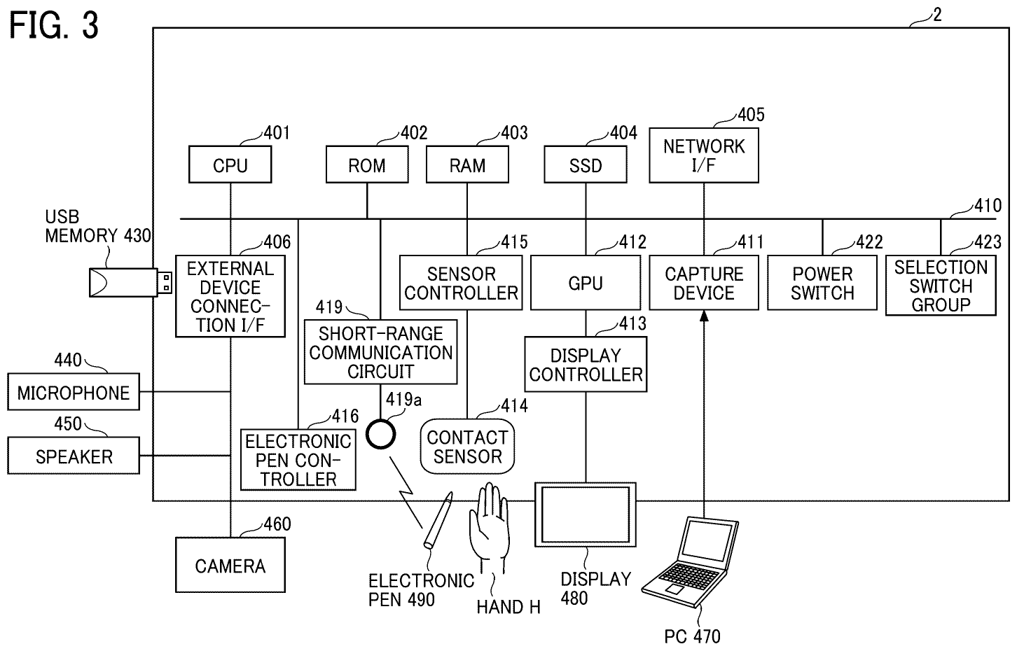

FIG. 3 is a block diagram illustrating a hardware configuration of the electronic whiteboard 2. As illustrated in FIG. 3, the electronic whiteboard 2 includes a central processing unit (CPU) 401, a read-only memory (ROM) 402, a random-access memory (RAM) 403, a solid-state drive (SSD) 404, a network interface (I/F) 405, and an external device connection I/F 406.

The CPU 401 controls the overall operation of the electronic whiteboard 2. The ROM 402 stores a program such as an initial program loader (IPL) used for booting an operating system (OS). The RAM 403 is used as a work area for the CPU 401. The SSD 404 stores various data such as a program used for the electronic whiteboard 2. The network I/F 405, which may be implemented by an interface circuit, controls communication with an external device through the communication network N. The external device connection I/F 406, which may be implemented by an interface circuit, is an interface that controls communication of data with various external devices. Examples of the external devices in this case include, but are not limited to, a universal serial bus (USB) memory 430 and external devices such as a microphone 440, a speaker 450, and a camera 460.

The electronic whiteboard 2 also includes a capture device 411, a graphics processing unit (GPU) 412, a display controller 413, a contact sensor 414, a sensor controller 415, an electronic pen controller 416, a short-range communication circuit 419, an antenna 419a for the short-range communication circuit 419, a power switch 422, and a selection switch group 423.

The capture device 411 acquires display data of a PC 470 connected to the electronic whiteboard 2 via a cable such as a HIGH-DEFINITION MULTIMEDIA INTERFACE (HDMI) cable and displays a still image or a video based on the display data. The GPU 412 is a semiconductor chip dedicated to graphics processing. The display controller 413 controls screen display for outputting an image processed by the GPU 412 to a display device such as a display 480. The contact sensor 414 detects contact onto the display 480 by, for example, an electronic pen 490 or a user's hand H. The sensor controller 415 controls the operation of the contact sensor 414. The contact sensor 414 detects input coordinates using an infrared ray blocking system. To detect the input coordinates, two light-receiving-and-emitting devices arranged at both ends of the upper face of the display 480, respectively, are used. A light-emitting element such as a laser included in each of the two light-receiving-and-emitting devices performs scanning by emitting an infrared beam and rotating the infrared beam in a range of 90 degrees in parallel to the surface of the display 480. The infrared beam is reflected by a reflecting member arranged at the surrounding of the display 480. A light-receiving element included in each of the light-receiving-and-emitting devices receives light (i.e., the infrared beam) returning through the same optical path of the emitted infrared beam. Each of the two light-receiving-and-emitting devices that serve as the contact sensor 414 outputs, to the sensor controller 415, position information (a position on the light-receiving element) of the infrared beam that is emitted from each of the two light-receiving-and-emitting devices and then blocked by an object. Based on two pieces of the position information received by the two light-receiving-and-emitting devices, the sensor controller 415 specifies the coordinates of the position contacted by the object. The electronic pen controller 416 communicates with the electronic pen 490 by BLUETOOTH to determine whether the display 480 is touched by the pen tip or the pen bottom. The electronic pen 490 includes a switch for switching between a mode for an operation by the pen tip and a mode for an operation by the pen bottom, and transmits mode information set on the electronic pen 490 by BLUETOOTH. In the following description, the mode for the operation by the pen tip and the mode for the operation by the pen bottom may be referred to as a pen tip mode and a pen bottom mode, respectively. In the pen tip mode, the electronic whiteboard 2 draws a line at the position of the coordinate point sequence traced by touching with the pen. In the pen bottom mode, the electronic whiteboard 2 functions as an eraser to erase the line drawn at the position of the coordinate point sequence traced by touching with the pen. The short-range communication circuit 419 is a communication circuit in compliance with, for example, the near field communication (NFC) or BLUETOOTH. The power switch 422 is a switch that turns on or off the power of the electronic whiteboard 2. The selection switch group 423 is, for example, a group of switches for adjusting brightness, hue, etc., of display on the display 480.

The electronic whiteboard 2 further includes a bus line 410. The bus line 410 is, for example, an address bus or a data bus, which electrically connects the components or elements such as the CPU 401 illustrated in FIG. 3.

The detector of the contact sensor 414 is not limited to the infrared ray blocking system. The contact sensor 414 may employ, as the detector, a capacitive touch panel that detects a change in capacitance to identify a contact position. Alternatively, the contact sensor 414 may employ, as the detector, a resistance film touch panel that detects a change in voltage of two opposing resistance films to identify a contact position. Still alternatively, the contact sensor 414 may employ, as the detector, an electromagnetic induction touch panel that detects electromagnetic induction caused by contact of an object onto the display to identify a contact position. In addition to the devices described above, any one of various other types of detection devices may be used as the contact sensor 414. In addition to or alternative to detecting a touch by the tip or bottom of the electronic pen 490, the electronic pen controller 416 may also detect a touch by another part of the electronic pen 490, such as a part held by the hand of the user.

### Tablet PC

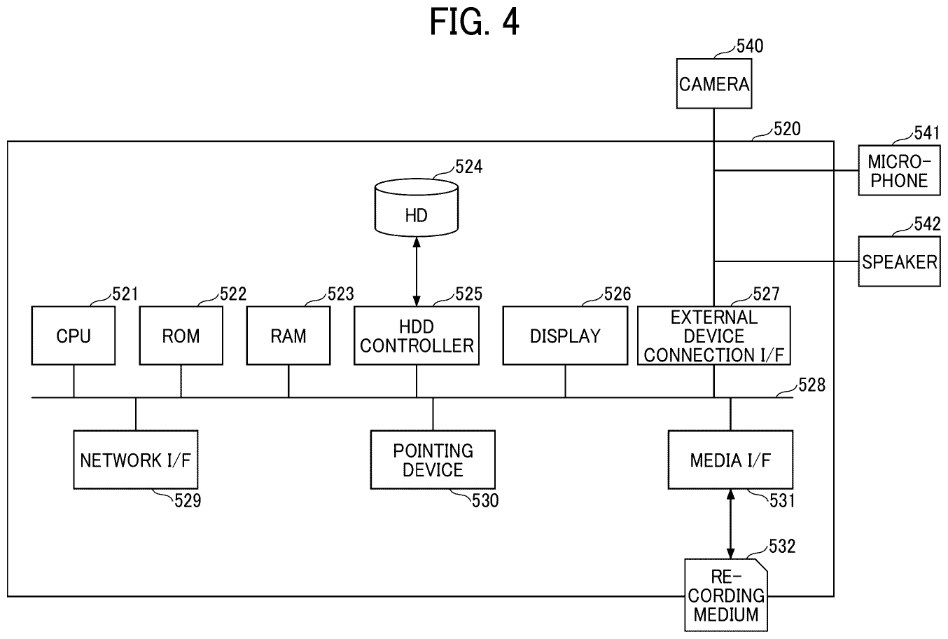

FIG. 4 is a block diagram illustrating a hardware configuration of the tablet PC 3. As illustrated in FIG. 4, the tablet PC 3 is implemented by a computer 520. The computer 520 includes a CPU 521, a ROM 522, a RAM 523, a hard disk (HD) 524, a hard disk drive (HDD) controller 525, a display 526, an external device connection I/F 527, a bus line 528, a network I/F 529, a pointing device 530, and a media I/F 531. The pointing device 530 is a touch panel.

The CPU 521 controls the overall operation of the tablet PC 3. The ROM 522 stores a program such as an IPL used for booting the CPU 521. The RAM 523 is used as a work area for the CPU 521. The HD 524 stores various data such as a program. The HDD controller 525 controls the reading or writing of data from or to the HD 524 under the control of the CPU 521. The display 526 displays various information such as a cursor, a menu, a window, characters, and images. The external device connection I/F 527, which may be implemented by an interface circuit, is an interface that controls communication of data with various external devices. Examples of the external devices in this case include, but are not limited to, a camera 540, a microphone 541, a speaker 542, a USB memory, and a printer. The network I/F 529, which may be implemented by an interface circuit, is an interface that controls data communication through a network. The bus line 528 is, for example, an address bus or a data bus, which electrically connects the components or elements such as the CPU 521 illustrated in FIG. 4. The pointing device 530 is an example of an input device used for, for example, selecting or executing various instructions, selecting an object to be processed, and moving a cursor being displayed. The media I/F 531, which may be implemented by an interface circuit, controls the reading or writing (storing) of data from or to (in) a recording medium 532 such as a flash memory.

### Functions

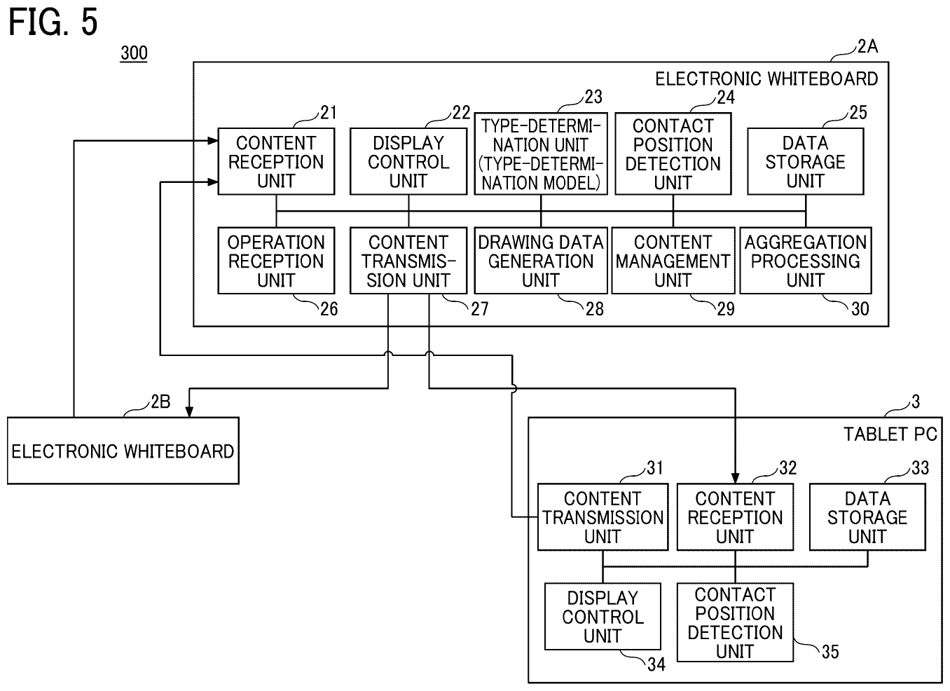

With reference to FIG. 5, a functional configuration of the display system 300 is described below. FIG. 5 is a block diagram illustrating functional configurations of the electronic whiteboard 2A, the electronic whiteboard 2B, and the tablet PC 3 included in the display system 300.

### Functions of Electronic Whiteboard

The electronic whiteboard 2A includes a content reception unit 21, a display control unit 22, a type-determination unit 23, a contact position detection unit 24, a data storage unit 25, an operation reception unit 26, a content transmission unit 27, a drawing data generation unit 28, a content management unit 29, and an aggregation processing unit 30. These functional units of the electronic whiteboard 2A are implemented by or caused to function by one or more of the hardware components illustrated in FIG. 3 operating in accordance with instructions from the CPU 401 according to the control program loaded from the SSD 404 to the RAM 403.

The content reception unit 21 receives drawing data of handwriting in the display region 251 from another device. Specifically, the content reception unit 21 receives display data of a content such as handwriting of drawing data or a figure transmitted from the electronic whiteboard 2B or the tablet PC 3.

The content transmission unit 27 transmits the display data of the content input to a device at one site to the other devices at the other sites. The content displayed on the device at the site includes the content directly input to the electronic whiteboard 2A and the content transmitted from the electronic whiteboard 2B or the tablet PC 3 to the electronic whiteboard 2A.

The operation reception unit 26 receives an operation to the electronic whiteboard 2A. For example, the operation reception unit 26 determines a button at the coordinates of a position contacted by the electronic pen 490 or the hand H and receives pressing of the button.

The display control unit 22 controls, for example, the display of a content such as handwriting of drawing data or a figure input to the device to which the display control unit 22 belongs, the display of the conference information, and the display of the content received from the electronic whiteboard 2B or the tablet PC 3. The display control unit 22 scrolls the display region 251 to move a content to the display extension region 252 that is larger than the display region 251. In addition, the display control unit 22 controls a content within the display extension region 252 to be displayed in the display region 251 in accordance with the scrolling.

The type-determination unit 23 determines the type of each content. The type-determination unit 23 has a type-determination model that is a machine learning model trained using training data for determining the type of content. The type-determination model is a feature extraction model suitable for images, such as a convolutional neural network (CNN). The type-determination model extracts features of a content and determines the type of the content.

The contact position detection unit 24 detects a position contacted by the user's hand H or the electronic pen 490. The drawing data generation unit 28 generates drawing data from a coordinate point sequence input from the contact position detection unit 24 when the user handwrites or generates a figure such as a circle or a rectangle.

The content management unit 29 manages the content using the data storage unit 25. As will be described in detail later, the data storage unit 25 stores a content management table used for managing each content including contents transmitted from the other devices. When a content is newly input, the content management unit 29 registers the information on the content in the content management table. When a content is updated, the content management unit 29 update the information on the content in the content management table.

The aggregation processing unit 30 performs a process related to aggregation of contents. The aggregation processing unit 30 arranges in the display region 251 the contents whose type corresponds to the type of content designated by the user and reduces the sizes of the contents so that the contents fit within the display region 251. The aggregation processing unit 30 also searches for a content matching a keyword.

### Functions of Another Electronic Whiteboard

The functions of the electronic whiteboard 2B may be substantially the same as those of the electronic whiteboard 2A, and therefore, the description thereof is omitted.

### Functions of Tablet PC

The tablet PC 3 includes a content transmission unit 31, a content reception unit 32, a data storage unit 33, a display control unit 34, and a contact position detection unit 35. These functional units of the tablet PC 3 are implemented by or caused to function by one or more of the hardware components illustrated in FIG. 4 operating in accordance with instructions from the CPU 521 according to the control program loaded from the HD 524 to the RAM 523. The data storage unit 33 is implemented by, for example, the HD 524 or the RAM 523.

The content transmission unit 31 transmits, to the electronic whiteboard 2A, a content such as handwriting of drawing data or a figure input to the device to which the content transmission unit 31 belongs.

The content reception unit 32 receives display data of a content such as handwriting of drawing data or a figure transmitted from the electronic whiteboard 2A. Accordingly, the electronic whiteboard 2A and the tablet PC 3 are sharing the content in real time.

The display control unit 34 controls the display of a content such as handwriting of drawing data or a figure input to the device to which the display control unit 34 belongs, the display of the conference information, the display of the content received from the electronic whiteboard 2A, and the update of the display region 251 (i.e., the display of a part of the display extension region 252) in accordance with scrolling.

The contact position detection unit 35 detects a position contacted by the user's hand H or the electronic pen 490. The data storage unit 33 stores information on each content including contents transmitted from the other devices.

The tablet PC 3 may have the same functional units as those of the electronic whiteboard 2A, such as a drawing data generation unit.

### Display Extension Region and Display Region

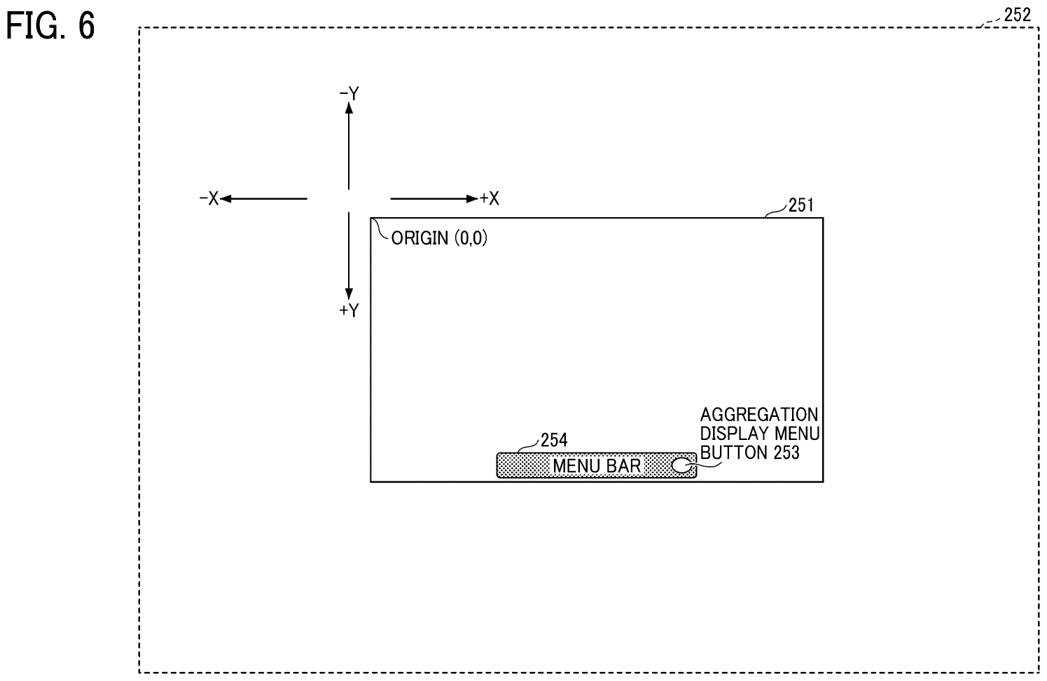

With reference to FIG. 6, the display extension region 252 and the display region 251 are described below. FIG. 6 is a diagram illustrating a correspondence between the display extension region 252 and the display region 251. The display region 251 is a region displayed on the display 480. The display extension region 252 is a region that includes the display region 251, and in which contents that cannot be displayed in the display region 251 are arranged. Although the size of the region depends on factors such as the image memory, the display extension region 252 is reserved to be larger than the display region 251.

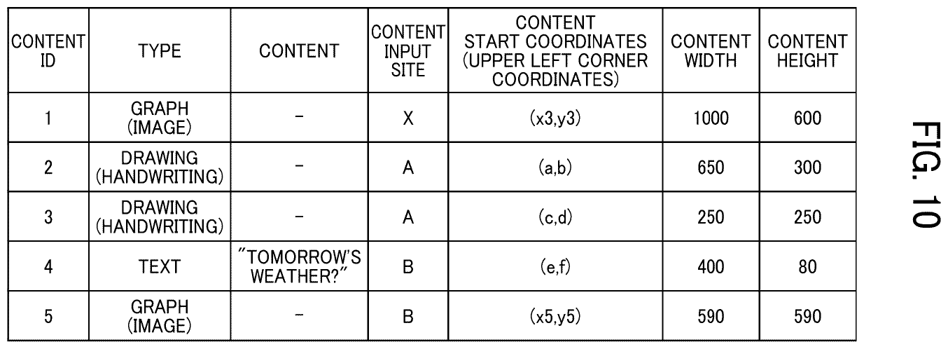

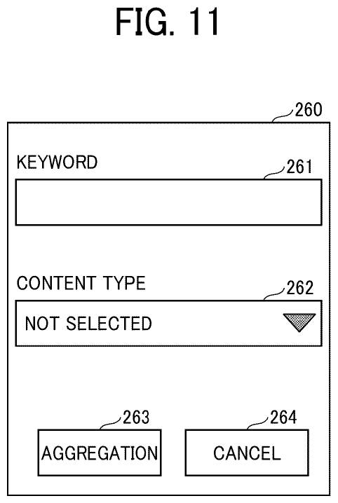

In the display region 251, a menu bar 254 and an aggregation display menu button 253 are displayed. The aggregation display menu button 253 is a button used for displaying a condition setting screen 260 (see FIG. 11) described later.

The coordinates in the display region 251 are defined by coordinates where the pixel position at the upper-left corner of the display 480 of the electronic whiteboard 2A is set as the origin, the rightward direction is set as the positive direction of an X-axis, and the downward direction is set as the positive direction of a Y-axis. In other words, the coordinates in the display region 251 are given by the number of pixels in the X-axis direction from the origin and the number of pixels in the Y-axis direction from the origin.

It is assumed that the display region 251 of the display 480 of the electronic whiteboard 2A is fixed at the initial position. The coordinates in the display extension region 252 are defined by coordinates where the pixel position at the upper-left corner of the display 480 of the electronic whiteboard 2A is set as the origin, the rightward direction is set as the positive direction of the X-axis, the leftward direction is set as the negative direction of the X-axis, the downward direction is set as the positive direction of the Y-axis, and the upward direction is set as the negative direction of the Y-axis.

### Copy of Screen Data of Connected Device to Display Region of Electronic Whiteboard

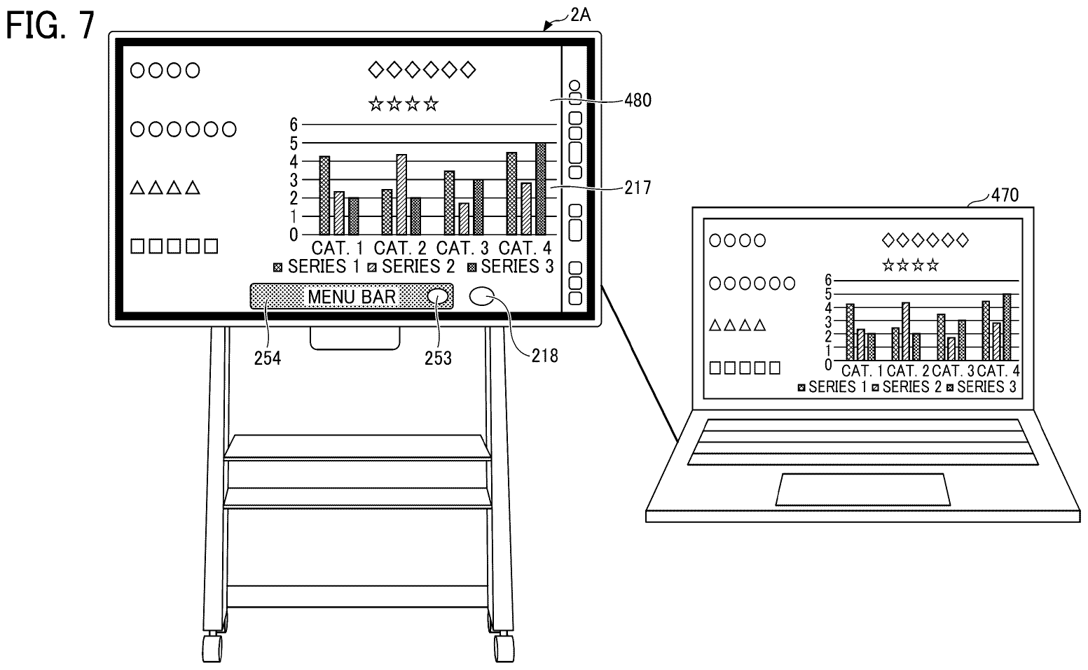

With reference to FIG. 7, a method for copying, when a screen displayed by the PC connected to the electronic whiteboard 2A is displayed in the display region 251, an entirety or a part of the screen to the electronic whiteboard 2A is described below.

When the power is turned on, each of the electronic whiteboards 2A and 2B displays a whiteboard on the display 480. The menu bar 254 displayed at the bottom of the whiteboard includes, in addition to the aggregation display menu button 253, a connection menu button, a full screen capture button, a partial screen capture button 218, and a whiteboard display button. The connection menu button is used to display a screen for connecting to the other electronic whiteboard. The full screen capture button is used to copy data of a full screen to the whiteboard as a still image and the partial screen capture button 218 is used to copy data of a partial screen to the whiteboard as a still image when the display information of the display of the PC 470 externally connected is displayed on the display 480 as a still image or video. The whiteboard display button is used to switch, to the whiteboard, the display from the screen of the PC 470 externally connected. When the electronic whiteboard 2A and the PC 470 are connected by the HDMI cable, the capture device 411 of the electronic whiteboard 2A causes the screen data of the PC 470 to be displayed on the display 480 as a still image or video. A display example of the state described above is illustrated in FIG. 7.

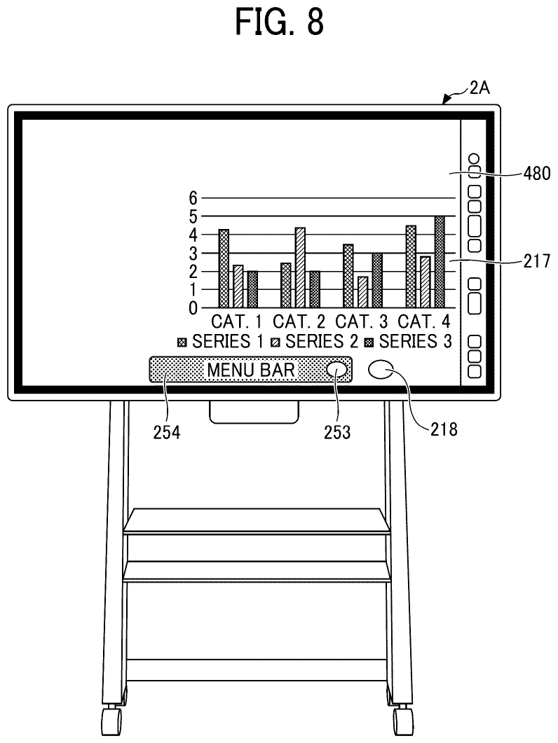

At this point, in order to copy a bar graph 217 displayed on the display 480 onto the whiteboard, the user touches the partial screen capture button 218 on the menu bar 254. After touching the upper-left of the bar graph 217, the user moves the touched finger to the lower-right of the bar graph 217 while keeping the finger in contact with the display 480, and then lifts the finger from the display 480. Then, the electronic whiteboard 2A displays a rectangle having a diagonal line connecting the start point and end point of the touch operation for a predetermined period of time. Subsequently, when the user touches the whiteboard display button on the menu bar 254, the display of the display 480 is switched from the screen of the PC 470 to the whiteboard. A display example of the display 480 of the electronic whiteboard 2A at this time is illustrated in FIG. 8. In this manner, the bar graph 217 displayed on the screen of the PC 470 is copied onto the whiteboard of the electronic whiteboard 2A.

### Examples of Contents

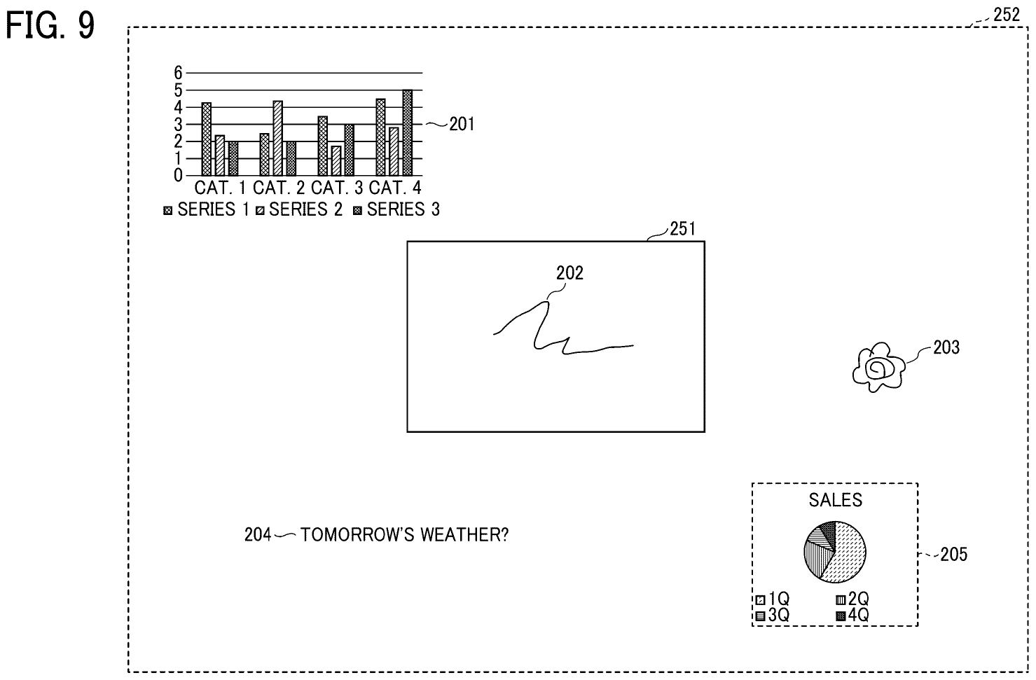

FIG. 9 is a diagram illustrating the display extension region 252 in which multiple contents are arranged. In FIG. 9, five contents are displayed. A content 201 is a bar graph input to the electronic whiteboard 2A at the X site. A content 202 is handwriting representing drawing data input to the electronic whiteboard 2B at the A site. A content 203 is other handwriting representing drawing data input to the electronic whiteboard 2B at the A site. A content 204 is text representing text data input to the tablet PC 3 at the B site. A content 205 is a pie chart input to the tablet PC 3 at the B site.

The content input to the device at a site is shared in the display extension region 252 of the electronic whiteboard 2A. When the user inputs a content to the device at one of the sites, the user moves the display region 251 to search for a blank space and inputs the content in the blank space. The user performs a swipe operation to move the display region 251 so that a content currently not displayed in the display region 251 to be displayed in the display region 251. In this way, the contents are arranged in the display extension region 252 as illustrated in FIG. 9.

In FIG. 9, the content 201 is a content copied from the screen data of the PC connected to the electronic whiteboard 2A at the same site and the content 205 is a content received from the tablet PC 3 in the B site. The content displayed in the display extension region 252 includes, for example, image data acquired by a web browser and screen data acquired from a PC, in addition to drawing data, a figure, text representing text data, and image data stored in the electronic whiteboard.

When a content is added to the display extension region 252, the type-determination unit 23 determines the type of the content. In other words, the type-determination model retains parameters whose accuracy in content classification has been increased through execution of a machine learning program using training data that enables classification of a content into one of “drawing (handwriting),” a “figure,” “text,” a “photo,” and a “graph (image).” The determination may be performed by an external server. The type-determination model may be, for example, a feature extraction model such as the CNN, but an existing model may be used as appropriate. For example, a model in which Residual Neural Networks (ResNet) is coupled to the CNN for preventing gradient vanishing may be used. The ResNet is a model that enables learning in deep networks by using residual connections to branch the output from a certain layer of a neural network, skip one or more layers, connect to the output of the skipped layers, and add the branched output to the output of the skipped layers.

When a content is added to the display extension region 252, the type-determination unit 23 determines the content to be one of the “drawing (handwriting),” the “figure,” the “text,” the “photo,” and the “graph (image).”

FIG. 10 is a schematic diagram illustrating a content management table that the content management unit 29 manages in the data storage unit 25. The electronic whiteboard 2B and the tablet PC 3 also have substantially the same information as that in FIG. 10. The content management table includes, as data items, a content identification (ID), a type, a content, a content input site, content start coordinates, a content width (an example of size information or second size information), and a content height (an example of the size information or the second size information). The content ID is identification information for uniquely identifying the content. The type is the type of the content determined by the type-determination unit 23. The content is a character string representing text data, which is registered in the case of text data or in the case where the drawing data is recognized as text data (i.e., text data converted from the drawing data). The content input site is the site where the content is originally input. Alternatively, as the content input site, user identification information may be used. The content start coordinates are the coordinates, in the display extension region 252, of the upper-left corner of a circumscribed rectangle that encloses the content. The coordinates of the upper-left corner, the upper-right corner, the lower-right corner, and the lower-left corner of the content are examples of position information. The content width is the lateral length of the circumscribed rectangle enclosing the content. The content width is the difference between the upper-left corner and the upper-right corner, or the difference between the lower-left corner and the lower-right corner. The content height is the vertical length of the circumscribed rectangle enclosing the content. The content height is the difference between the upper-left corner and the lower-left corner, or the difference between the upper-right corner and the lower-right corner.

### Designation of Type of Content to be Aggregated

When the user presses the aggregation display menu button 253 illustrated in FIG. 6, the display control unit 22 causes the condition setting screen 260 to be displayed as a method for aggregating and displaying contents.

FIG. 11 is a diagram illustrating the condition setting screen 260. The condition setting screen 260 includes a keyword field 261, a type-designation field 262, an aggregation button 263, and a cancel button 264. The keyword field 261 is a field used for setting a character string to primarily search for text data or drawing data. When the user enters a character string in the keyword field 261 and presses the aggregation button 263, the aggregation processing unit 30 aggregates contents that include the character string in the display region 251. The display control unit 22 controls the contents to be displayed.

The type-designation field 262 is a field used for designating the type of content to be aggregated. In the type-designation field 262, a list of types of contents determined by the type-determination unit 23 is displayed in a pull-down format. Accordingly, in the type-designation field 262, all types of the contents in the display extension region 252 (only the types of the contents in the display extension region 252) are displayed without excess or deficiency. When the user selects one of the types displayed in the field and presses the aggregation button 263, the aggregation processing unit 30 aggregates the contents corresponding to the designated type in the display region 251, and the display control unit 22 controls the contents to be displayed. The user may be allowed to select multiple types of contents.

Preferably, the number of contents of each type may also be displayed in the pull-down menu. The user can refer to the numbers when selecting a type of content. For example, when the number of contents per type is small, the user may select two types. Conversely, when the number is large, the user may use a keyword to narrow down the contents.

The keyword field 261 and the type-designation field 262 may function as a logical AND or logical OR operation. In other words, when the user presses the aggregation button 263, the aggregation processing unit 30 aggregates in the display region 251 contents that satisfies the conditions based on the information on the contents in the data storage unit 25.

Alternatively, the user may select any one or more contents and the aggregation processing unit 30 may aggregate the selected contents in the display region 251. In this case, a list of the contents may be displayed as a thumbnail.

### Arrangement Rule of Contents to be Aggregated and Displayed

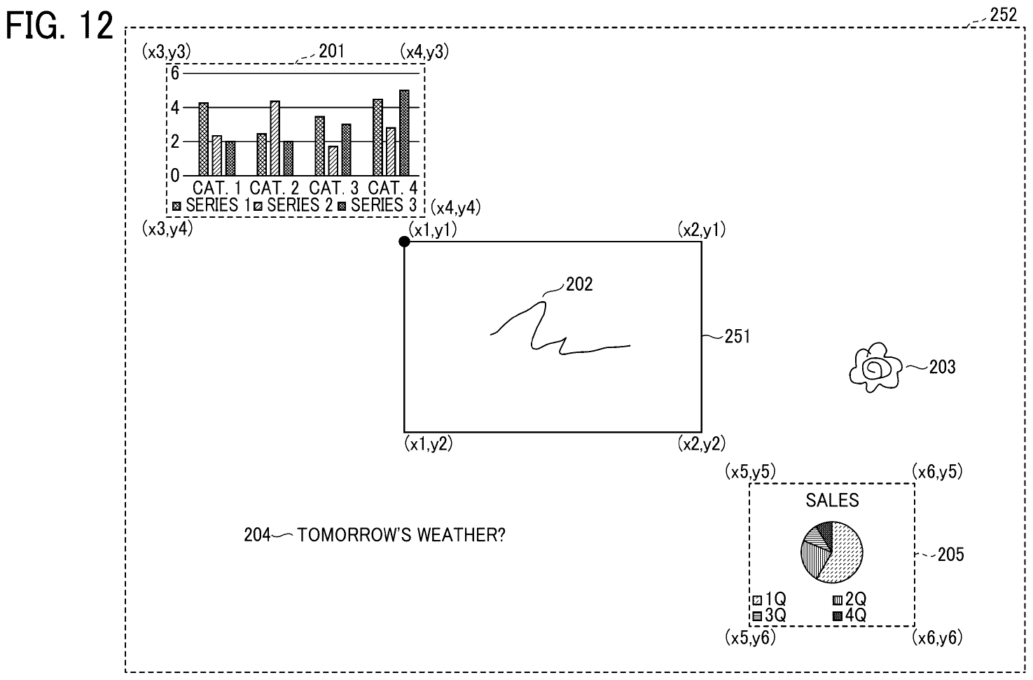

With reference to FIGS. 12 to 15, an arrangement rule of contents to be aggregated and displayed is described below. FIG. 12 is a diagram illustrating contents to be displayed in the display region 251 when a graph is selected in the type-designation field 262. In FIG. 12, the graphs and the coordinates of each graph in the display region 251 are illustrated. The coordinates of the upper-left, upper-right, lower-right, and lower-left corners of the content 201 are (x3, y3), (x4, y3), (x4, y4), and (x3, y4), respectively. The coordinates of the upper-left, upper-right, lower-right, and lower-left corners of the content 205 are (x5, y5), (x6, y5), (x6, y6), and (x5, y6), respectively. The coordinates of the upper-left, upper-right, lower-right, and lower-left corners of the display region 251 are (x1, y1), (x2, y1), (x2, y2), and (x1, y2), respectively.

Note that the upper-left corner, upper-right corner, lower-right corner, and lower-left corner are edge portions of the content or the display region.

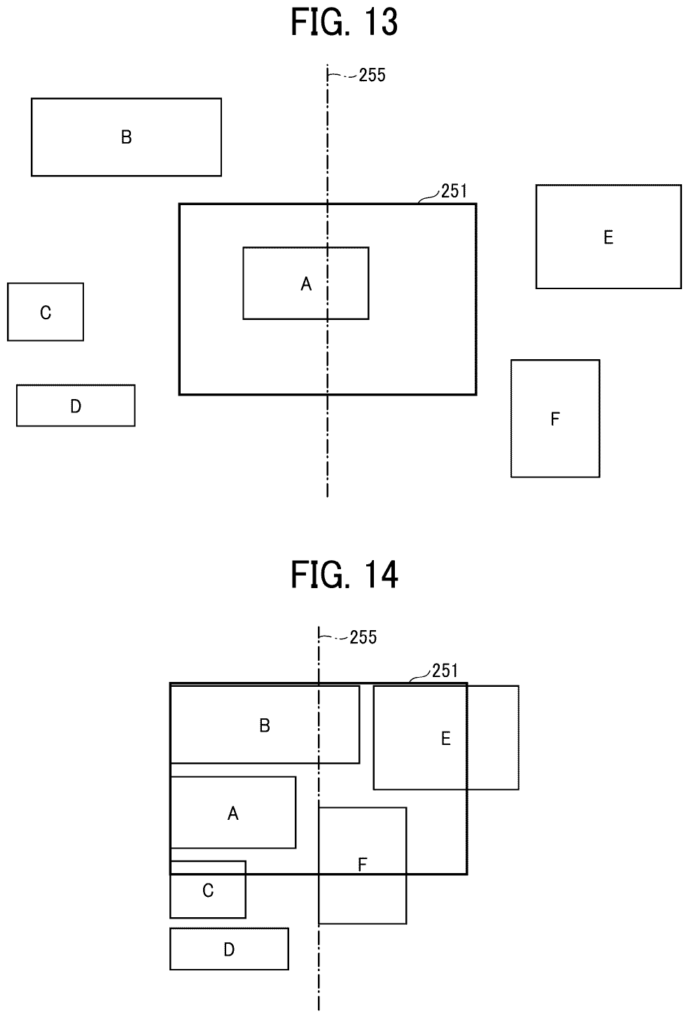

FIG. 13 is a diagram illustrating an arrangement rule using contents A to F. As illustrated in FIG. 13, the aggregation processing unit 30 divides the display extension region 252 into a left region and a right region by a perpendicular line 255 passing through the center point of the display region 251.

(1) When the contents A to F are present only in the left region or only in the right region, the contents A to F are arranged in the display region 251 in order from the top.

(2) When the above condition (1) is not satisfied, the number of contents present in the left region and the number of contents present in the right region are compared and the smaller number is identified. Then, the aggregation processing unit 30 alternately arranges the number of contents corresponding to the smaller number from the left region and the number of contents corresponding to the smaller number from the right region in the display region 251 in order from the top. In other words, the aggregation processing unit 30 alternately arranges the aforementioned number of contents in the display region 251 in order from the top, such as the top of the left half of the display region 251, the top of the right half, the second from the top of the left half, and the second from the top of the right half. At this time, the contents present in the left region are arranged on the left side in the display region 251, and the contents present in the right region are arranged on the right side in the display region 251.

(3) The aggregation processing unit 30 additionally arranges the contents present only in the left region or only in the right region remaining after the execution of the arrangement of (2) in the display region 251 in order from the top.

In the arrangement, the aggregation processing unit 30 alternately arranges the contents in the left half and the right half of the display region 251, with priority given to the content having a smaller coordinate in the Y-axis direction.

In adding a content in the left half or the right half of the display region 251, when there is a blank space on the right side of the content already arranged and the next content can be arranged in the blank space, the next content is arranged on the right side of the content already arranged, not on the lower side.

Among the contents A to F illustrated in FIG. 13 before the execution of the aggregation, the contents A to D are present in the left region and the contents E and F are present in the right region. When comparing the number of contents present in the left region and the number of contents present in the right region, the smaller number is two.

a. Accordingly, in accordance with the order of the smaller coordinate in the Y-axis direction, the content B is first arranged at the top of the left half of the display region 251.

b. Subsequently, the content E is arranged at the top of the right half of the display region 251.

c. Subsequently, the content A is arranged second from the top of the left half of the display region 251.

d. Subsequently, the content F is arranged second from the top of the right half of the display region 251.

e. Of the remaining contents C and D, the content C is arranged third from the top of the left half.

f. The content D cannot be arranged to the right of the content C. In this case, the content D is added to the left half or the right half where the last content is positioned higher. Accordingly, the remaining content D is arranged fourth from the top of the left half.

As a result, the contents A to F are arranged as illustrated in FIG. 14. In FIG. 14, the contents are aggregated in the center of the display region and displayed. The arrangement rule described above is given by way of example. The contents may be arranged from the upper-left to the lower-right of the display region 251 in the order of the coordinates of the contents, or in descending or ascending order of the areas of the contents. Furthermore, the contents A to F may be arranged using an artificial intelligence (AI) to minimize the space required.

The problem of arranging blocks so as to minimize the areas of the blocks is typically known as the “packing problem.” The packing problem is a combinatorial optimization problem whose goal is to arrange items of different sizes and shapes in a storage space as efficiently as possible. It is considered difficult to find a solution to the packing problem. Especially, when the blocks have various sizes and shapes, it is exceedingly difficult to find an optimal solution. However, the following algorithms and methods are commonly known to address the packing problem.

1. Greedy Algorithm: This is the simplest method, in which blocks are arranged one by one in order. Examples include the “largest-first method,” in which blocks are arranged in descending order of size, and the “smallest-first method,” in which blocks are arranged in ascending order of size.

2. Heuristic Algorithm: Examples include methods such as First Fit Decreasing (FFD) and Best Fit Decreasing (BFD). In these methods, blocks are sorted by size and arranged to efficiently fill a space.

3. Backtracking: This is a technique for finding a solution by partially exploring the search space for a solution. All possibilities are not tried, but the exploring is performed while pruning to some extent.

4. Dynamic Programming: This is a technique for efficiently finding a solution by dividing a problem into subproblems, solving the subproblems, and reusing the results. This technique is particularly applied to the packing of two-dimensional or three-dimensional items.

5. Metaheuristic Algorithm: Examples include methods such as a genetic algorithm, simulated annealing, and particle swarm optimization. These methods are algorithms used to find approximate solutions and are particularly effective for large-scale problems.

6. Integer Linear Programming (ILP): This is a method to formulate a problem as an integer linear programming problem and find the optimal solution.

Commercial software can provide accurate solutions but can be computationally expensive. By applying the packing problem, the electronic whiteboard 2 can arrange contents corresponding to a designated type or contents related to a designated keyword so that the ratio of the contents occupying the display region to the entire display region becomes high and can cause a device to display the contents. Furthermore, when multiple types of contents are aggregated, the aggregation processing unit 30 may arrange the contents so that the contents of the same type are grouped together. In this case, the aggregation processing unit 30 arranges only the contents of the same type first in the same manner as described above in order from the top of the display region 251.

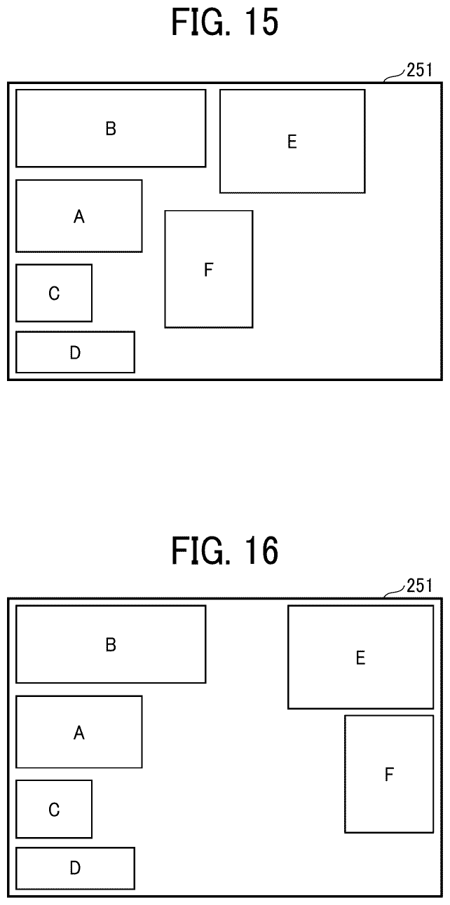

In the state of FIG. 14, since all the contents A to F do not fit within the display region 251, the aggregation processing unit 30 reduces the sizes of the contents A to F so that all the contents A to F fit within the display region 251. FIG. 15 is a diagram illustrating the contents A to F after the reduction of the sizes.

Since there is a blank space to the right of the contents E and F, the contents E and F may be moved to the right so as to be seen easier as illustrated in FIG. 16. In FIG. 16, the contents are aligned to both sides of the display region and displayed.

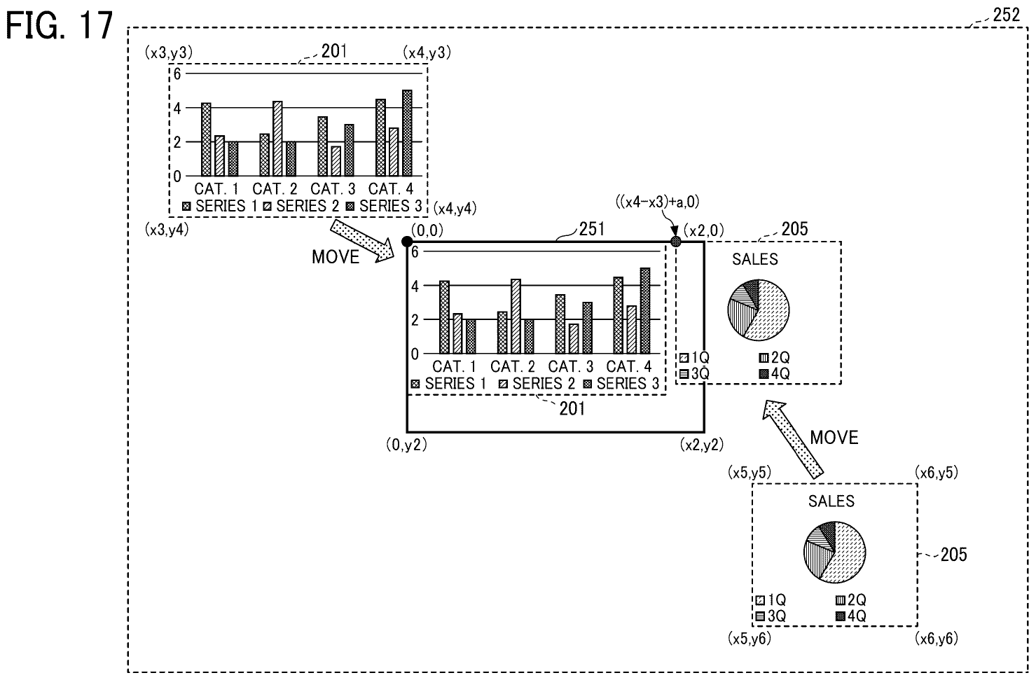

The contents 201 and 205 illustrated in FIG. 12 are also arranged in accordance with the same arrangement rule. FIG. 17 is a diagram illustrating how the contents 201 and 205 are arranged. Since the content 201 is present in the left region and the content 205 is present in the right region, the content 201 is displayed in the upper-left of the display region 251 and the content 205 is arranged on the right side of the content 201. With reference to the coordinates in FIG. 12, a description is given. The aggregation processing unit 30 moves the coordinates (x3, y3) of the upper-left corner of the content 201 to align with the coordinates (0, 0) of the upper-left corner of the display region 251, and moves the coordinate (x5, y5) of the upper-left corner of the content 205 to the coordinates ((x4-x3)+a, 0). The aggregation processing unit 30 arranges the contents 201 and 205 with a distance “a” therebetween. The distance “a” may be, for example, 20, and serves as a gap to ensure visibility.

In the state of FIG. 17, the content 205 extends beyond the display region 251 in the X-axis direction, and the entirety of the content 205 cannot be displayed. For this reason, the aggregation processing unit 30 reduces the sizes of the contents 201 and 205 so that the content 205 also fits within the display region 251. When the user selects multiple types of contents, the aggregation processing unit 30 may reduce the sizes of the contents by a different scaling ratio for each type, instead of uniformly scaling down all the contents. For example, the aggregation processing unit 30 may apply a reduction ratio (less than one) to graphs, which is smaller than a reduction ratio to be applied to drawing data (primarily text). In this way, the contents can more easily fit within the display region 251 while maintaining visibility. The user may be allowed to set a reduction ratio for each type.

The aggregation processing unit 30 may detect the size of the text of the drawing data using an existing method, determine a reduction ratio for the content (text) so that the size of the text does not become smaller than a certain size (so that the size of the text becomes a certain size), and determine a reduction ratio for the other contents so that the other contents can fit within the display region by this reduction ratio.

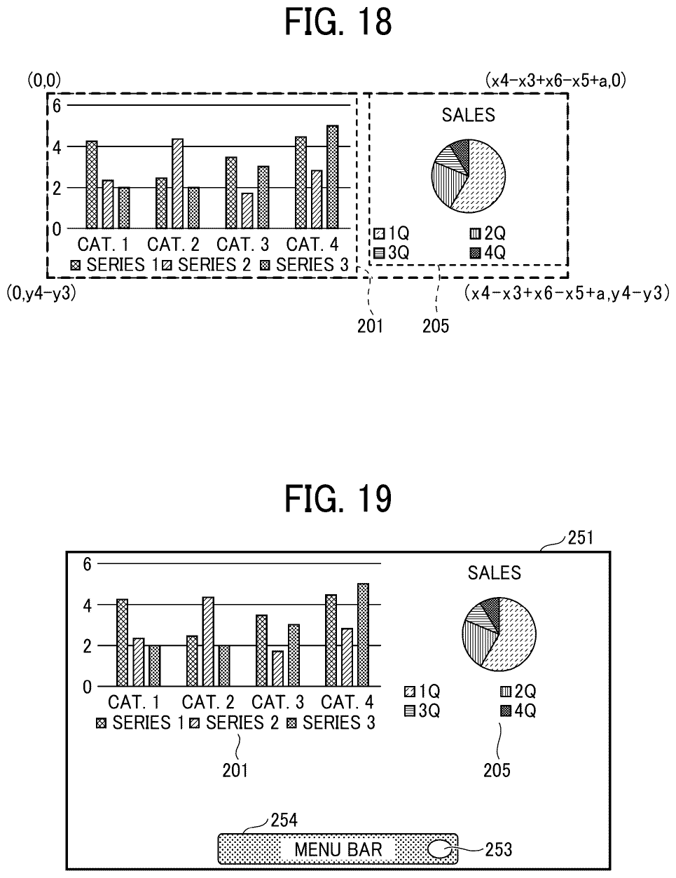

FIG. 18 is a diagram illustrating the coordinates of the contents 201 and 205 before the reduction of the sizes. The coordinates of a rectangle circumscribing both contents 201 and 205 before the reduction of the sizes are as follows. The coordinates of the upper-left corner are (0, 0), the coordinates of the upper-right corner are (x4−x3+a+x6−x5, 0), the coordinates of the lower-right corner are (x4−x3+a+x6−x5, y4−y3), and the coordinates of the lower-left corner are (0, y4−y3).

The length (number of pixels) of the display region 251 in the X-axis direction is “x2,” and the length (number of pixels) from the left edge of the content 201 to the right edge of the content 205 is “(x4−x3)+ (x6−x5)+a.” Therefore, the reduction ratio for reducing the sizes of the contents 201 and 205 so as to fit within the display region 251 is as follows.

$$Reduction ratio = ( x 2 ) / ( ( x 4 - x 3 ) + ( x 6 - x 5 ) + a ) )$$

FIG. 19 is a diagram illustrating the contents 201 and 205 whose sizes are reduced by this reduction ratio. The contents 201 and 205 fit within the display region 251, and all the contents are displayed.

When multiple contents are aggregated and displayed, the contents are arranged in accordance with the aforementioned arrangement rule of the contents. However, although the total width (length in the X-axis direction) of the multiple contents fits within the display region 251, the total height (length in the Y-axis direction) of the multiple contents may extends beyond the display region 251. In this case, the aggregation processing unit 30 calculates a reduction ratio in the Y-axis direction and reduces the sizes of all the contents by this reduction ratio. Further, both the total width and height of the multiple contents may extend beyond the display region 251. In this case, the aggregation processing unit 30 calculates reduction ratios in the X-axis and Y-axis directions, and reduces the sizes of all the content using the smaller of the two ratios.

### Operations or Processes

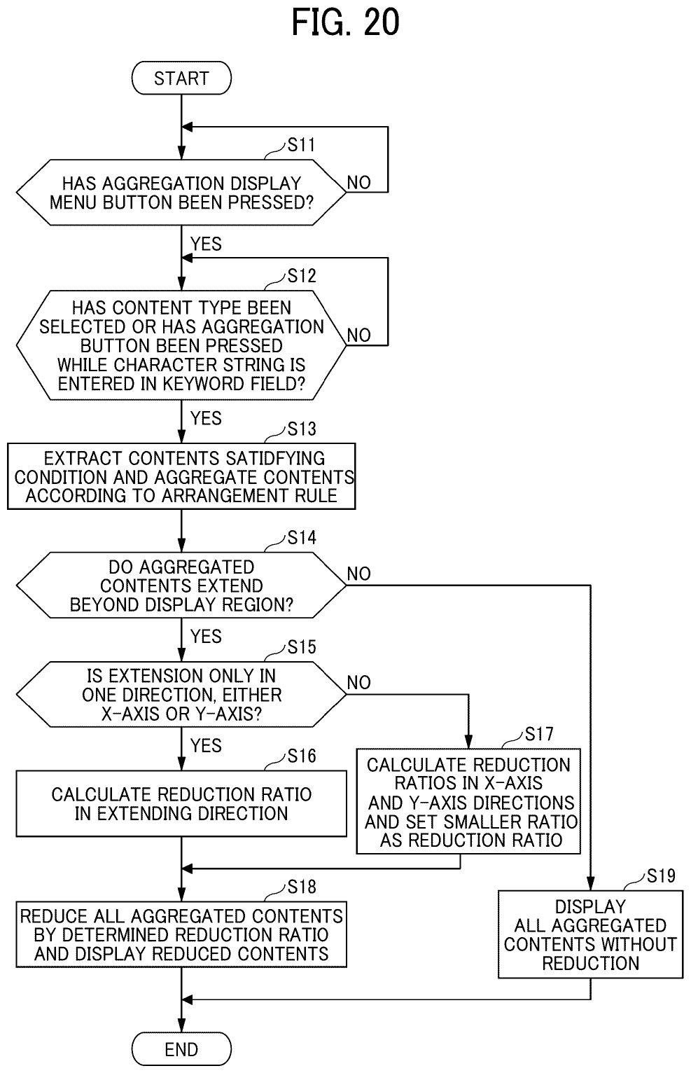

FIG. 20 is a flowchart of a process performed by the electronic whiteboard 2A to aggregate and display contents. The process of FIG. 20 can be performed, for example, after the electronic whiteboard 2A is turned on. However, the aggregation display menu button 253 may be displayed only when one or more contents are present in the display extension region 252.

In S11, the operation reception unit 26 determines whether the aggregation display menu button 253 has been pressed. In the case where the operation reception unit 26 determines that the aggregation display menu button 253 has been pressed (YES in S11), in S12, the operation reception unit 26 further determines whether the type of content has been selected in the type-designation field 262, or whether the aggregation button 263 has been pressed while a character string is entered in the keyword field 261. In the case where the operation reception unit 26 determines that the aggregation display menu button 253 has not been pressed (NO in S11), the operation reception unit 26 waits until the aggregation display menu button 253 is pressed.

In the case where the result of the determination in S12 is Yes (YES in S12), in S13, the aggregation processing unit 30 refers to the data storage unit 25 to extract contents that satisfy the conditions, and aggregates the contents in accordance with the arrangement rule.

In S14, the aggregation processing unit 30 determines whether the aggregated contents extend beyond the display region 251. In other words, the aggregation processing unit 30 determines whether the total width of the aggregated contents is longer than the width of the display region 251 (in the X-axis direction) or whether the total height of the aggregated contents is longer than the height of the display region 251 (in the Y-axis direction).

In the case where the aggregation processing unit 30 determines that the aggregated contents extend beyond the display region 251 (YES in S14), in S15, the aggregation processing unit 30 determines whether the aggregated contents extend beyond the display region 251 only in one direction, either the X-axis direction or the Y-axis direction.

In the case where the result of the determination in S15 is Yes (YES in S15), in S16, the aggregation processing unit 30 calculates a reduction ratio in the direction in which the aggregated contents extend.

In the case where the result of the determination in S15 is No (NO in S15), in S17, the aggregation processing unit 30 calculates reduction ratios in the X-axis and Y-axis directions and sets the smaller of the two ratios as the reduction ratio.

In S18, the aggregation processing unit 30 reduces the sizes of all the aggregated contents by the determined reduction ratio, and the display control unit 22 causes the contents to be displayed in the display region 251.

In the case where the aggregation processing unit 30 determines that the aggregated contents do not extend beyond the display region 251 (NO in S14), in S19, the display control unit 22 causes the aggregated contents to be displayed without reduction.

In the electronic whiteboard 2B, since the display region unique to the electronic whiteboard 2B is displayed, the aggregation display is not performed. When the aggregation button 263 is pressed on the electronic whiteboard 2B, the process of FIG. 20 is performed in the electronic whiteboard 2B. However, when the electronic whiteboards 2A and 2B are set to be synchronized, the electronic whiteboard 2B may also aggregate one or more contents.

According to the technique in the related art, all the contents outside the display region are aggregated and displayed. For this reason, when the number of contents is large, the contents are excessively reduced in size to be displayed and difficult to sec.

The electronic whiteboard 2A according to the present embodiment aggregates and displays in the display region 251 only the types of contents that the user desires to see. Thus, even when many contents are present in the display extension region 252, each content can be prevented from becoming excessively small. Accordingly, the screen becomes easier to view compared to the conventional approach.

### Second Embodiment

In the present embodiment, the aggregation display of contents in a virtual conference using a virtual conference server is described.

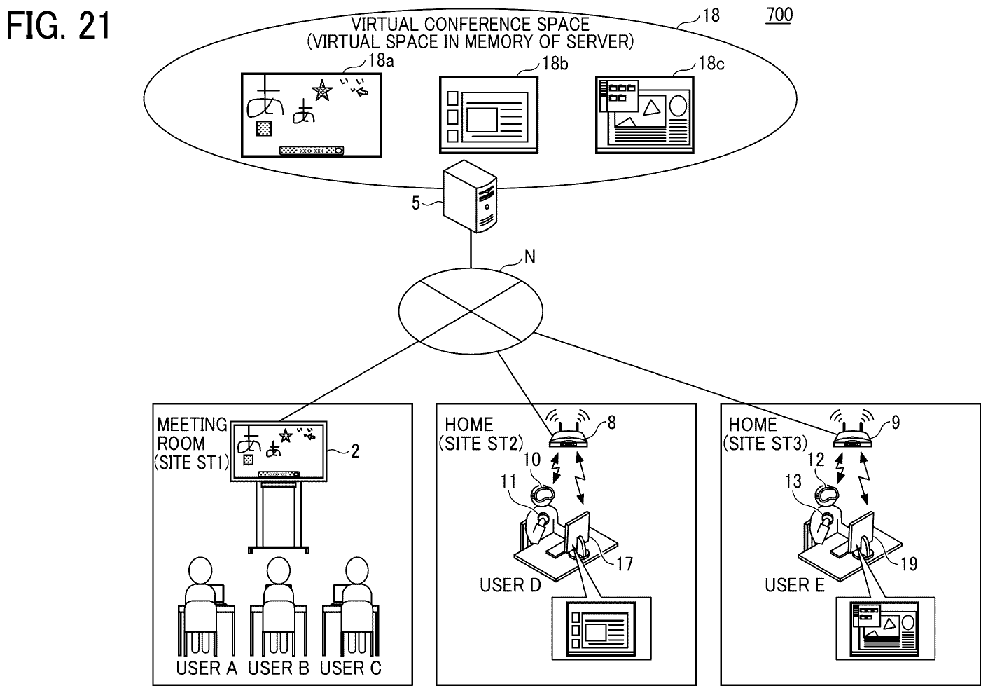

FIG. 21 is a schematic diagram illustrating a configuration of a virtual conference system 700. With reference to FIG. 20, a case is described in which users at a site ST1 (e.g., a meeting room) participate in a virtual conference using the electronic whiteboard 2, while users at sites 2 and 3 (e.g., homes) participate in the same virtual conference, each using virtual reality (VR) goggles and a VR operation controller. Each of the users at the sites 2 and 3 (homes) performs an operation for displaying, in the virtual conference, the content displayed by the PC, while one of the users at the site ST1 (meeting room) performs an operation for displaying, in the virtual conference, the content displayed by the electronic whiteboard 2. Accordingly, when the virtual conference server aggregates and arranges the contents, not only the contents input to the electronic whiteboard 2 but also the contents displayed by the PCs in addition to the contents input to the electronic whiteboard 2 are aggregated and arranged in the display region. Thus, the contents can be more easily viewed at a glance.

In the virtual conference, a virtual conference server 5 aggregates and displays the contents of the respective sites. The virtual conference server 5 transmits the display data of the contents arranged in a virtual space (referred to as a virtual conference space 18) to the electronic whiteboard 2 and VR goggles 10 and 12. The virtual conference server 5 also arranges the contents of the display data received from the electronic whiteboard 2 and PCs 17 and 19 (examples of a communication terminal) in the virtual space. The virtual conference space 18 is formed in a memory of the virtual conference server 5, and the contents of the display data transmitted from the electronic whiteboard 2 and the PCs 17 and 19 are written in the virtual conference space 18.

When one of the electronic whiteboard 2 and the PCs 17 and 19 requests the aggregation display of contents, the virtual conference server 5 aggregates the contents of the display data transmitted from the devices at the respective sites in a region corresponding to the display region 251 and transmits the display data of the aggregated contents to the electronic whiteboard 2 and the PCs 17 and 19. The region corresponding to the display region 251 refers to a region having the same area as that of the display region 251 of the electronic whiteboard 2. The details are described below.

### Configuration of System

As illustrated in FIG. 21, the electronic whiteboard 2 is located at the meeting room (site ST1) where users A to C are present, a user D is present at home (site ST2), and a user E is present at home (site ST3). The virtual conference server 5, the electronic whiteboard 2, the PCs 17 and 19, and the VR goggles 10 and 12 are connected to the communication network N such as the Internet.

The virtual conference server 5 is an example of an information processing apparatus (an example of the first information processing apparatus) that aggregates and displays the contents. The virtual conference server 5 executes a virtual conference application. In the following description, a service provided by the virtual conference application executed by the virtual conference server 5 is referred to as a virtual conference service. The virtual conference space 18 is, for example, a 360-degree three-dimensional space that simulates a meeting room in virtual space, but may alternatively be a planar space that is larger than the display regions of the respective devices. The respective devices refer to the electronic whiteboard 2, the PCs 17 and 19, and the VR goggles 10 and 12. The data of the virtual conference space 18 is screen data of the respective devices. Of the data of the virtual conference space 18, the screen data of the electronic whiteboard 2 (an example of the second information processing apparatus) is referred to as a virtual whiteboard 18a. Of the data of the virtual conference space 18, the screen data of the PC 17 used by the user D is referred to as virtual PC screen data 18b. Of the data of the virtual conference space 18, the screen data of the PC 19 used by the user E is referred to as virtual PC screen data 18c. The virtual whiteboard 18a is synchronized with the contents of the electronic whiteboard 2. The virtual PC screen data 18b is synchronized with the screen data of the PC 17. The virtual PC screen data 18c is synchronized with the screen data of the PC 19. The VR goggles 10 and 12 each display an image based on the data of the virtual conference space 18.

The electronic whiteboard 2 is located at the meeting room where the users A, B, and C are present. The electronic whiteboard 2 is connected to the communication network N and communicates with the virtual conference server 5.

The user D is at home (or may alternatively be at a satellite office). A WIRELESS FIDELITY (Wi-Fi) router 8 is installed at home. The user D uses the PC 17, the VR goggles 10, and a VR operation controller 11. The Wi-Fi router 8 at the home of the user D can be connected to the communication network N. The PC 17 and the VR goggles 10 of the user D can communicate with the Wi-Fi router 8 wirelessly. The VR goggles 10 and the VR operation controller 11 can communicate with each other via wireless communication such as BLUETOOTH. The PC 17 and the VR goggles 10 are also connected to each other via, for example, BLUETOOTH. On the PC 17 of the user D, the virtual conference application for communicating with the virtual conference server 5 is activated. Multiple users may participate in the conference, each wearing the VR goggles 10.

The user E is at home (or may alternatively be at a satellite office). A Wi-Fi router 9 is installed at home. The user D uses the PC 19, the VR goggles 12, and a VR operation controller 13. The Wi-Fi router 9 at the home of the user E can be connected to the communication network N. The PC 19 and the VR goggles 12 of the user E can communicate with the Wi-Fi router 9 wirelessly. The VR goggles 12 and the VR operation controller 13 can communicate with each other via wireless communication such as BLUETOOTH. The PC 19 and the VR goggles 12 are also connected to each other via, for example, BLUETOOTH. On the PC 19 of the user E, the virtual conference application for communicating with the virtual conference server 5 is activated. Multiple users may participate in the conference, each wearing the VR goggles 12.

Instead of the VR goggles, augmented reality (AR) goggles or mixed reality (MR) goggles may be used as the head-mounted display.

Display data of a content input to the electronic whiteboard 2 at the site1 is transmitted to the virtual conference server 5. The virtual conference server 5 writes the display data of this content in the virtual whiteboard 18a and transmits the data of the video of the virtual conference space 18 to the VR goggles 10 and 12. Thus, the drawing data of the electronic whiteboard 2 is synchronized (shared) between the site ST1 and the sites 2 and 3. Similarly, the drawing data of handwriting made in the virtual whiteboard 18a in the virtual conference space 18 by the user at the site ST2 is transmitted to the virtual conference server 5. The virtual conference server 5 writes the drawing data in the virtual whiteboard 18a and transmits the drawing data to the electronic whiteboard 2 and the VR goggles 12. Thus, the drawing data of the virtual whiteboard 18a is synchronized between the site ST2 and the sites 1 and 3. The drawing data at the site ST3 is also synchronized in the same manner.

In addition, the screen data of the PC 17 at the site ST2 is transmitted to the virtual conference server 5 and written in the virtual conference space 18 as the virtual PC screen data 18b. When the user D performs a predetermined operation, the screen image of the virtual PC screen data 18b is copied onto the virtual whiteboard 18a. The virtual conference server 5 transmits the display data of the contents in the virtual whiteboard 18a to the electronic whiteboard 2. Thus, the screen data of the PC 17 at the site ST2 is shared between the sites 1 and 2.

### Hardware Configuration

### VR Goggles

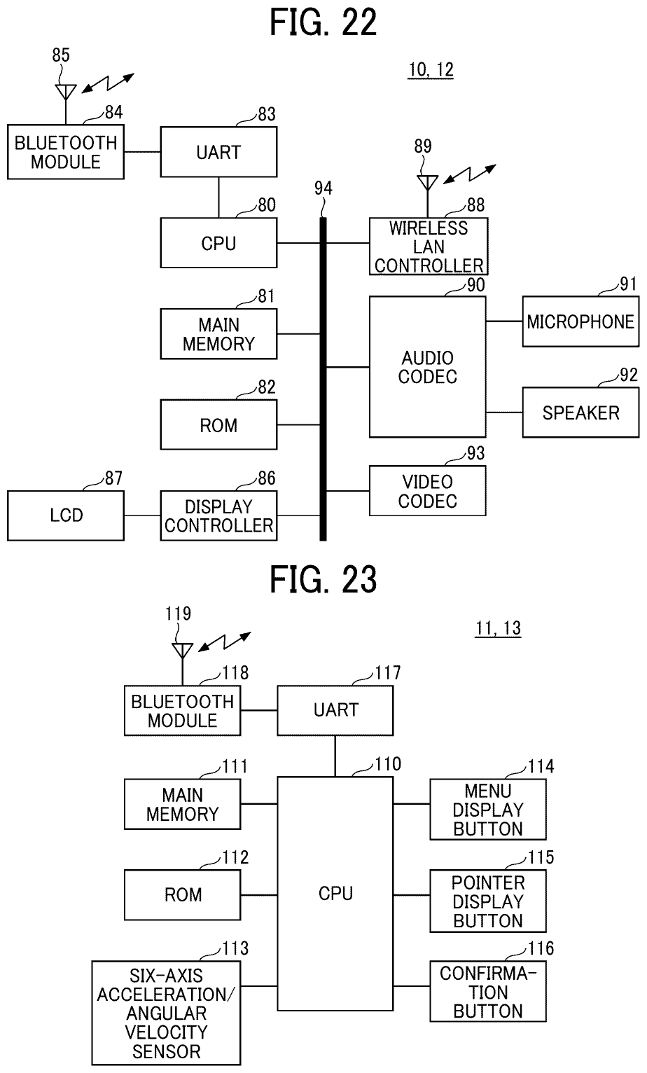

FIG. 22 is a block diagram illustrating a hardware configuration of each of the VR goggles 10 and 12. Each of the VR goggles 10 and 12 includes a CPU 80, a main memory 81, a ROM 82, a display controller 86, a wireless LAN controller 88, an audio codec 90, and a video codec 93, which are connected to each other via a bus 94.

The CPU 80 executes an OS and a control processing program read from the ROM 82 onto the main memory 81, to perform various types of processing. The main memory 81 includes a dynamic random-access memory (DRAM) and is used as, for example, a work area for the CPU 80.

In the ROM 82, the OS, a system program that runs at power on, and a program for controlling the VR goggles 10 or 12 to which the ROM 82 belongs are written in advance.

A universal asynchronous receiver-transmitter (UART) 83 is connected to the CPU 80. The UART 83 is an interface for serial data transmission and reception between the CPU 80 and a BLUETOOTH module 84, and includes, for example, a first-in first-out (FIFO) memory and a shift register.

The BLUETOOTH module 84 includes a radio frequency (RF) section and a baseband section, and is connected to an antenna 85. The BLUETOOTH module 84 performs wireless communication in compliance with the BLUETOOTH standard.

The display controller 86 performs digital-to-analogue (D/A) conversion of, for example, text data, graphic data, and image data, and controls the LCD 87 to display these pieces of data as images. The LCD 87 is a display device that displays information.

The wireless LAN controller 88 executes a communication protocol conforming to, for example, the Institute of Electrical and Electronics Engineers (IEEE) 802.11ax standard, and controls communication with other devices by transmitting and receiving radio waves via the antenna 89.

An audio signal input from the microphone 91 is converted into audio data by an analog-to-digital (A/D) conversion circuit, and the audio data is encoded by the audio codec 90 in accordance with an advanced audio coding (AAC) system. Further, AAC coded data received from an external device is decoded by the audio codec 90, converted into an analog signal by a D/A conversion circuit, and output from the speaker 92 as sound. The video codec 93 decodes compressed video data received from an external device. The compressed video data may be formatted in compliance with, for example, the International Telecommunication Union Telecommunication Standardization Sector (ITU-T) Recommendation H.264. Among the components described above, the data is exchanged via the bus 94.

### VR Operation Controller

FIG. 23 is a block diagram illustrating a hardware configuration of each of the VR operation controllers 11 and 13. Each of the VR operation controllers 11 and 13 includes a UART 117, a main memory 111, a ROM 112, a six-axis acceleration/angular velocity sensor 113, a menu display button 114, a pointer display button 115, and a confirmation button 116, which are connected to a CPU 110.

The CPU 110 executes a control processing program read from the ROM 112 onto the main memory 111 to perform control processing. The main memory 111 includes a DRAM and is used as, for example, a work area for the CPU 110.

In the ROM 112, a system program that runs at power on and a program for transmitting information on pressing of the menu display button 114, the pointer display button 115, or the confirmation button 116 via BLUETOOTH are written in advance.

The six-axis acceleration/angular velocity sensor 113 outputs measurement data of acceleration and angular velocity. The UART 117 is an interface for serial data transmission and reception between the CPU 110 and a BLUETOOTH module 118, and includes, for example, a FIFO memory and a shift register. The BLUETOOTH module 118 includes an RF section and a baseband section, and is connected to an antenna 119. The BLUETOOTH module 118 performs wireless communication in compliance with the BLUETOOTH standard.

### Virtual Conference Server

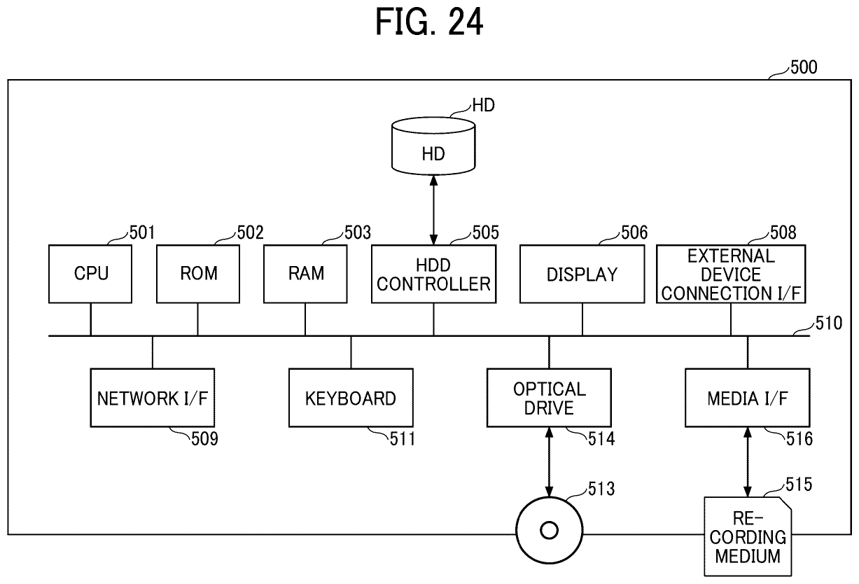

FIG. 24 is a block diagram illustrating a hardware configuration of the virtual conference server 5. As illustrated in FIG. 24, the virtual conference server 5 is implemented by a computer 500. The computer 500 includes a CPU 501, a ROM 502, a RAM 503, an HD 504, an HDD controller 505, a display 506, an external device connection I/F 508, a network I/F 509, a bus line 510, a keyboard 511, an optical drive 514, and a media I/F 516.

The CPU 501 controls the overall operation of the virtual conference server 5. The ROM 502 stores a program such as an IPL used for booting the computer 500. The RAM 503 is used as a work area for the CPU 501. The HD 504 stores various data such as a program. The HDD controller 505 controls the reading or writing of data from or to the HD 504 under the control of the CPU 501. The display 506 displays various information such as a cursor, a menu, a window, characters, and images. The external device connection I/F 508, which may be implemented by an interface circuit, is an interface for connection with various external devices. Examples of the external devices in this case include, but are not limited to, a USB memory and a printer. The network I/F 509, which may be implemented by an interface circuit, is an interface that controls data communication through a network. The bus line 510 is, for example, an address bus or a data bus, which electrically connects the components or elements such as the CPU 501 illustrated in FIG. 24.

The keyboard 511 is an example of an input device used for, for example, inputting characters, numerical values, and various instructions. The optical drive 514 controls the reading or writing of various data from or to an optical recording medium 513, which is an example of a removable recording medium. The optical recording medium 513 may be, for example, a compact disc (CD), a digital versatile disc (DVD), or a BLU-RAY disc. The media I/F 516, which may be implemented by an interface circuit, controls the reading or writing (storing) of data from or to (in) a recording medium 515 such as a flash memory.

### Functions

### Virtual Conference Server and Electronic Whiteboard

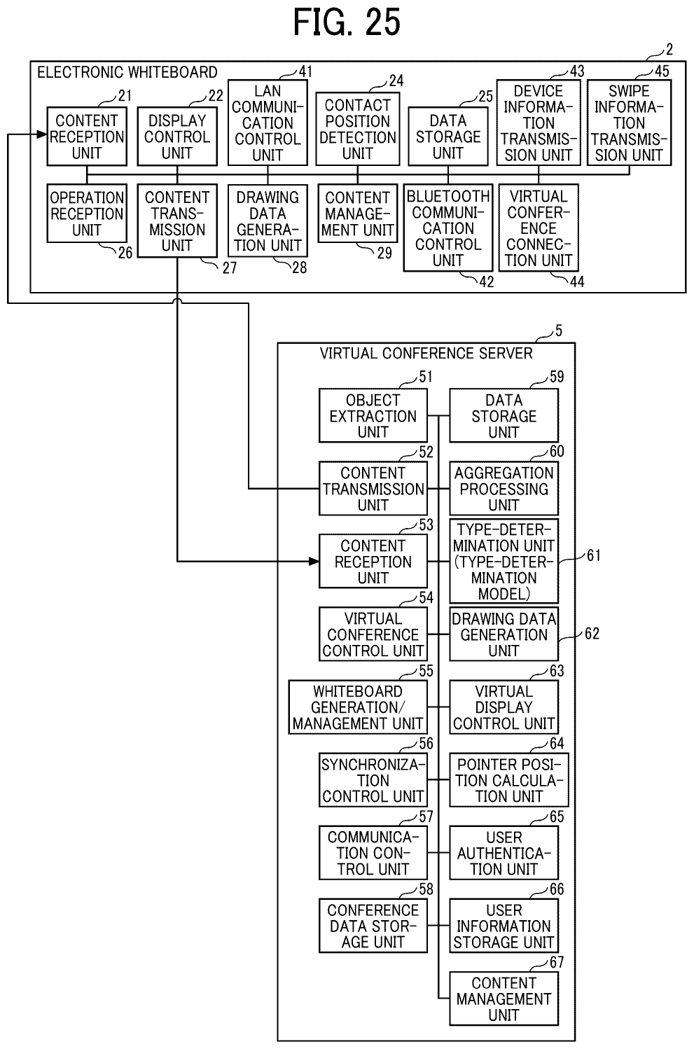

FIG. 25 is a block diagram illustrating functional configurations of the virtual conference server 5 and the electronic whiteboard 2.

### Electronic Whiteboard

The electronic whiteboard 2 includes the content reception unit 21, the display control unit 22, the contact position detection unit 24, the data storage unit 25, the operation reception unit 26, the content transmission unit 27, the drawing data generation unit 28, the content management unit 29, a LAN communication control unit 41, a BLUETOOTH communication control unit 42, a device information transmission unit 43, a virtual conference connection unit 44, and a swipe information transmission unit 45. These functional units of the electronic whiteboard 2 are implemented by or caused to function by one or more of the hardware components illustrated in FIG. 3 operating in accordance with instructions from the CPU 401 according to the control program (virtual conference application) loaded from the SSD 404 to the RAM 403. The contact position detection unit 24, the drawing data generation unit 28, the data storage unit 25, the content transmission unit 27, and the content reception unit 21 may have substantially the same functions as those in the first embodiment.

The display control unit 22 performs control for displaying a content input to the electronic whiteboard 2 and a content of display data transmitted from the virtual conference server 5 on the display 480.

The LAN communication control unit 41 transmits or receives data except the display data of the content to or from the virtual conference server 5. Specifically, the LAN communication control unit 41 is connected to the communication network N such as ETHERNET, and transmits or receives data to or from other devices via the communication network N.

The BLUETOOTH communication control unit 42 performs communication in compliance with the BLUETOOTH standard. The virtual conference connection unit 44 performs control for connecting to the virtual conference service performed by the virtual conference server 5 using a uniform resource locator (URL) of the virtual conference service and a conference ID set in advance.

The device information transmission unit 43 transmits the device information to the virtual conference server 5 and receives authentication for participating in the conference from the virtual conference server 5.

When the user performs an operation for swiping the display region 251 on the electronic whiteboard 2, the swipe information transmission unit 45 transmits the direction and length of the swiping to the virtual conference server 5 via the LAN communication control unit 41.

### Virtual Conference Server

The virtual conference server 5 includes an object extraction unit 51, a content transmission unit 52, a content reception unit 53, a virtual conference control unit 54, a whiteboard generation/management unit 55, a synchronization control unit 56, a communication control unit 57, a conference data storage unit 58, a data storage unit 59, an aggregation processing unit 60, a type-determination unit 61, a drawing data generation unit 62, a virtual display control unit 63, a pointer position calculation unit 64, a user authentication unit 65, a user information storage unit 66, and a content management unit 67. These functional units of the virtual conference server 5 are implemented by or caused to function by one or more of the hardware components illustrated in FIG. 24 operating in accordance with instructions from the CPU 501 according to the control program loaded from the HD 504 to the RAM 503. The content transmission unit 52, the content reception unit 53, the data storage unit 59, the aggregation processing unit 60, the type-determination unit 61, the drawing data generation unit 62, and the content management unit 67 may have substantially the same functions as those of the corresponding functional units in the electronic whiteboard 2 described in the first embodiment.

The object extraction unit 51 determines the boundary of an object from the data added to the virtual whiteboard 18a and extracts the object. The object refers to an item that can be separated and displayed in any region. Examples of the object include handwriting of drawing data, an icon, text of text data, and a figure. In the case where the object is identified as handwriting of drawing data, the object extraction unit 51 groups the pieces of drawing data of the handwriting. For example, all pieces of drawing data of the handwriting in one screen may be grouped together as a single group, or some pieces of drawing data of the handwriting may be grouped based on the distance between the handwriting representing the pieces of drawing data.

The content transmission unit 52 transmits the display data of the contents transmitted from the PCs 17 and 19 to the electronic whiteboard 2. The content transmission unit 52 transmits the display data of the contents transmitted from the electronic whiteboard 2 to the VR goggles 10 and 12.

The content reception unit 53 receives the display data of the contents transmitted from the PCs 17 and 19. The content reception unit 53 receives the display data of the contents transmitted from the electronic whiteboard 2.

The virtual conference control unit 54 controls the conference data storage unit 58 to store the information on the participants in the conference and the information on the devices such as the PCs 17 and 19 and the VR goggles 10 and 12 participating in the conference in association with identification information (a conference ID) for identifying the conference. The virtual conference control unit 54 performs a remote conference among the devices for each conference ID. The virtual conference control unit 54 controls the conference data storage unit 58 to store the screen data of the virtual whiteboard and the audio data received from the devices participating in the virtual conference.

The whiteboard generation/management unit 55 generates the virtual whiteboard 18a in the virtual conference space 18 and manages the virtual whiteboard 18a.

The synchronization control unit 56 synchronizes the electronic whiteboard 2 and the virtual whiteboard 18a such that the contents of the display data in the memory of the electronic whiteboard 2 match the contents of the display data in the virtual whiteboard 18a. Specifically, the synchronization control unit 56 has a function of detecting update of the contents of the display data in the memory of the electronic whiteboard 2 and the contents of the display data in the virtual whiteboard 18a. The synchronization control unit 56 has a function of reflecting the updated contents of the display data in the memory of the electronic whiteboard 2 to the contents of the display data in the virtual whiteboard 18a. The synchronization control unit 56 has a function of reflecting the updated contents of the display data in the virtual whiteboard 18a to the contents of the display data in the memory of the electronic whiteboard 2.

The communication control unit 57 exchanges data among the electronic whiteboard 2, the PCs 17 and 19, and the VR goggles 10 and 12.

The conference data storage unit 58 stores, for example, the virtual whiteboard 18a, the virtual PC screen data 18b and 18c, and audio data received from the other devices participating in the virtual conference.

The drawing data generation unit 62 generates, for example, a menu displayed in the virtual conference space 18 and a pointer instructed to be displayed by the VR operation controller 11 or 13. The drawing data generation unit 62 also generates drawing data from a trajectory (coordinate point sequence) of the pointer transmitted from the VR operation controller 11 or 13 or a figure such as a circle or a rectangle.

The virtual display control unit 63 performs control for displaying the screen data of the PCs 17 and 19 in the virtual conference space 18 as the screen images of the virtual PC screen data 18b and 18c, respectively. The virtual display control unit 63 also performs control for displaying, for example, the menu and the pointer in the virtual conference space 18.

The pointer position calculation unit 64 calculates the position of the pointer (in the virtual conference space 18) indicated by the direction and movement of the VR operation controller 11 or 13.

The user authentication unit 65 collates the username and password received via the communication control unit 57 with the username and password stored in the user information storage unit 66 to authenticate the user who participates in the virtual conference.

The user information storage unit 66 stores the usernames and passwords of the users who participate in the virtual conference.

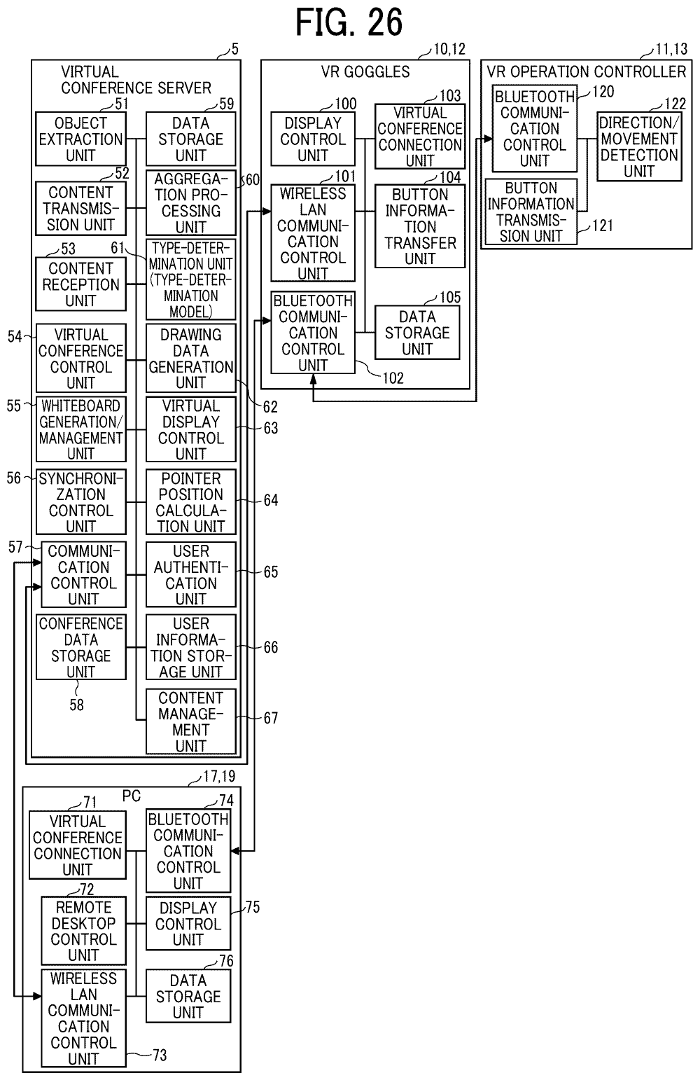

FIG. 26 is a block diagram illustrating functional configurations of the virtual conference server 5, the PCs 17 and 19, the VR goggles 10 and 12, and the VR operation controllers 11 and 13.

### Personal Computer (PC)

Each of the PCs 17 and 19 includes a virtual conference connection unit 71, a remote desktop control unit 72, a wireless LAN communication control unit 73, a BLUETOOTH communication control unit 74, a display control unit 75, and a data storage unit 76. These functional units of each of the PCs 17 and 19 are implemented by or caused to function by one or more of the hardware components illustrated in FIG. 4 operating in accordance with instructions from the CPU 521 according to the control program (virtual conference application) loaded from the HD 524 to the RAM 523.

The virtual conference connection unit 71 connects to the virtual conference service provided by the virtual conference server 5 and transmits the username and password used as the authentication data. In addition, the virtual conference connection unit 71 manages the URL of the virtual conference space 18 and the conference ID received from the virtual conference service, and also connects to the address indicated by the URL of the virtual conference space 18 to perform processing for participating in the virtual conference. Furthermore, the virtual conference connection unit 71 transmits the URL of the virtual conference space 18 and the conference ID to the VR goggles 10 or 12 via the BLUETOOTH communication control unit 74.

The remote desktop control unit 72 transmits the screen data of the PC 17 or 19 to the virtual conference service so that the screen data is displayed as screen images in the virtual conference space 18.

The wireless LAN communication control unit 73 performs communication with the virtual conference server 5 via the Wi-Fi router 8 or 9.

The BLUETOOTH communication control unit 74 performs communication with the VR goggles 10 or 12 in compliance with the BLUETOOTH standard. The display control unit 75 performs control for displaying the screen data as a screen image on a display (liquid crystal display (LCD)).

The data storage unit 76 stores, for example, the address (URL) of the virtual conference service provided by the virtual conference server 5, the URL of the virtual conference space 18 received from the virtual conference service, the conference ID, and the username and password of the user who uses the PC 17 or 19.

### Virtual Reality (VR) Goggles

Each of the VR goggles 10 and 12 includes a display control unit 100, a wireless LAN communication control unit 101, a BLUETOOTH communication control unit 102, a virtual conference connection unit 103, a button information transfer unit 104, and a data storage unit 105. These functional units of each of the VR goggles 10 and 12 are implemented by or caused to function by one or more of the hardware components illustrated in FIG. 22 operating in accordance with instructions from the CPU 80 according to the control program (virtual conference application) loaded from the ROM 82 to the main memory 81.

The display control unit 100 performs control for displaying the contents of the virtual whiteboard 18a and the virtual PC screen data 18b and 18c transmitted from the virtual conference service on the LCD 87. The wireless LAN communication control unit 101 performs communication with the virtual conference server 5 via the Wi-Fi router 8 or 9.

The BLUETOOTH communication control unit 102 performs communication with the VR operation controller 11 or 13 in compliance with the BLUETOOTH standard. The virtual conference connection unit 103 performs control for connecting to the virtual conference service provided by the virtual conference server 5 using the URL of the virtual conference service and the conference ID transmitted from the PC 17 or 19.

The button information transfer unit 104 receives information on pressing of a button from the VR operation controller 11 or 13, and transmits the information on the pressed button to the virtual conference server 5 via the wireless LAN communication control unit 101.

The data storage unit 105 stores, for example, the address (URL) of the virtual conference service provided by the virtual conference server 5, the conference ID, and the username and password of the user who uses the VR goggles 10 or 12.

### Virtual Reality (VR) Operation Controller

Each of the VR operation controllers 11 and 13 includes a BLUETOOTH communication control unit 120, a button information transmission unit 121, and a direction/movement detection unit 122. These functional units of each of the VR operation controllers 11 and 13 are implemented by or caused to function by one or more of the hardware components illustrated in FIG. 23 operating in accordance with instructions from the CPU 110 according to the control program loaded from the ROM 112 to the main memory 111.

The BLUETOOTH communication control unit 120 performs communication with the VR goggles 10 or 12 in compliance with the BLUETOOTH standard. The button information transmission unit 121 transfers information on pressing the menu display button 114, the pointer display button 115, or the confirmation button 116 to the BLUETOOTH communication control unit 120.

The direction/movement detection unit 122 detects the direction (posture in the three-dimensional space) and movement of the VR operation controller 11 or 13 based on the data of the acceleration and angular velocity obtained from the six-axis acceleration/angular velocity sensor 113, and transfers these pieces of information to the BLUETOOTH communication control unit 120.

### Participation of Users in Conference

The processes when the users participate in the conference are described below. The users A to C participate in the conference from the meeting room (site ST1). The users A to C participate in the conference using the electronic whiteboard 2. When one of the users A to C in the meeting room (site ST1) touches a “conference participation” button displayed on the electronic whiteboard 2, the LAN communication control unit 41 of the electronic whiteboard 2 connects to the virtual conference server 5. The device information transmission unit 43 transmits the device information.

When the virtual conference server 5 authenticates the electronic whiteboard 2 based on the device information, the virtual conference server 5 determines whether a conference in which the electronic whiteboard 2 is qualified to participate is registered within a certain period of time from the current time. When a conference in which the electronic whiteboard 2 is qualified to participate is determined to be registered, the virtual conference server 5 permits the electronic whiteboard 2 to participate in the conference. The permission of the participation means that the drawing data can be shared with the devices at the other sites. Subsequently, the synchronization control unit 56 of the virtual conference server 5 starts a synchronization process between the electronic whiteboard 2 and the virtual whiteboard 18a.

The user D participates in the conference from the home (site ST2). The user D wears the VR goggles 10 and participates in the conference (in a visual state as if the use D were in the virtual conference space). When the virtual conference application on the PC 17 is activated in response to an operation performed by the user D, the virtual conference connection unit 44 connects to the virtual conference service provided by the virtual conference server 5 and displays a screen for entering a username and a password. The URL of the virtual conference service provided by the virtual conference server 5 is registered in the PC 17 in advance as setting data of the virtual conference application. When the user D enters the username and the password, the virtual conference connection unit 44 transmits these pieces of data to the virtual conference server 5. The virtual conference server 5 authenticates the user and transmits information indicating successful authentication to the PC 17 as a response.

The virtual conference application on the PC 17 causes a button for participation in a virtual conference to be displayed. When the user D selects the button, the virtual conference application causes a screen for entering the URL of the virtual conference space 18 and the conference ID to be displayed. When the user D enters the URL of the virtual conference space 18 and the conference ID and presses an OK button, the virtual conference connection unit 44 transmits a connection command including the conference ID to the address indicated by the URL of the virtual conference space 18.

The virtual conference server 5 determines whether a conference in which the user D is qualified to participate is registered within a certain period of time from the current time. When a conference in which the user D is qualified to participate is determined to be registered, the virtual conference server 5 permits the PC 17 to connect to the virtual conference space 18.

Subsequently, the virtual conference application on the PC 17 transmits the URL of the virtual conference space 18 and the conference ID to the VR goggles 10 of the user D via BLUETOOTH. When the VR goggles 10 receive these pieces of data, the virtual conference connection unit 103 transmits a connection command including the conference ID to the address indicated by the URL of the virtual conference space 18. The virtual conference service provided by the virtual conference server 5 collates the received conference ID with the conference ID of the conference in which the PC 17 is permitted to participate. When matching of the conference IDs is confirmed, the virtual conference service provided by the virtual conference server 5 permits the VR goggles 10 to connect to the virtual conference space 18.

When connecting to the virtual conference space 18, the virtual conference application on the PC 17 causes a button for selecting a remote desktop to be displayed. When the user D selects the button, the remote desktop control unit 72 transmits the screen data of the PC 17 to the virtual conference server 5 and causes the screen data to be displayed as a screen image of the virtual PC screen data 18b in the virtual conference space 18. Subsequently, the virtual conference service provided by the virtual conference server 5 transmits the updated display data of the virtual conference space 18 to the VR goggles 10. The VR goggles 10 cause the updated display data to be displayed as an image on the LCD 87. The virtual display control unit 63 of the virtual conference server 5 controls the screen image of the virtual PC screen data 18b of the PC 17 displayed in the virtual conference space 18, so that the screen image is displayed only on the VR goggles 10 of the user D.

The processes for the user E at home (site ST3) to participate in the virtual conference may be substantially the same as those for the user D.

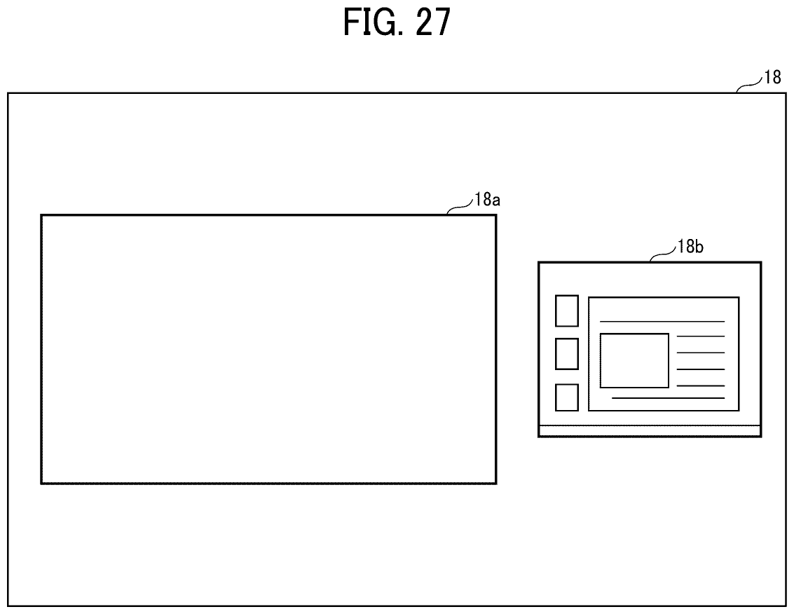

FIG. 27 is a diagram illustrating a display example of the virtual conference space 18 displayed on the VR goggles 10 of the user D. As illustrated in FIG. 27, in the virtual conference space 18, the virtual whiteboard 18a and the virtual PC screen data 18b are displayed as the respective screen images. Similarly, on the VR goggles 12 of the user E, the virtual whiteboard 18a and the virtual PC screen data 18c are displayed as the respective screen images. The virtual whiteboard 18a does not include a menu bar 254 in FIG. 27, but may include one.

The user D holds the VR operation controller 11 with the grip portion (i.e., the portion held by the hand) facing upward. The VR operation controller 11 transmits output data (information on the direction and movement) received from the six-axis acceleration/angular velocity sensor 113 to the virtual conference server 5 via the VR goggles 10. The virtual conference server 5 determines that the VR operation controller 11 is upside down based on the output data. Then, the whiteboard generation/management unit 55 of the virtual conference server 5 sets the handwriting mode for the virtual whiteboard 18a, and displays the position of the VR operation controller 11 at that time as a pen mark at the upper-left corner on the screen image of the virtual whiteboard 18a. In this state, when the user D moves the VR operation controller 11 on a plane perpendicular to the ground, the pen mark also moves in that direction. When the user D moves the VR operation controller 11 in the depth direction (the direction away from the body of the user D on a plane horizontal to the ground) by a certain distance, the drawing data generation unit 62 determines that the pen-down state is established. Subsequently, when the user D moves the VR operation controller 11 on a plane perpendicular to the ground and performs an operation for handwriting, the drawing data generation unit 62 generates drawing data based on the trajectory of the movement. The drawing data generation unit 62 writes the drawing data in the virtual whiteboard 18a. When the user D moves the VR operation controller 11 in the depth direction (the direction away from the body of the user D on a plane horizontal to the ground) by a certain distance, the drawing data generation unit 62 determines that the pen-up state is established.

In this way, the user D uses the VR operation controller 11 to handwrite text on the screen image of the virtual whiteboard 18a. The synchronization control unit 56 of the virtual conference server 5 transmits the drawing data to the electronic whiteboard 2. The electronic whiteboard 2 displays the drawing data as an image on the display 480.

### Operations or Processes

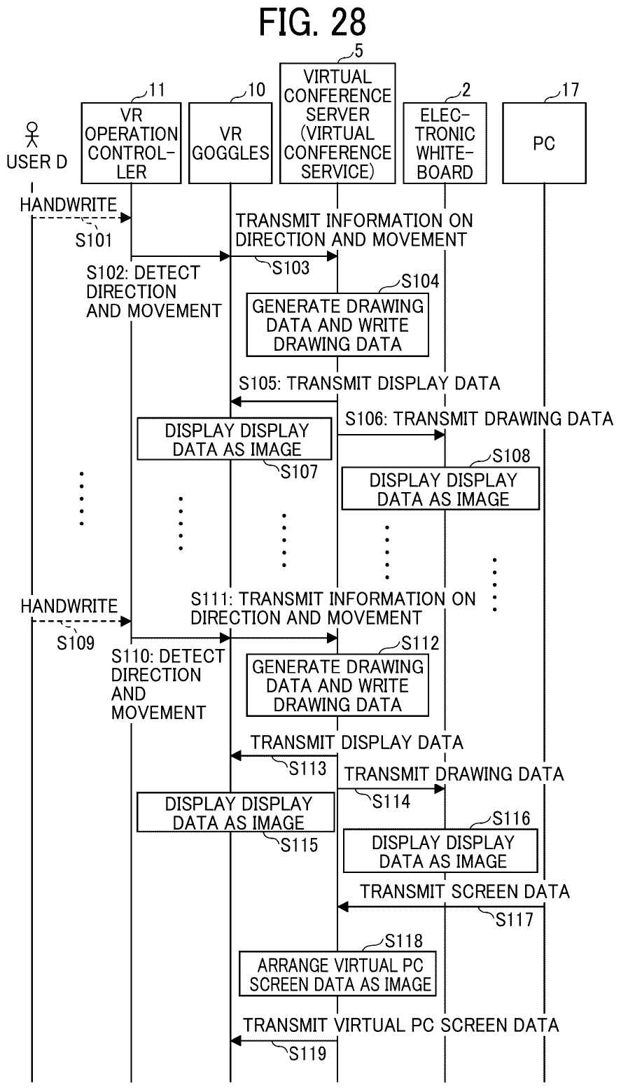

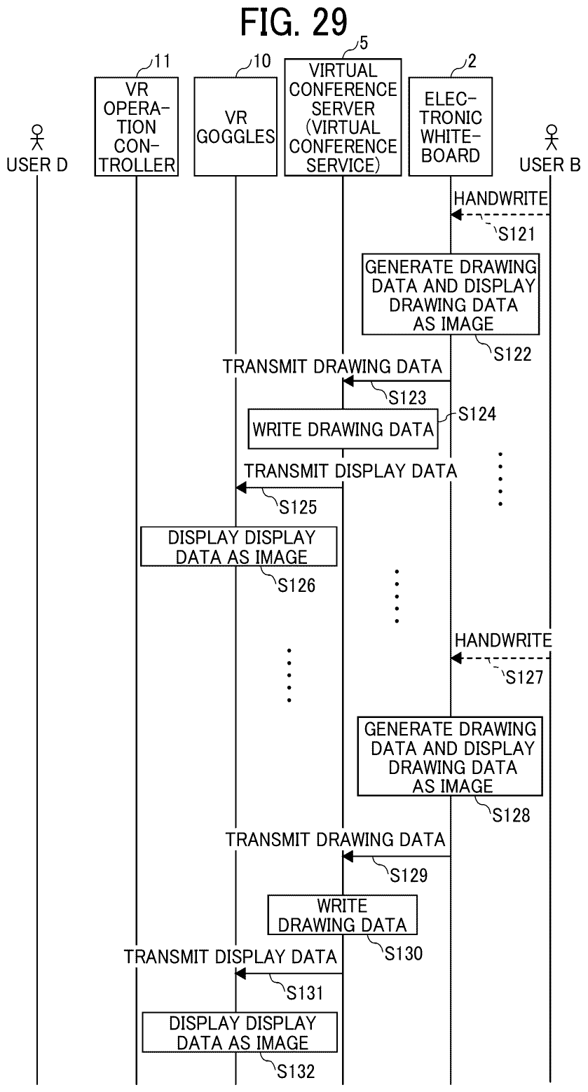

FIG. 28 is a sequence diagram illustrating a process for drawing handwriting performed by the VR operation controller 11. FIG. 29 is a sequence diagram illustrating a process for drawing handwriting in the electronic whiteboard 2. In the description with reference to FIG. 28, it is assumed that the electronic whiteboard 2 and the user D have already participated in the conference.

In S101, the user D holds the VR operation controller 11 with the grip portion (i.e., the portion held by the hand) facing upward and moves the VR operation controller 11 in the depth direction (the direction away from the body of the user D on a plane horizontal to the ground) by a certain distance (pen down). The user D moves the VR operation controller 11 on a plane perpendicular to the ground and performs an operation for handwriting.

In S102, the direction/movement detection unit 122 of the VR operation controller 11 detects the direction (posture in the three-dimensional space) and movement of the VR operation controller 11 based on the data of the acceleration and angular velocity received from the six-axis acceleration/angular velocity sensor 113. The BLUETOOTH communication control unit 120 transmits the information on the direction and movement to the VR goggles 10.

In S103, the BLUETOOTH communication control unit 102 of the VR goggles 10 receives the information on the direction and movement of the VR operation controller 11. The wireless LAN communication control unit 101 transmits the information to the virtual conference server 5.

In S104, the communication control unit 57 of the virtual conference server 5 receives the information. The pointer position calculation unit 64 calculates the position of the pointer. When the drawing data generation unit 62 determines that the direction (posture in the three-dimensional space) of the VR operation controller 11 is such that the grip portion (portion held by the hand) is facing upward, the drawing data generation unit 62 generates drawing data based on the trajectory of the position of the pointer. The drawing data generation unit 62 writes the drawing data in the virtual whiteboard 18a.

In S105, the virtual display control unit 63 of the virtual conference server 5 updates the display data of the virtual whiteboard 18a. The communication control unit 57 transmits the updated display data to the VR goggles 10.

In S106, the content transmission unit 52 of the virtual conference server 5 transmits the drawing data to the electronic whiteboard 2 via the communication control unit 57.

In S107, the wireless LAN communication control unit 101 of the VR goggles 10 receives the display data. The display control unit 100 performs control for displaying the display data as a screen image.

In S108, the content reception unit 21 of the electronic whiteboard 2 receives the drawing data. The display control unit 22 adds the drawing data to the current screen data to cause the display 480 to display the updated screen data as the screen image.

In S109 to S116, the same processes are repeatedly executed while the user D is handwriting using the VR operation controller 11.

In S117, when the user D selects the button for selecting a remote desktop caused to be displayed by the virtual conference application on the PC 17, the remote desktop control unit 72 transmits the screen data of the PC 17 to the virtual conference server 5.

In S118, the communication control unit 57 of the virtual conference server 5 receives the screen data. The virtual display control unit 63 arranges the screen image of the virtual PC screen data 18b in the virtual conference space 18.

In S119, the virtual conference server 5 transmits the virtual PC screen data 18b to the VR goggles 10 via the communication control unit 57.

With reference to FIG. 29, the synchronization when the handwriting is made on the electronic whiteboard 2 is described. In S121, the user B (or may alternatively be the user A or C) in the meeting room handwrites or causes a figure to be displayed on the display region 251 using the electronic pen 490.

In S122, the contact position detection unit 24 detects the position contacted by the electronic pen 490. The drawing data generation unit 28 generates drawing data or a figure to be displayed as an image.

In S123, the content transmission unit 27 of the electronic whiteboard 2 sequentially transmits the drawing data to the virtual conference server 5.

In S124, the content reception unit 53 of the virtual conference server 5 receives the drawing data. The synchronization control unit 56 writes the drawing data in the virtual whiteboard 18a.

In S125, the virtual conference server 5 transmits the display data of the virtual whiteboard 18a to the VR goggles 10 and 12 at homes via the communication control unit 57.

In S126, the wireless LAN communication control unit 101 of the VR goggles 10 receives the display data of the virtual whiteboard 18a. The display control unit 100 performs control for displaying the display data as a screen image.

In S127 to S132, the same processes are repeatedly executed while the user B is handwriting on the electronic whiteboard 2.

### Aggregation Display of Virtual Whiteboard and Virtual PC Screen Data

Through the above-described processes, the virtual whiteboard 18a and the virtual PC screen data 18b and 18c are displayed in the virtual conference space 18 as the screen images.

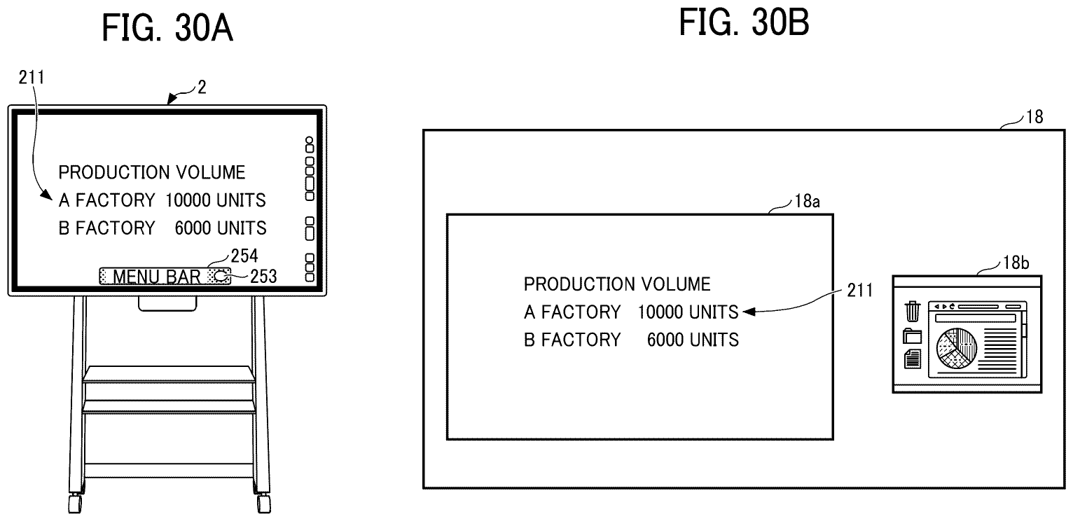

FIG. 30A is a diagram illustrating a display example of the electronic whiteboard 2. FIG. 30B is a diagram illustrating a display example of the virtual conference space 18 that the user D views.

When a content is added to the screen image of the virtual whiteboard 18a, the object extraction unit 51 analyzes the shape of the boundary line (edge) between display pixels and non-display pixels of the content, and determines that only text (drawing data) is displayed in the virtual whiteboard 18a. The display pixels refer to pixels whose value of the pixel data is not zero and the non-display pixels refer to pixels whose value of the pixel data is zero. The object extraction unit 51 groups the pieces of data of the text (drawing data).

The type-determination unit 61 determines that the group of the pieces of data of the text is a “drawing (handwriting).” The method of determination may be the same as that in the first embodiment.

The content management unit 67 causes the data storage unit 59 to store the coordinates of the upper-left corner (in the virtual conference space) of the rectangular region circumscribing the group and the size of the rectangular region (i.e., the number of display pixels in the lateral and vertical directions) together with the type of content that is the drawing data of handwriting.

In the present embodiment, the coordinates in the virtual conference space 18 are expressed by display coordinates where the pixel position at the upper-left corner of the screen image of the virtual whiteboard 18a is set as the origin, the rightward direction is set as the positive direction of the X-axis, and the downward direction is set as the positive direction of the Y-axis. In other words, the display coordinates are given by the number of pixels in the X-axis direction from the origin and the number of pixels in the Y-axis direction from the origin.

Subsequently, the screen image of the PC 17 used by the user D is to be displayed on the screen image of the virtual whiteboard 18a so that the other users can also view the screen image of the PC 17. For this purpose, the user A in the meeting room moves the content 211 displayed on the electronic whiteboard 2 to the outside of the display region 251 of the electronic whiteboard 2. When the user A performs a swipe operation in the leftward direction on the display of the electronic whiteboard 2, the electronic whiteboard 2 determines that the distance between the coordinates of two positions that the contact position detection unit 24 detects in the time interval is greater than a predetermined value and that the swipe operation has been performed. Then, the display control unit 22 of the electronic whiteboard 2 erases the display data of the content 211 (that is the drawing data of handwriting in FIG. 30) in the display memory. The display 480 of the electronic whiteboard 2 returns to a blank state. The swipe information transmission unit 45 of the electronic whiteboard 2 transmits information on the swipe operation (i.e., the direction and length, which is vector information) to the virtual conference server 5.

The virtual display control unit 63 of the virtual conference server 5 moves the content 211 to the left within the virtual conference space 18 in accordance with the direction and length of the movement of the swipe operation.

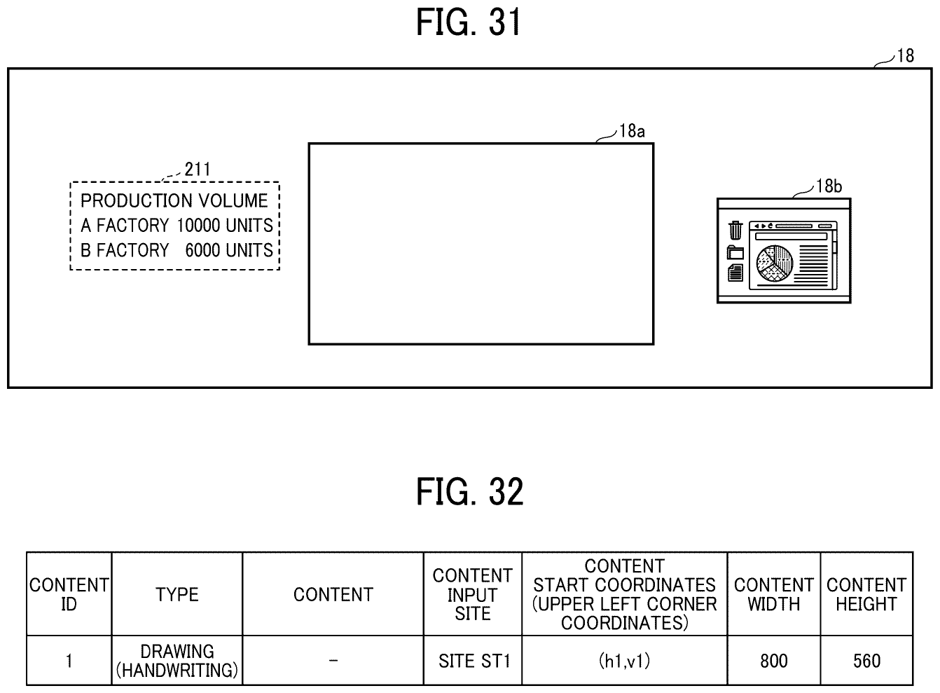

FIG. 31 is a diagram illustrating the virtual conference space 18 in which the content 211 is moved to the left. As illustrated in FIG. 31, the content 211 (a group of the pieces of drawing data), the screen image of the virtual whiteboard 18a, and the screen image of the virtual PC screen data 18b are displayed separately in the virtual conference space 18.

FIG. 32 is a diagram illustrating a content management table that the content management unit 67 manages. In the content management table, information on the content 211 that is the group of the pieces of drawing data is registered. The information to be managed may be the same as that in FIG. 10.

FIG. 33 is a diagram illustrating the screen image of the virtual PC screen data 18b in the virtual conference space 18. On the screen image of the virtual PC screen data 18b, a content 212 is presented. A movement bar 221 is added to the upper edge of the screen image of the virtual PC screen data 18b. When the user D presses and holds the pointer display button 115 on the VR operation controller 11 while placing the pointer over the movement bar 221, the screen image of the virtual PC screen data 18b enters a movable state.

When the user D moves the pointer while holding down the pointer display button 115, the screen image of the virtual PC screen data 18b also moves in accordance with the movement of the pointer. When the user D places the screen image of the virtual PC screen data 18b over the screen image of the virtual whiteboard 18a in this operation, the virtual display control unit 63 copies the screen image of the virtual PC screen data 18b to the screen image of the virtual whiteboard 18a. Subsequently, the user D moves the pointer superimposed and displayed on the movement bar while holding down the pointer display button 115 on the VR operation controller 11 in the same manner as described above, and separates the screen image of the virtual PC screen data 18b from the screen image of the virtual whiteboard 18a. This operation is for displaying the screen image of the virtual PC screen data 18b again in the virtual conference space 18. However, if the setting is such that the screen image of the virtual PC screen data 18b remains even after being copied to the screen image of the virtual whiteboard 18a, this operation does not need to be performed.

The synchronization control unit 56 of the virtual conference server 5 detects the update of the virtual whiteboard 18a. The synchronization control unit 56 transmits the display data of the contents on the screen image of the virtual whiteboard 18a to the electronic whiteboard 2 via the communication control unit 57. The electronic whiteboard 2 displays the received contents on the screen image of the virtual whiteboard 18a.

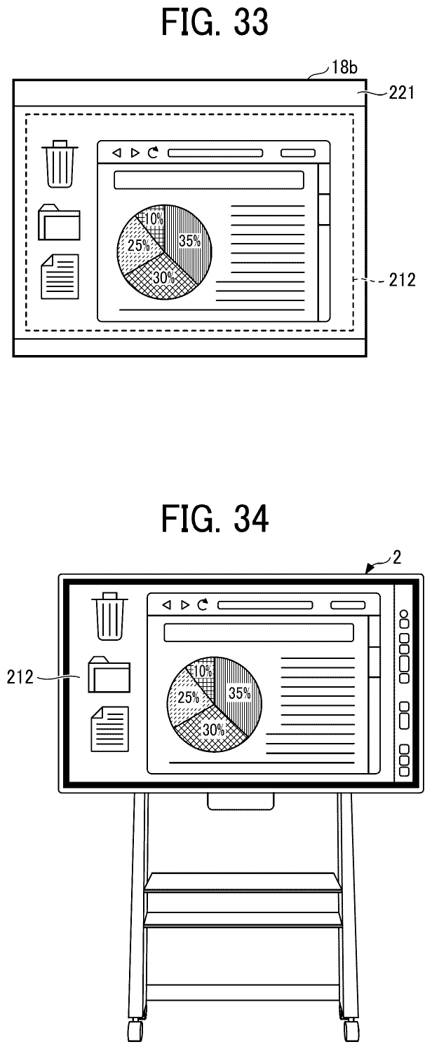

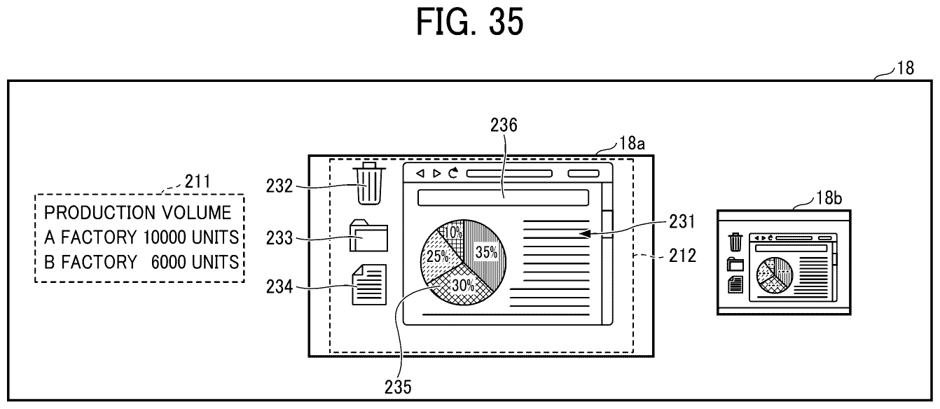

FIG. 34 is a diagram illustrating the content 212 on the screen image of the virtual whiteboard 18a displayed by the electronic whiteboard 2. FIG. 35 is a diagram illustrating the contents 211 and 212 and the screen image of the virtual PC screen data 18b present in the virtual conference space 18. As illustrated in FIG. 34, the electronic whiteboard 2 displays the screen image of the virtual PC screen data 18b that represents the screen data of the PC 17. As a result, the content 212 on the screen image of the virtual PC screen data 18b is shared between the users A to C in the meeting room and the user D. Also, as illustrated in FIG. 35, the content 212 on the screen image of the virtual PC screen data 18b is copied to the screen image of the virtual whiteboard 18a.

Since the content 212 is added to the screen image of the virtual whiteboard 18a, the object extraction unit 51 analyzes the shape of the boundary line (edge) between the display pixels (the value of the pixel data is not zero) and the non-display pixels (the value of the pixel data is zero) of the content 212, and determines that text and images are presented on the screen image of the virtual whiteboard 18a. The object extraction unit 51 groups the pieces of data of the text as text data 231.

The virtual conference service transfers the text data 231 that is a group of the pieces of data of the text to the type-determination unit 61. The type-determination unit 61 determines that the text data is “text” using the type-determination model.

The content management unit 67 causes the data storage unit 59 (content management table) to store the coordinates of the upper-left corner (in the virtual conference space) of the rectangular region circumscribing the group of the pieces of data of the text and the size of the rectangular region (i.e., the number of display pixels in the lateral and vertical directions) together with the type of content that is the text.

Subsequently, the object extraction unit 51 determines that a circular object 235, three objects (a trash box 232, a folder 233, and a document 234), and a rectangular object 236 are present in the region where the text is not present. The virtual conference service first transfers the circular object 235 to the type-determination unit 61. The type-determination unit 61 determines that the circular object 235 is a “graph (image)” using the type-determination model. The content management unit 67 causes the data storage unit 59 (content management table) to store the coordinates of the upper-left corner (in the virtual conference space) of the rectangular region circumscribing the circular object 235 and the size of the rectangular region (i.e., the number of display pixels in the lateral and vertical directions) together with the type of content that is the graph (image).

Subsequently, the virtual conference service transfers the next object data (the trash box 232) to the type-determination unit 61. The type-determination unit 61 attempts to determine the type of content for the trash box 232 using the type-determination model. However, since the trash box 232 has not been learned, the type-determination unit 61 determines that this object is “others.” The content management unit 67 causes the data storage unit 59 (content management table) to store the information on the coordinates and sizes of objects classified into one of the “drawing (handwriting),” the “figure,” the “text,” the “photo (image),” and the “graph (image).” However, the content management unit 67 does not cause the data storage unit 59 to store the information on the objects classified into the “others.”

The virtual conference service then transfers the next object data (the folder 233) to the type-determination unit 61. The type-determination unit 61 determines that the object is “others.” Accordingly, the content management unit 67 does not cause the data storage unit 59 (content management table) to store the information on the object.

The virtual conference service then transfers the next object data (the document 234) to the type-determination unit 61. The type-determination unit 61 determines that the object is “others.” Accordingly, the content management unit 67 does not cause the data storage unit 59 (content management table) to store the information on the object.

The virtual conference service then transfers the rectangular object 236 to the type-determination unit 61. The type-determination unit 61 determines that the object is the “figure.” The content management unit 67 causes the data storage unit 59 (content management table) to store the coordinates of the upper-left corner (in the virtual conference space) of the rectangular region circumscribing the rectangular object 236 and the size of the rectangular region (i.e., the number of display pixels in the lateral and vertical directions) together with the type of content that is the figure.

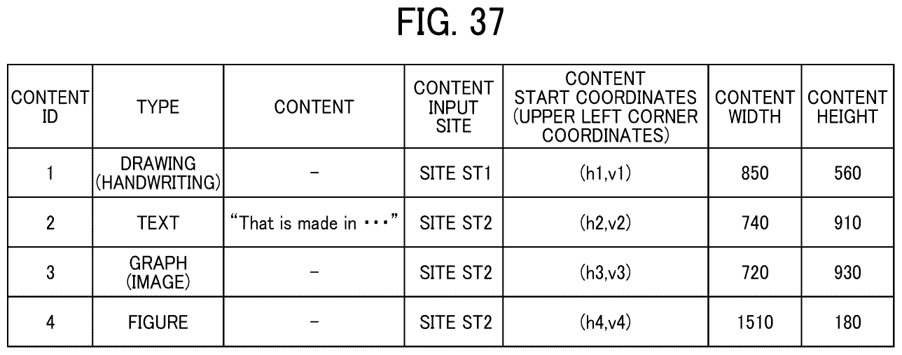

As described above, the objects in the content 212 determined to be other than the “others” are registered as the contents in the content management table (see FIG. 37).

Then, handwriting of drawing data is made on the electronic whiteboard 2 in the meeting room. The handwriting of drawing data is now going to be shared with the users at the other sites. In order to return the display region 251 to a blank state, the user A performs a swipe operation on the electronic whiteboard 2. The user A moves the content 212 on the screen image of the virtual whiteboard 18a displayed on the electronic whiteboard 2 to the outside of the display region 251 of the electronic whiteboard 2. When the user A performs a swipe operation in the upward direction on the display of the electronic whiteboard 2, the electronic whiteboard 2 determines that the distance between the coordinates of two positions that the contact position detection unit 24 detects in the time interval is greater than a predetermined value and that the swipe operation has been performed. The display control unit 22 of the electronic whiteboard 2 erases the display data of the content 212 in the display memory. The display 480 of the electronic whiteboard 2 returns to a blank state.

The swipe information transmission unit 45 of the electronic whiteboard 2 transmits information on the swipe operation (i.e., the direction and length, which is vector information) to the virtual conference server 5. When the virtual conference server 5 receives the information, the virtual display control unit 63 moves the content 212 upward within the virtual conference space 18 according to the direction and length of the movement.

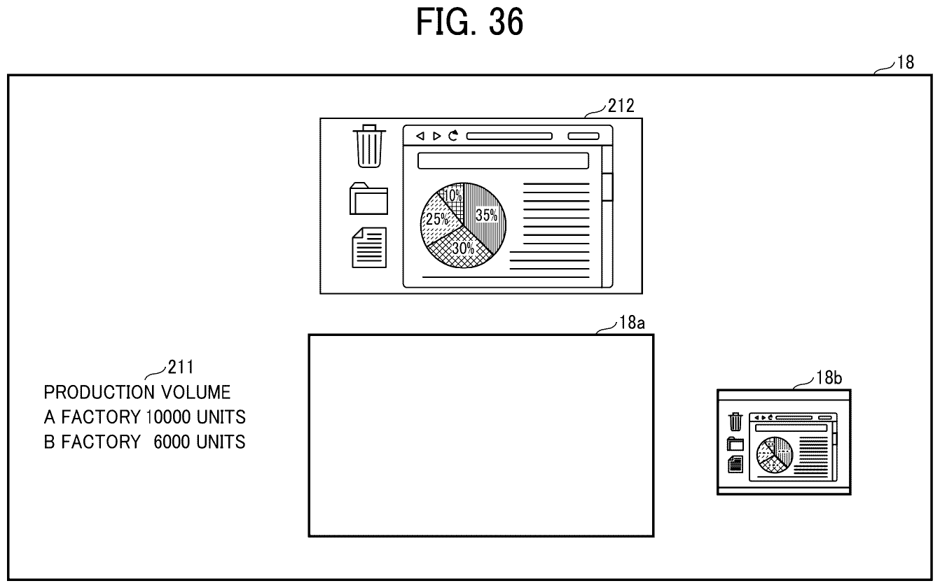

FIG. 36 is a diagram illustrating the virtual conference space 18 in which the content 212 that was in the virtual whiteboard 18a has been moved upward. As illustrated in FIG. 36, in the virtual conference space 18, the content 211 (the group of the pieces of drawing data), the content 212 (the content on the screen image of the virtual whiteboard 18a after swiping), the screen image of the virtual whiteboard 18a, and the screen image of the virtual PC screen data 18b are displayed separately.

FIG. 37 is a diagram illustrating a content management table managed by the content management unit 67 for the contents in the virtual conference space 18 of FIG. 36. The objects whose types are determined to be other than the “others” in the content 212 are three objects (the text data, the graph, and the figure). Accordingly, a total of four contents including the content 211 are registered in the content management table. The content having a content ID “1” corresponds to the content 211. The content having a content ID “2” corresponds to the text data 231. The content having a content ID “3” corresponds to the circular object 235. The content having a content ID “4” corresponds to the rectangular object 236.

Although a screen image of one screen data is divided into multiple contents in FIG. 37, the content management unit 67 may register a screen image of one screen data as a content in the content management table without division. In this case, the type of content may be classified into, for example, screen data. The aggregation processing unit 60 may aggregate the screen image of the virtual PC screen data 18b and the contents input to the electronic whiteboard 2.

Subsequently, the user A in the meeting room handwrites on the electronic whiteboard 2. The content transmission unit 27 of the electronic whiteboard 2 transmits the drawing data of the handwriting to the virtual conference server 5. When the virtual conference server 5 receives the drawing data, the synchronization control unit 56 causes the drawing data to be presented as the handwriting on the screen image of the virtual whiteboard 18a.

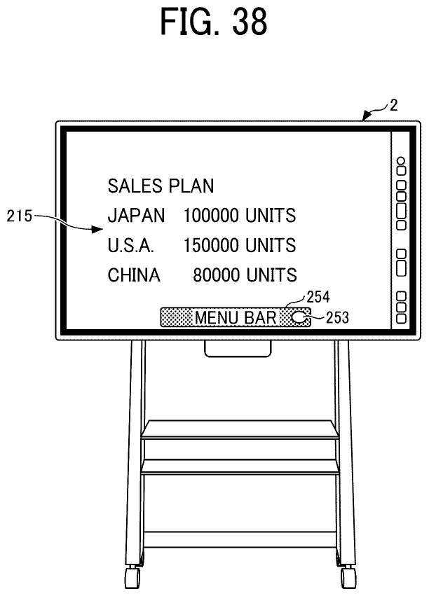

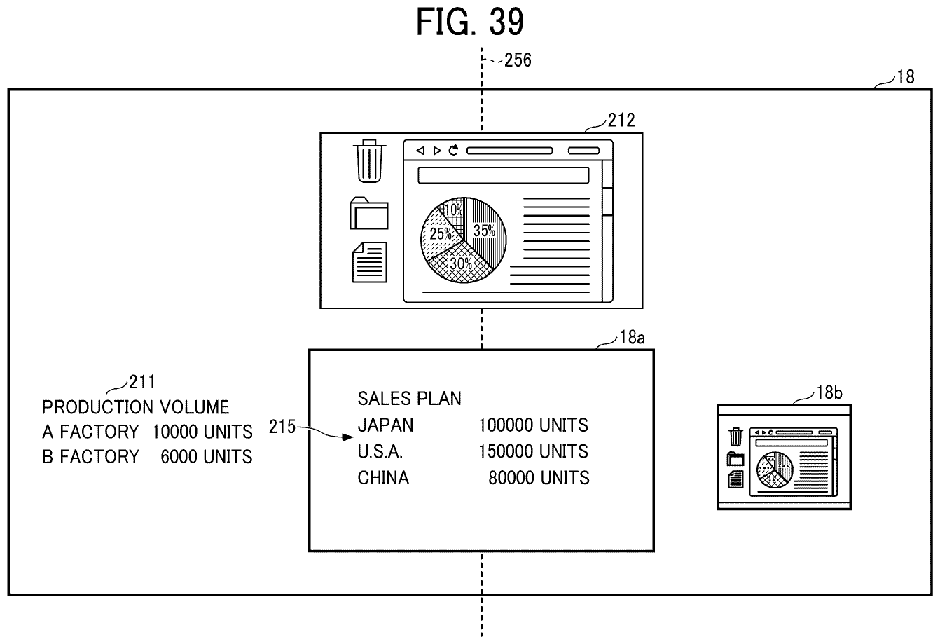

FIG. 38 is a diagram illustrating a content 215 that is the handwriting on the electronic whiteboard 2. The content 215 is drawing data. FIG. 39 is a diagram illustrating the screen image of the virtual whiteboard 18a in the virtual conference space 18, which is synchronized with the drawing data of the handwriting on the electronic whiteboard 2. In comparison with FIG. 36, in FIG. 39, the content 215 is newly presented on the screen image of the virtual whiteboard 18a.

The virtual conference service transfers the display data of the content 215 on the screen image of the virtual whiteboard 18a to the object extraction unit 51. The object extraction unit 51 analyzes the shape of the boundary line (edge) between the display pixels (the value of the pixel data is not zero) and the non-display pixels (the value of the pixel data is zero) of this content, and determines that only text is presented on the screen image of the virtual whiteboard 18a. The object extraction unit 51 groups the pieces of data of the text (drawing data).

The virtual conference service transfers the group of the pieces of data of the text to the type-determination unit 61. The type-determination unit 61 determines that the group of the pieces of data of the text is a “drawing (handwriting)” using the type-determination model. The content management unit 67 causes the content management table to store the coordinates of the upper-left corner (in the virtual conference space) of the rectangular region circumscribing the group of the pieces of data of the text and the size of the rectangular region (i.e., the number of display pixels in the lateral and vertical directions) together with the type of content that is the drawing (handwriting).

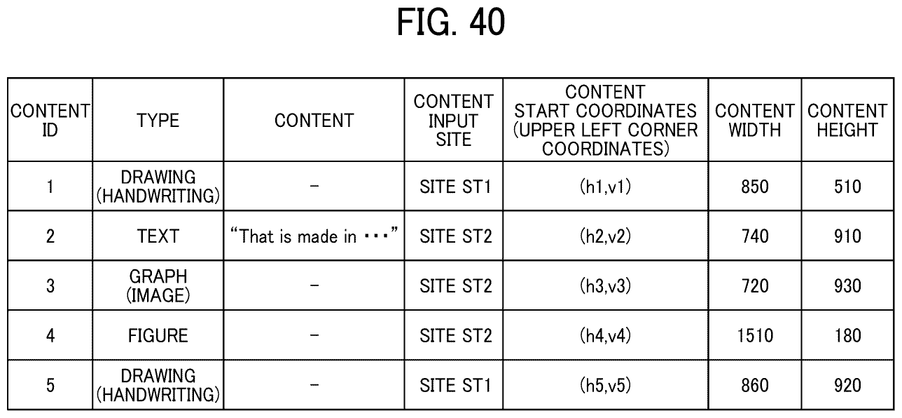

FIG. 40 is a diagram illustrating a content management table managed by the content management unit 67 for the contents in the virtual conference space 18 of FIG. 39. In this content management table, the information on the content 215 added to the screen image of the virtual whiteboard 18a in FIG. 39 is newly registered. The content having a content ID “5” corresponds to the content 215.

At this point, the user A in the meeting room presses the aggregation display menu button 253 illustrated in FIG. 6 in order to display the drawing data (the content 211) previously handwritten on the electronic whiteboard 2 as an image together with the image of the drawing data (the content 215) currently displayed. Since the electronic whiteboard 2 displays the condition setting screen 260, the user A selects the drawing (handwriting) as the type of content and presses the aggregation button 263.

The content management unit 67 refers to the content management table and confirms that the contents having content IDs “1” and “5” are contents whose content type is the “drawing (handwriting).” The aggregation processing unit 60 determines the arrangement of the contents having the content IDs “1” and “5” according to the arrangement rule of the contents described in the first embodiment.

In the present embodiment, the virtual conference space 18 is applied in place of the display extension region 252 described in the first embodiment. As illustrated in FIG. 39, the virtual conference space 18 is divided into a left region and a right region by a perpendicular line 256 passing through the center point of the virtual conference space 18, and it is determined whether the contents are present only in the left region or only in the right region. Since both the contents 211 and 215 having the respective content IDs “1” and “5” are present in the left region, the aggregation processing unit 60 compares the Y coordinates of the start coordinates (the coordinates of the upper-left corner) of the contents 211 and 215. Since the Y coordinates of the start coordinates of the content 215 having the content ID “5” is smaller in value (i.e., positioned higher), the aggregation processing unit 60 arranges the content 215 having the content ID “5” on the upper side and the content 211 having the content ID “1” on the lower side.

As illustrated in the content management table of FIG. 40, the coordinates of the content 215 having the content ID “5” are (h5, v5). This indicates that there is a blank space corresponding to h5 and v5 on the left and upper sides of the content 215, respectively. The aggregation processing unit 60 moves the content 215 having the content ID “5” by h5 pixels in the left direction and by v5 pixels in the upper direction. In other words, the aggregation processing unit 60 moves the upper-left corner of the content 215 so as to align with the origin to fill the blank space.

The aggregation processing unit 60 moves the content 211 having the content ID “1” so that the coordinates of the upper-left corner align with coordinates (0, 920+a). The value “a” is a gap between the contents 211 and 215, and, for example, is set to be 20.

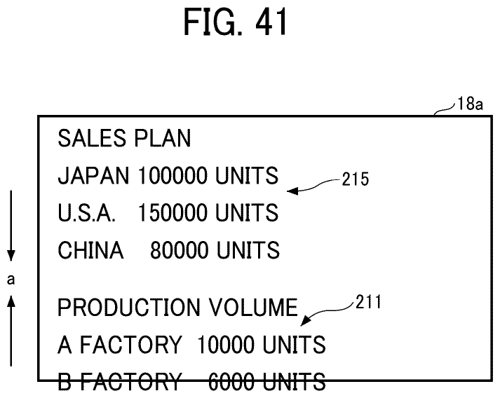

FIG. 41 is a diagram illustrating the screen image of the virtual whiteboard 18a on which the content 215 is arranged on the upper side and the content 211 is arranged on the lower side. The upper-left corner of the content 215 having the content ID “5” is aligned with the upper-left corner of the screen image of the virtual whiteboard 18a. The gap “a” is present between the content 215 having the content ID “5” and the content 211 having the content ID “1.” On the other hand, the lower portion of the content 211 having the content ID “1” extends beyond the screen image of the virtual whiteboard 18a.

In the state of FIG. 41, the content 211 having the content ID “1” extends beyond the screen image of the virtual whiteboard 18a in the positive direction of the Y-axis direction. Therefore, the electronic whiteboard 2 cannot display the extending portion. In view of the above, the aggregation processing unit 60 reduces the sizes of the content 211 having the content ID “5” and the content 215 having the content ID “1” so that the content 211 having the content ID “1” also fits within the screen image of the virtual whiteboard 18a.

It is assumed that the number of pixels in the vertical direction of the screen image of the virtual whiteboard 18a (excluding the menu bar and the portion below the menu bar) is 1200. Since the total number of pixels in the vertical direction of the contents 215 and 211 and the gap therebetween is given by 510+920+20, the reduction ratio is calculated as follows.

$$Reduction Ratio = 1 \; 200 / ( 510 + 920 + 20 )$$

The aggregation processing unit 60 reduces the sizes of the content 215 having the content ID “5” and the content 211 having the content ID “1” by this reduction ratio.

The aggregation processing unit 60 may change the reduction ratio according to the size of text, even for contents determined to be of the same type of drawing data. The aggregation processing unit 60 calculates an average size of one character using an existing method and individually applies the reduction ratios to the contents 211 and 215. For example, it is assumed that the height of the content 211 is A, the character size is L1, the reduction ratio is r1, the height of the content 215 is B, the character size is L2 (that is greater than L1), the reduction ratio is r2, and the height of the display region is T. In this case, the reduction ratios r1 and r2 can be obtained based on the following relationship.

$$( L 2 / L 1 ) \times r 2 \times A + r 2 \times B = T$$

$$r 1 = ( L 2 / L 1 ) \times r 2$$

The aggregation processing unit 60 reduces the size of the content 211 by the reduction ratio r1 and reduces the size of the content 215 by the reduction ratio r2. Thus, the two contents 211 and 215 are scaled such that the character sizes of the two contents are approximately the same and the two contents fit within the display region. Since the reduction ratio becomes greater than one depending on the character size, the aggregation processing unit 60 may enlarge the size of the content.

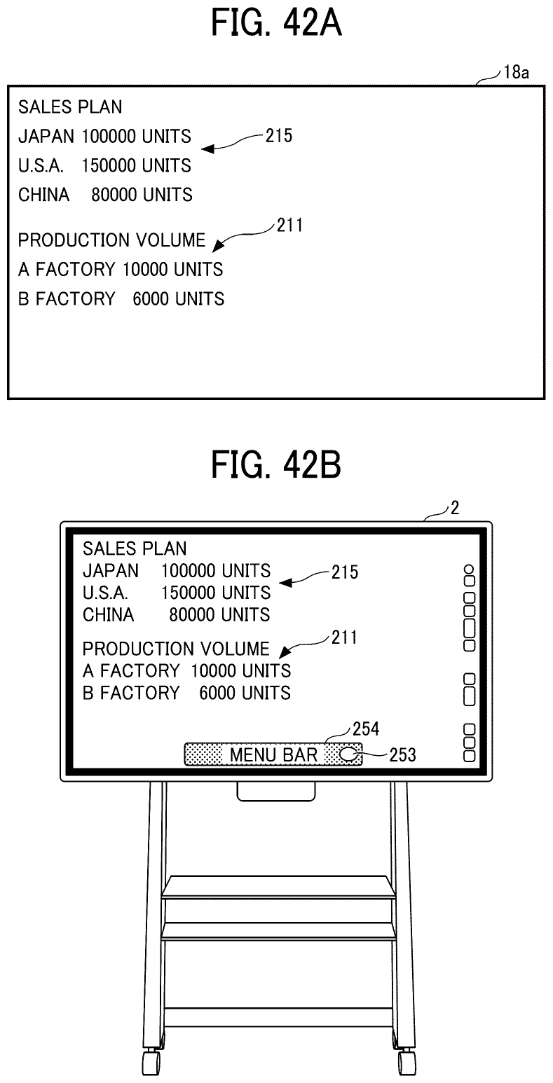

FIG. 42A is a diagram illustrating the screen image of the virtual whiteboard 18a after the reduction of the sizes of the contents. The content 215 having the content ID “5” and the content 211 having the content ID “1” fit within the screen image of the virtual whiteboard 18a. FIG. 42B is a diagram illustrating the contents that the electronic whiteboard 2 displays on the display. As illustrated in FIG. 42B, the electronic whiteboard 2 receives the display data of the contents 211 and 215 on the screen image of the virtual whiteboard 18a and displays the display data as the content 215 having the content ID “5” and the content 211 having the content ID “1” on the display 480.

### Operations or Processes

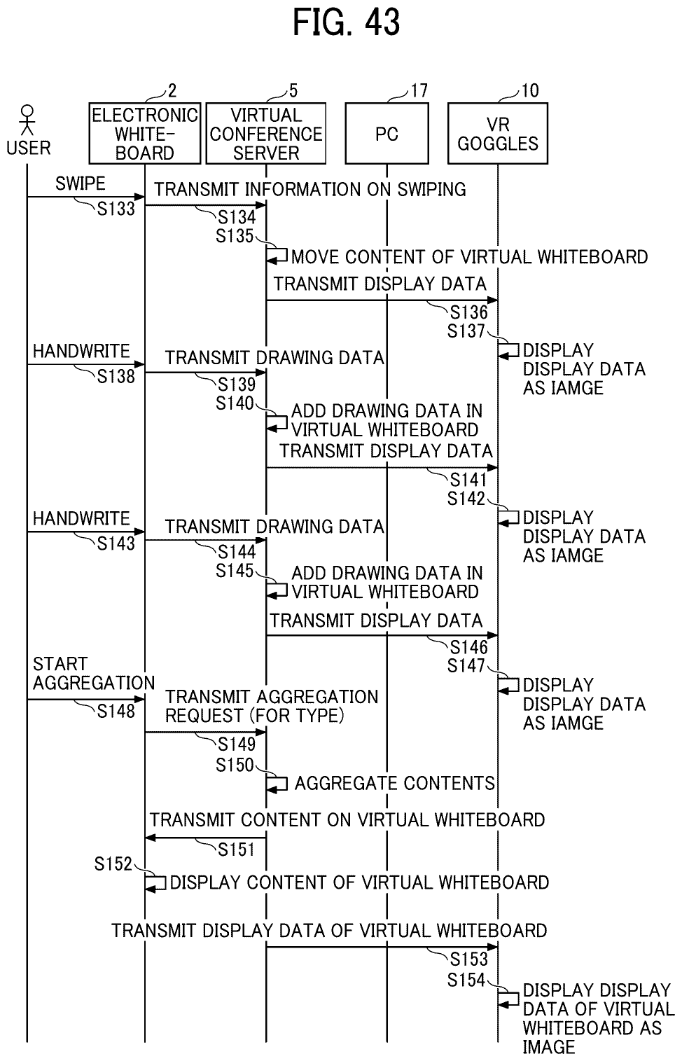

FIG. 43 is a sequence diagram illustrating processes or operations performed by the virtual conference system 700. It is assumed that, at the start of the processes or operations in FIG. 43, the virtual conference space 18 is in the state as illustrated in FIG. 35.

In S133, the user A performs a swipe operation on the electronic whiteboard 2. The user A performs an operation for swiping the content displayed on the electronic whiteboard 2 upward. The display control unit 22 of the electronic whiteboard 2 erases the drawing data of the handwriting in the display memory. The display 480 of the electronic whiteboard 2 returns to a blank state.

In S134, the swipe information transmission unit 45 of the electronic whiteboard 2 transmits information on the swipe operation (i.e., the direction and length, which is vector information) to the virtual conference server 5.

In S135, when the virtual conference server 5 receives the information, the virtual display control unit 63 moves the content on the screen image of the virtual whiteboard 18a upward within the virtual conference space 18 according to the direction and length of the movement.

In S136, the virtual conference server 5 transmits the updated display data of the virtual conference space 18 to the VR goggles 10 and 12.

In S137, the wireless LAN communication control unit 101 of the VR goggles 10 receives the updated display data, and the display control unit 100 performs control for displaying the updated display data as a screen image.

In S138, the user A in the meeting room handwrites on the electronic whiteboard 2.

In S139, the content transmission unit 27 of the electronic whiteboard 2 transmits the drawing data of the handwriting to the virtual conference server 5.

In S140, when the content reception unit 53 of the virtual conference server 5 receives the drawing data, the synchronization control unit 56 adds the drawing data to the virtual whiteboard 18a. At this time, the object extraction unit 51 groups pieces of drawing data. The type-determination unit 61 determines that the type of the content of the group of the pieces of drawing data is the drawing (handwriting). The content management unit 67 causes the content management table to store the coordinates of the upper-left corner (in the virtual conference space) of the rectangular region circumscribing the group of the pieces of drawing data and the size of the rectangular region (i.e., the number of display pixels in the lateral and vertical directions) together with the type of content that is the drawing (handwriting). When handwriting of drawing data is newly added near the handwriting of the drawing data present on the screen image of the virtual whiteboard 18a, the handwriting of drawing data newly added is included in the existing group of the pieces of drawing data. In other words, while handwriting of drawing data to be included in the same group is being added to the screen image of the virtual whiteboard 18a, only the size (the number of display pixels in the lateral and vertical directions) of the rectangular region circumscribing the existing group is updated in the content management table.

In S141, the virtual conference server 5 transmits the updated display data of the virtual whiteboard 18a to the VR goggles 10 and 12.

In S142, the wireless LAN communication control unit 101 of the VR goggles 10 receives the updated display data, and the display control unit 100 performs control for displaying the updated display data as a screen image.

In S143 to S147, the same processes are repeatedly executed while the user A is handwriting on the electronic whiteboard 2.

In S148, the user A selects the type of content and presses the aggregation button 263. In S149, the LAN communication control unit 41 of the electronic whiteboard 2 transmits an aggregation request including the designated type of content to the virtual conference server 5.

In S150, when the communication control unit 57 of the virtual conference server 5 receives the aggregation request, the aggregation processing unit 60 extracts one or more contents whose content type corresponds to the designated type of content from the virtual conference space 18 (content management table), and aggregates and arranges the contents on the screen image of the virtual whiteboard 18a.

In S151, the communication control unit 57 of the virtual conference server 5 transmits the display data of the one or more contents aggregated on the screen image of the virtual whiteboard 18a to the electronic whiteboard 2.

In S152, the LAN communication control unit 41 of the electronic whiteboard 2 receives the display data of the one or more contents, and the display control unit 22 controls the display 480 to display the display data as the one or more contents.

In S153, the virtual conference server 5 transmits the updated display data of the virtual whiteboard 18a to the VR goggles 10 and 12.

In S154, the wireless LAN communication control unit 101 of the VR goggles 10 receives the updated display data, and the display control unit 100 performs control for displaying the updated display data as a screen image.

According to the present embodiment, contents displayed in the virtual conference space 18 by multiple devices can be aggregated and arranged in the display region 251 of the electronic whiteboard 2. Not only the contents input to the electronic whiteboard 2 but also the contents displayed by the PCs 17 and 19 in addition to the contents input to the electronic whiteboard 2 are aggregated and arranged in the display region 251. Thus, the contents can be more easily viewed at a glance.

### Third Embodiment

In the present embodiment, an information providing method is described in which the contents aggregated and arranged in the first embodiment are displayed on multiple devices that participate in a remote conference from different sites.

### Configuration of System

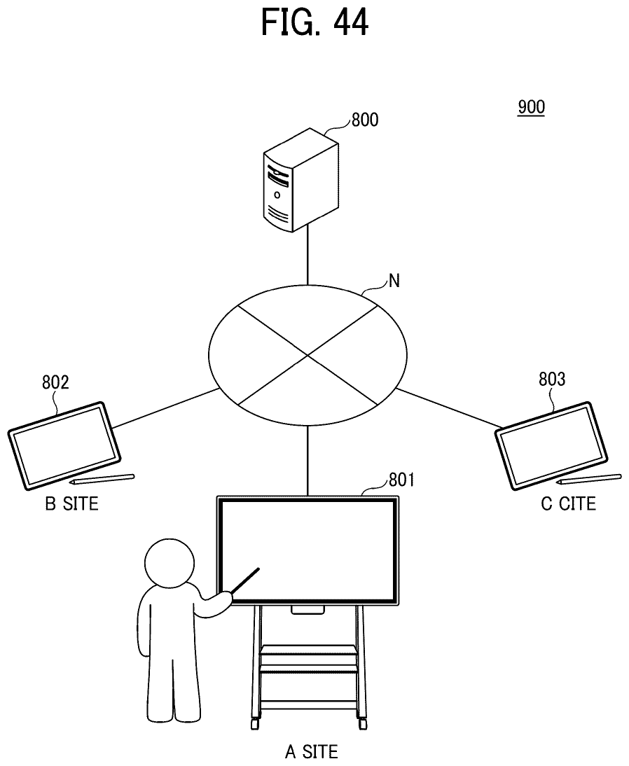

FIG. 44 is a schematic diagram illustrating a configuration of a display system 900 according to the present embodiment. In the display system 900 of FIG. 44, an electronic whiteboard 801 and two tablet PCs 802 and 803 communicate with a conference server 800 via the communication network N. The electronic whiteboard 801 is located at the A site. The tablet PC 802 is located at the B site. The tablet PC 803 is located at the C site. The electronic whiteboard 801 and the tablet PCs 802 and 803 may be substantially the same as the corresponding devices in the first embodiment. When the electronic whiteboard 801 and the tablet PCs 802 and 803 are not distinguished from each other, these devices are collectively referred to as devices.

The conference server 800 is a server that performs the remote conference. The conference server 800 transmits the image data and the audio data received from the devices at the sites A to C to the devices at the sites A to C excluding the site where the transmission source device is located. Since the electronic whiteboard 801 and the two tablet PCs 802 and 803 each display the received image data as an image and output the received audio data, the remote conference is conducted among users at remote locations.

In the configuration of FIG. 44, the electronic whiteboard 801 and the tablet PCs 802 and 803 each display a certain portion of the display extension region 252. The coordinates of the upper-left corner and size of the display extension region 252 displayed on the electronic whiteboard 801 and the tablet PCs 802 and 803 are constantly managed by the conference server 800. When a user of one of the devices or another device performs a predetermined operation, the contents in the display region 251 are displayed on the whiteboard region of each device.

The hardware configuration of the electronic whiteboard 801 may be substantially the same as that in FIG. 3. The hardware configuration of each of the tablet PCs 802 and 803 may be substantially the same as that in FIG. 4. The hardware configuration of the conference server 800 may be substantially the same as that in FIG. 24.

### Functions

### Conferencing Server

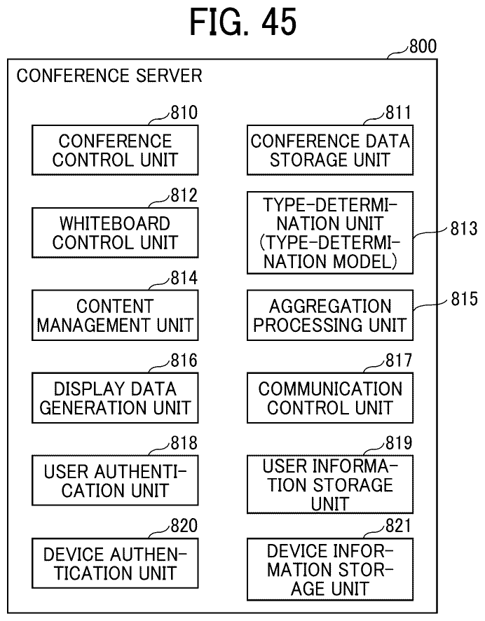

FIG. 45 is a block diagram illustrating a functional configuration of the conference server 800. The conference server 800 includes a conference control unit 810, a conference data storage unit 811, a whiteboard control unit 812, a type-determination unit 813 (type-determination model), a content management unit 814, an aggregation processing unit 815, a display data generation unit 816, a communication control unit 817, a user authentication unit 818, a user information storage unit 819, a device authentication unit 820, and a device information storage unit 821. These functional units of the conference server 800 are implemented by or caused to function by one or more of the hardware components illustrated in FIG. 24 operating in accordance with instructions from the CPU 501 according to the control program loaded from the HD 504 to the RAM 503. The aggregation processing unit 815, the type-determination unit 813, and the content management unit 814 may have substantially the same functions as the corresponding functional units of the electronic whiteboard 2 in the first embodiment. The communication control unit 817, the conference data storage unit 811, the user authentication unit 818, and the user information storage unit 66 may have substantially the same functions as the corresponding functional units of the virtual conference server 5 in the second embodiment.

The conference control unit 810 controls the conference data storage unit 811 to store the information on the conference participants and the conference identification information (conference ID) in association with each other, and executes a conference application. The conference application executes, for each conference ID, some applications used in a conference. One of the applications is distribution of, for example, audio data, image data (video input to a camera), conference material, and screen data received from the terminal devices used by the conference participants (such as the electronic whiteboard 801 and the tablet PCs 802 and 803) to the other terminal devices. The conference ID is information for identifying a conference, and is generated when the conference is scheduled. In the case where the conference is not scheduled, the conference ID is generated when any one of the tablet PCs 802 and 803 and the electronic whiteboard 801 connects to the conference server 800 for participating in the conference.

The conference data storage unit 811 stores the information on the conference participants and the conference ID in association with each other. The conference data storage unit 811 also stores, for example, audio data, image data (video input to a camera), and conference material received from the tablet PC 802 and 803 and the electronic whiteboard 801.

The whiteboard control unit 812 manages, in the display extension region 252, the positions of the display region displayed on the display 480 by the electronic whiteboard 801 and the display region displayed on the display 526 by each of the tablet PCs 802 and 803. The whiteboard control unit 812 also performs control for transmitting data of the whiteboard region that one of the electronic whiteboard 801 and the tablet PCs 802 and 803 displays as an image on the display. The other devices except the data source device receive the data and display the data as an image.

The type-determining unit 813 determines the type of content. The type-determination unit 813 has a type-determination model that is a machine learning model trained using training data for determining the type of content. The type-determination model is a feature extraction model suitable for images, such as the CNN. The type-determination model extracts features of a content and determines the type of content.

The content management unit 814 registers the contents of the display data received from the tablet PCs 802 and 803 and the electronic whiteboard 801 and the information on the contents in the content management table (see FIG. 10).

The aggregation processing unit 815 arranges the contents whose type corresponding to the type of content designated by the user in the display region of each of the tablet PCs 802 and 803 and the electronic whiteboard 801 and reduces the sizes of the contents so that the contents fit within the display region. The aggregation processing unit 815 also searches for a content that matches a keyword.

The display data generation unit 816 generates display data that the conference application causes to be displayed as an image on each of the tablet PCs 802 and 803 and the electronic whiteboard 801.

The communication control unit 817 executes a communication protocol for the conference application and also performs communication control as a web server.

The user authentication unit 818 collates the user ID and password received via the communication control unit 817 with the user ID and password stored in the user information storage unit 819, and authenticates the user who uses the conference application.

The user information storage unit 819 stores the user ID and password of the user who uses the conference application.

The device authentication unit 820 collates the device ID of the device (electronic whiteboard 801) that uses the conference application received via the communication control unit 817 with the device ID stored in the device information storage unit 821, and authenticates the device that uses the conference application.

### Electronic Whiteboard

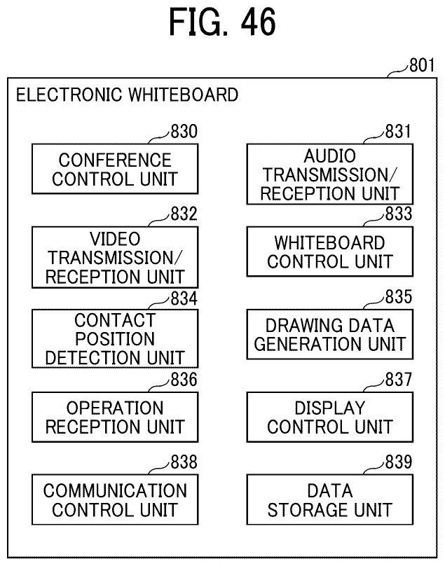

FIG. 46 is a block diagram illustrating a functional configuration of the electronic whiteboard 801. The electronic whiteboard 801 includes a conference control unit 830, an audio transmission/reception unit 831, a video transmission/reception unit 832, a whiteboard control unit 833, a contact position detection unit 834, a drawing data generation unit 835, an operation reception unit 836, a display control unit 837, a communication control unit 838, and a data storage unit 839. These functional units of the electronic whiteboard 801 are implemented by or caused to function by one or more of the hardware components illustrated in FIG. 3 operating in accordance with instructions from the CPU 401 according to the control program (virtual conference application) loaded from the SSD 404 to the RAM 403. The contact position detection unit 834, the drawing data generation unit 835, the operation reception unit 836, the display control unit 837, and the data storage unit 839 may have substantially the same functions as those of the corresponding functional units in the first embodiment.

The conference control unit 830 executes the conference application to perform the remote conference with the terminal devices (such as the tablet PCs 802 and 803) at the sites via the conference server 800.

The audio transmission/reception unit 831 encodes, in accordance with the AAC system, audio data obtained by performing A/D conversion on audio signals input from the microphone 440 and transmits the encoded audio data. The audio transmission/reception unit 831 also decodes the received encoded audio data and outputs audio signals obtained by performing D/A conversion on the decoded audio data to the speaker 450.

The video transmission/reception unit 832 encodes, in accordance with the ITU-T Recommendation H.265, video data obtained by performing A/D conversion on video signals input from the camera 460 and transmits the encoded video data. The video transmission/reception unit 832 also decodes the received encoded video data and outputs video signals obtained by performing D/A conversion on the decoded video data to the display control unit 837.

The whiteboard control unit 833 performs control for transmitting drawing data of handwriting in the display region 251 and display data of a content such a drawing or photo added to the display region 251 to the display extension region 252 of the conference server 800. The whiteboard control unit 833 also performs control for moving the region to be displayed on the display 480 of the electronic whiteboard 801 within the display extension region 252 of the conference server 800.

The contact position detection unit 834 detects a position contacted by the user's hand H or the electronic pen 490.

The drawing data generation unit 835 generates drawing data from a coordinate point sequence input from the contact position detection unit 834 when the user handwrites. The drawing data generation unit 835 also generates a figure such as a circle or a rectangle.

The operation reception unit 836 receives an operation to the electronic whiteboard 801. For example, the operation reception unit 836 determines, for example, a button at the coordinates of a position contacted by the electronic pen 490 or the hand H and receives pressing of the button.

The display control unit 837 controls, for example, the display of a content such as handwriting of drawing data or a figure input to the electronic whiteboard 801, the display of the conference information, and the display of an image based on screen data received from the conference server 800.

The communication control unit 838 controls communication according to a communication protocol such as a transmission control protocol/internet protocol (TCP/IP), a real-time transport protocol control protocol (RTCP), or a hypertext transfer protocol (HTTP), or a wireless communication protocol conforming to the IEEE 802.11ax standard.

The data storage unit 839 stores, for example, drawing data of handwriting, display screen data, and the device ID of the electronic whiteboard 801.

### Tablet PC

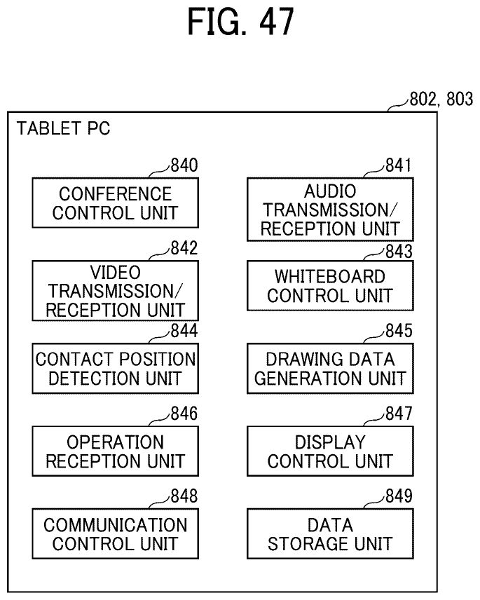

FIG. 47 is a block diagram illustrating a functional configuration of each of the tablet PCs 802 and 803. Each of the tablet PCs 802 and 803 includes a conference control unit 840, an audio transmission/reception unit 841, a video transmission/reception unit 842, a whiteboard control unit 843, a contact position detection unit 844, a drawing data generation unit 845, an operation reception unit 846, a display control unit 847, a communication control unit 848, and a data storage unit 849. These functional units of each of the tablet PCs 802 and 803 are implemented by or caused to function by one or more of the hardware components illustrated in FIG. 4 operating in accordance with instructions from the CPU 521 according to the control program loaded from the HD 524 to the RAM 523.

The functional units except the data storage unit 849 are substantially the same as the corresponding functional units of the electronic whiteboard 801. The data storage unit 849 stores, for example, drawing data of handwriting, display screen data, and a user ID and password of the user of each of the tablet PCs.

### Process for Starting Conference

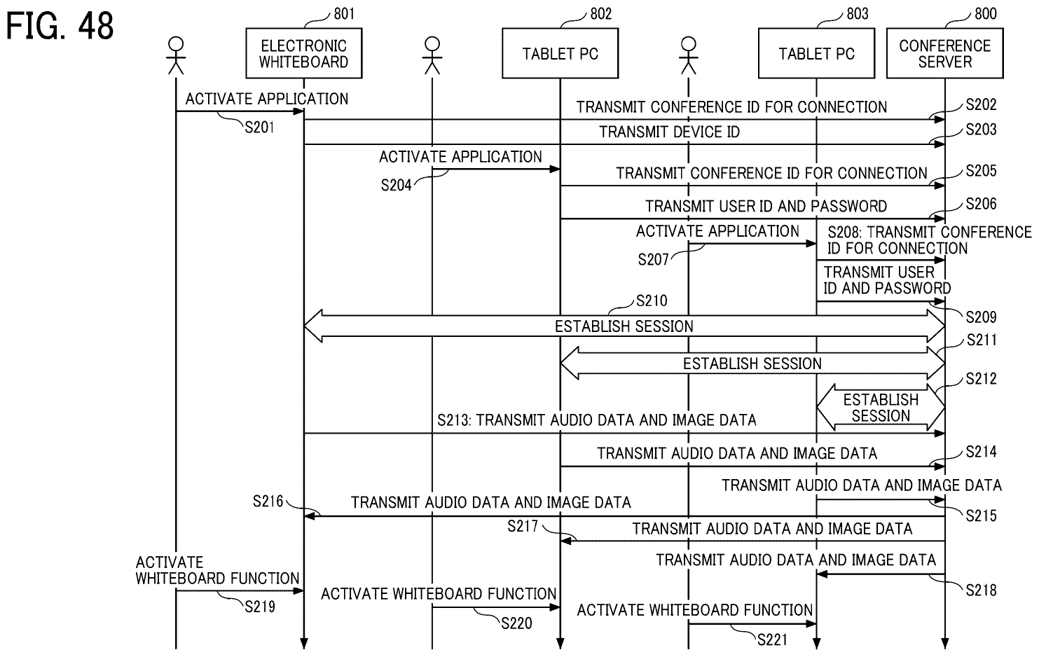

FIG. 48 is a sequence diagram illustrating a process for starting a remote conference among the electronic whiteboard 801 and the two tablet PCs 802 and 803 via the conference server 800.

In S201, a user who uses the electronic whiteboard 801 activates the conference application and inputs the conference ID of the conference scheduled in advance or selects the conference ID from a list of scheduled conferences.

In S202, the conference control unit 830 of the electronic whiteboard 801 transmits the conference ID to the conference server 800 to connect the electronic whiteboard 801 to the conference server 800.

In S203, the conference control unit 830 of the electronic whiteboard 801 transmits the device ID of the electronic whiteboard 801 to the conference server 800. The device authentication unit 820 of the conference server 800 authenticates the device ID and permits the electronic whiteboard 801 to participate in the conference.

In S204, a user of the tablet PC 802 activates the conference application and inputs the conference ID of the conference scheduled in advance or selects the conference ID from a list of scheduled conferences.

In S205, the conference control unit 840 of the tablet PC 802 transmits the conference ID to the conference server 800 to connect the tablet PC 802 to the conference server 800.

In S206, the conference control unit 840 of the tablet PC 802 transmits the user ID and the password to the conference server 800. The user authentication unit 818 of the conference server 800 authenticates the user ID and the password and permits the tablet PC 802 to participate in the conference.

In S207 to S209, the tablet PC 803 participates in the conference in the same manner.

In S210 to S212, the conference control unit 830 of the electronic whiteboard 801 and the conference control unit 840 of each of the tablet PCs 802 and 803 establish a session for the conference with the conference control unit 810 of the conference server 800. The session is a communication state in which image data, audio data, document data, and display data of contents in the whiteboard region of a device serving as a transmission source are distributed to all the other devices participating in the same conference. In S213, the audio transmission/reception unit 831 of the electronic whiteboard 801 transmits to the conference server 800 audio data that is input from the microphone and encoded. The video transmission/reception unit 832 of the electronic whiteboard 801 transmits to the conference server 800 image data that is input from the camera and encoded.

In S214, the audio transmission/reception unit 841 of the tablet PC 802 transmits to the conference server 800 audio data that is input from the microphone and encoded. The video transmission/reception unit 842 of the tablet PC 802 transmits to the conference server 800 image data that is input from the camera and encoded.

In S215, the tablet PC 803 transmits audio data and image data to the conference server 800 in the same manner.

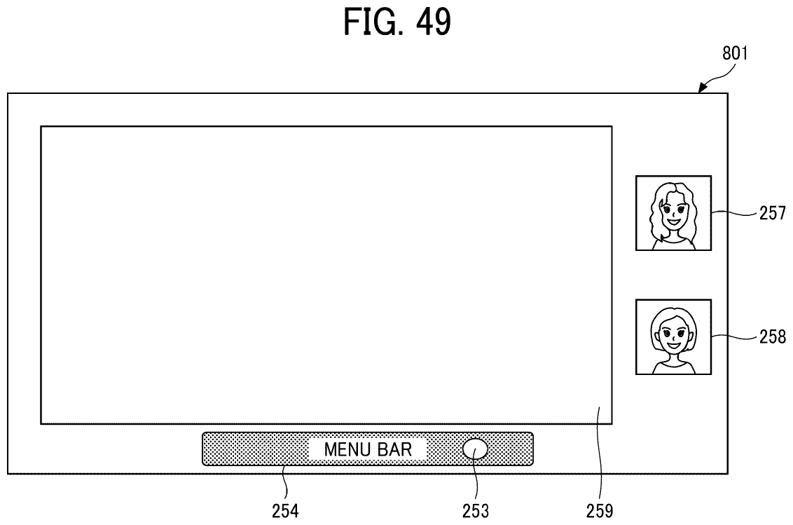

In S216 to S218, the conference control unit 810 of the conference server 800 transmits the audio data and the image data received from a certain device to all the other devices participating in the conference. The conference control unit 810 of the conference server 800 mixes the audio data received from all the devices and transmits the mixed audio data to all the other devices, and transmits the image data received from each device to all the other devices through separate channels. The audio transmission/reception unit 831 of the electronic whiteboard 801 and the audio transmission/reception unit 841 of each of the tablet PCs 802 and 803 decode the audio data received from the conference server 800 and output the audio signals from the respective speakers. The video transmission/reception unit 832 of the electronic whiteboard 801 and the video transmission/reception unit 842 of each of the tablet PCs 802 and 803 decode the image data received from the conference server 800 through two channels and cause the image data to be displayed as two images in predetermined regions of the respective displays 480 and 526. In S219, the user of the electronic whiteboard 801 operates the display screen of the display 480 to turn on a whiteboard function that is a function of the conference application. In response to the operation, the whiteboard control unit 833 of the electronic whiteboard 801 causes the display 480 to display a whiteboard. The display content of the whiteboard at this time is the same as the display content of the display region 251 in FIG. 6. However, the electronic whiteboard 801 according to the present embodiment can further display the image data received from the tablet PCs 802 and 803 as images (see FIG. 49).

In S220 and S221, the user of each of the tablet PCs 802 and 803 also operates the display screen of the display 526 to turn on the whiteboard function that is a function of the conference application. In response to the operation, the whiteboard control unit 833 of each of the tablet PCs 802 and 803 causes the display 526 to display the whiteboard region.

FIG. 49 is a diagram illustrating a screen that the electronic whiteboard 801 causes the display 480 to display. The electronic whiteboard 801 has a whiteboard region 259 and image display sections 257 and 258 in which image data received from the tablet PCs 802 and 803 is displayed as images, respectively. The whiteboard region 259 is a region that provides whiteboard functions, such as input by hand and drawing. The contents of the display region 251 are displayed in the whiteboard region 259. The sizes of the region and sections are given by way of example, and may be changed by the user.

On the other hand, on the display 526 of the tablet PC 802, image data captured by the camera of the electronic whiteboard 801 and image data of the user of the tablet PC 803 captured by the camera of the tablet PC 803 are displayed as images. On the display 526 of the tablet PC 803, image data captured by the camera of the electronic whiteboard 801 and image data of the user of the tablet PC 802 captured by the camera of the tablet PC 802 are displayed as images.

### Synchronization Among Electronic Whiteboard and Tablet PCs

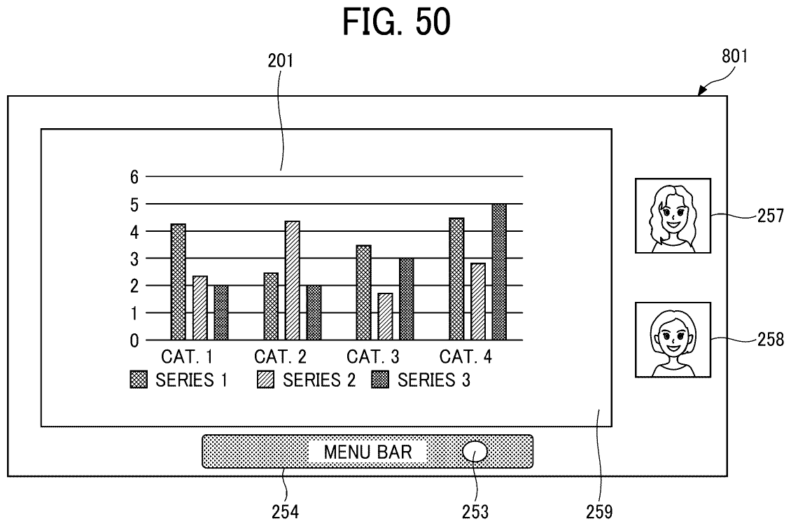

The user of the electronic whiteboard 801 connects a PC that the user uses to the electronic whiteboard 801 with an HDMI cable, and performs an operation for displaying the screen data of the PC as an image on the display 480 of the electronic whiteboard 801 (see FIG. 7). The user then performs an operation for copying the bar graph 217 displayed on the display 480 onto the whiteboard. The screen of the electronic whiteboard 801 in this state is illustrated in FIG. 50.

FIG. 50 is a diagram illustrating the screen that the electronic whiteboard 801 causes the display 480 to display. The bar graph 217 displayed on the screen of the PC is displayed as the content 201 in the whiteboard region 259.

In response to the operation for copying, the whiteboard control unit 833 of the electronic whiteboard 801 performs control for transmitting the display data of the content 201 to the conference server 800. The conference server 800 transmits the received display data to the tablet PCs 802 and 803. Each of the tablet PCs 802 and 803 displays the received display data as an image (that is the content 201) in the whiteboard region 259.

The type-determination unit 813 of the conference server 800 determines that the content of the display data is a “graph (image)” using the type-determination model. The content management unit 814 of the conference server 800 causes a content management table in the conference data storage unit 811 to store the coordinates of the upper-left corner of the rectangular region circumscribing the content (content 201) of the display data, the size of the rectangular region (i.e., the number of display pixels in the lateral and vertical directions), the content input site that is the site A, and the type of content that is the graph (image). The content management table described above may be substantially the same as the content management table in FIG. 10.

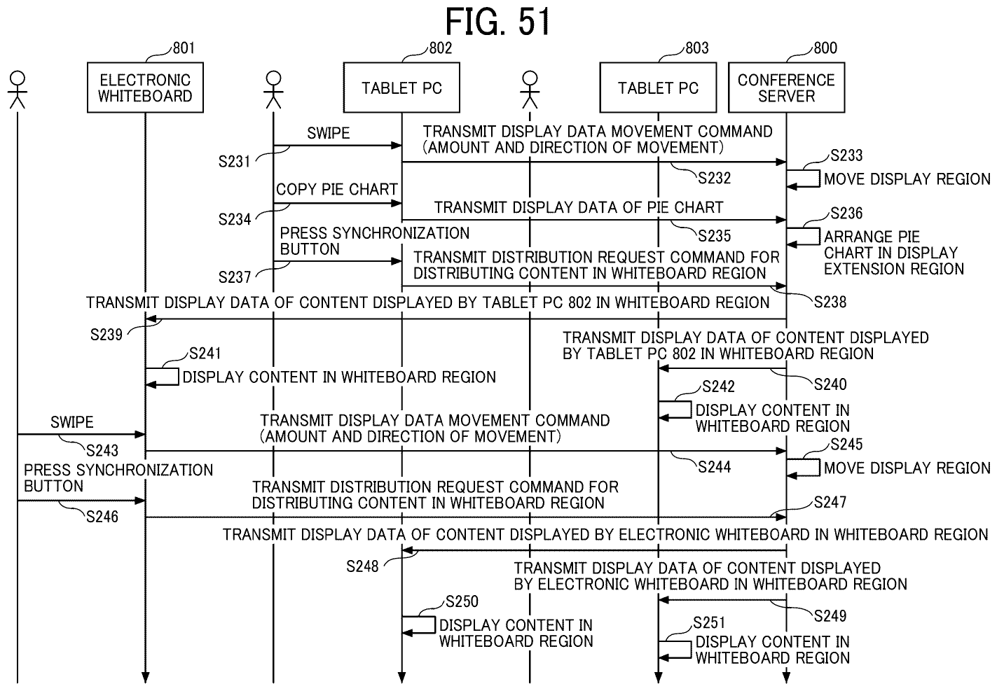

FIG. 51 is a sequence diagram illustrating a synchronization process among the electronic whiteboard 801 and the tablet PCs 802 and 803.

In S231, the user of each device proceeds with a discussion while referring to the content 201 (bar graph). In the middle of the discussion, the topic of sales is brought up. The user of the tablet PC 802 performs an operation for opening a file stored in the tablet PC 802, and performs another operation for displaying a page having a pie chart of sales (using an application different from an application having the whiteboard function). The user of the tablet PC 802 now desires to add the pie chart of sales to the whiteboard. However, since there is no available space in the whiteboard region 259, the user performs a swipe operation within the whiteboard region for moving the content 201 that is the bar graph outside the whiteboard region of the display 526.

In S232, when the swipe operation is performed on the tablet PC 802, the operation reception unit 846 of the tablet PC 802 receives the amount and direction of the movement of the display data. The whiteboard control unit 843 performs control for transmitting a display data movement command (including the amount and direction of the movement) to the conference server 800.

In S233, when the conference server 800 receives the command, the whiteboard control unit 812 moves the content 201 that is the bar graph present in the display region 251 in the direction of the swipe operation. Note that the display region 251 moves in the direction opposite to the direction of the swipe operation.

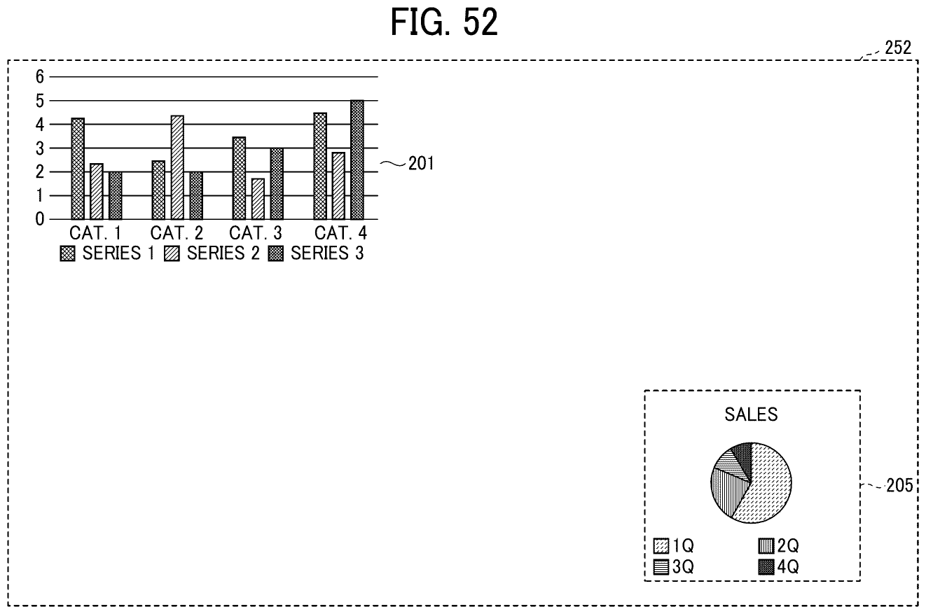

FIG. 52 is a diagram illustrating the contents 201 and 205 arranged in the display extension region 252. The content 201 is moved to the edge of the display extension region 252 according to the swipe operation. Note that, when the swipe operation is performed on the tablet PC 802, the content 205 that is the pie chart is not present in the display extension region 252.

In S234, the user of the tablet PC 802 performs an operation for copying the pie chart of sales, which is displayed by an application different from an application having the whiteboard function, onto the whiteboard.

In S235, the whiteboard control unit 843 of the tablet PC 802 performs control for transmitting the display data of the content 205 that is the pie chart of sales to the conference server 800.

In S236, the conference server 800 arranges the content 205 of the received display data in the display extension region 252. The content 205 is arranged at the position in the display extension region 252 as illustrated in FIG. 52 in response to the swipe operation performed earlier. The type-determination unit 813 of the conference server 800 determines that the content of the display data is a “graph (image)” using the type-determination model. The content management unit 814 of the conference server 800 causes the content management table in the conference data storage unit 811 to store the coordinates of the upper-left corner of the rectangular region circumscribing the content (content 205) of the display data and the size of the rectangular region (i.e., the number of display pixels in the lateral and vertical directions) together with the content input site that is the site B and the type of content that is the graph (image).

In S237, the user of the tablet PC 802 presses a synchronization button for synchronizing the whiteboard. The synchronization button is a button for causing the contents of the display data in the whiteboard region of the device on which the synchronization button is pressed to be displayed (synchronized) on the other devices participating in the conference.

In S238, in response to the operation of pressing the synchronization button, the whiteboard control unit 843 of the tablet PC 802 performs control for transmitting, to the conference server 800, a distribution request command for distributing the contents in the whiteboard region of the tablet PC 802 to the other devices.

In S239 and S240, when the conference server 800 receives the command, the whiteboard control unit 812 performs control for transmitting, to the electronic whiteboard 801 and the tablet PC 803, the display data of the contents displayed in the whiteboard region by the tablet PC 802, from among the contents in the display extension region 252. The current coordinates of the whiteboard region of the tablet PC 802 are attached to the distribution request command. The contents displayed in the whiteboard region by the tablet PC 802 are specified using the coordinates and the content management table.

In S241 and S242, when receiving the display data of the contents, each of the electronic whiteboard 801 and the tablet PC 803 displays the contents in the whiteboard region 259.

In S243, the user of each device proceeds with the discussion while referring to the content 205 (pie chart of sales). At the end of the conference, the user of the electronic whiteboard 801 performs a swipe operation within the whiteboard region 259 for moving the content 205 outside the whiteboard region of the display 480 in order to write action items on the whiteboard.

In S244, when the swipe operation is performed on the electronic whiteboard 801, the operation reception unit 836 of the electronic whiteboard 801 receives the amount and direction of the movement of the display data. The whiteboard control unit 833 performs control for transmitting a display data movement command (including the amount and direction of the movement) to the conference server 800.

In S245, when the conference server 800 receives the command, the whiteboard control unit 812 moves the display region 251 of the electronic whiteboard 801 in the display extension region 252 in the direction opposite to the direction of the swipe operation.

In S246, the user of the electronic whiteboard 801 presses the synchronization button of the whiteboard.

In S247, the whiteboard control unit 833 performs control for transmitting a distribution request command for distributing the contents on the whiteboard displayed on the display 480 of the electronic whiteboard 801 to the conference server 800.

In S248 and S249, when the conference server 800 receives the command, the whiteboard control unit 812 performs control for transmitting, to the tablet PCs 802 and 803, the display data of the contents displayed in the whiteboard region by the electronic whiteboard 801, from among the contents in the display extension region 252. The current coordinates of the whiteboard region of the electronic whiteboard 801 are attached to the distribution request command. The contents displayed in the whiteboard region by the electronic whiteboard 801 are specified using the coordinates and the content management table.

In S250 and S251, in response to receiving the display data of the contents, each of the tablet PCs 802 and 803 displays the contents in the whiteboard region 259. At this point, nothing is displayed on the whiteboard on each device. In the other words, only the swipe operation has been performed at this stage.

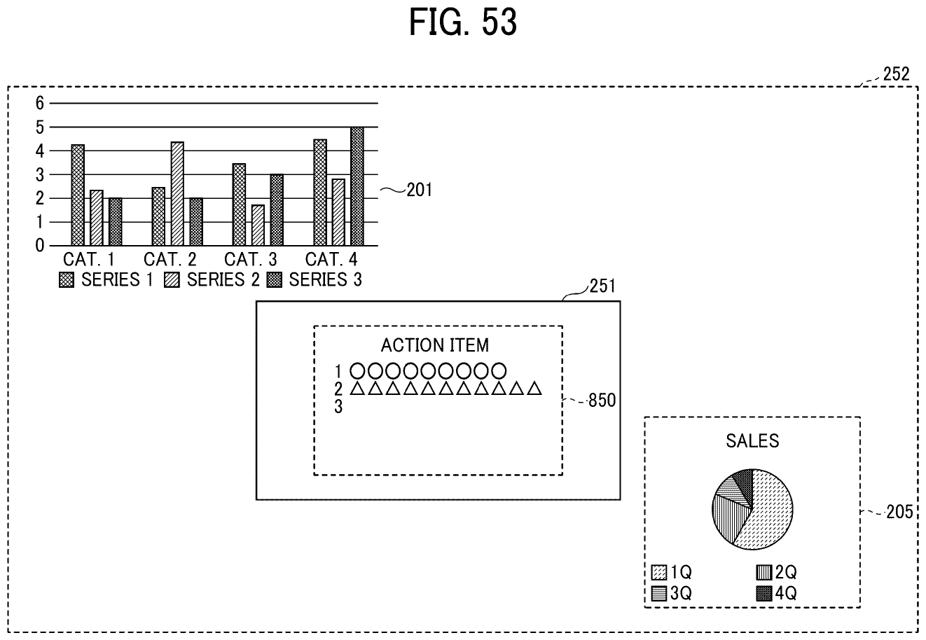

The user of the electronic whiteboard 801 handwrites action items on the whiteboard. The display extension region 252 at this time is illustrated in FIG. 53.

FIG. 53 is a diagram illustrating the contents arranged in the display extension region 252. The content 205 that is the pie chart and the content 201 that is the bar graph are displayed in the display extension region 252. In addition, a content 850 that is the action items has been handwritten in the display region 251.

When the user of the electronic whiteboard 801 has handwritten the action items in the whiteboard region 259, the whiteboard control unit 833 of the electronic whiteboard 801 performs control for transmitting the drawing data of the handwriting to the conference server 800. The whiteboard control unit 812 of the conference server 800 performs control for storing the drawing data and the electronic whiteboard 801 in association with each other, and performs control for transmitting the drawing data to the tablet PCs 802 and 803. In response to receiving the drawing data, each of the tablet PCs 802 and 803 displays the drawing data as a content in the whiteboard region 259.

When the content of the drawing data is added to the display extension region 252 of the conference server 800, the type-determination unit 813 determines that the content of the added drawing data is a drawing (handwriting) using the type-determination model. The content management unit 814 of the conference server 800 causes the content management table in the conference data storage unit 811 to store the coordinates of the upper-left corner of the rectangular region circumscribing the content (content 850) of the drawing data, the size of the rectangular region (i.e., the number of display pixels in the lateral and vertical directions), and the content input site that is the site A together with the type of content that is the drawing (handwriting).

### Aggregation of Contents

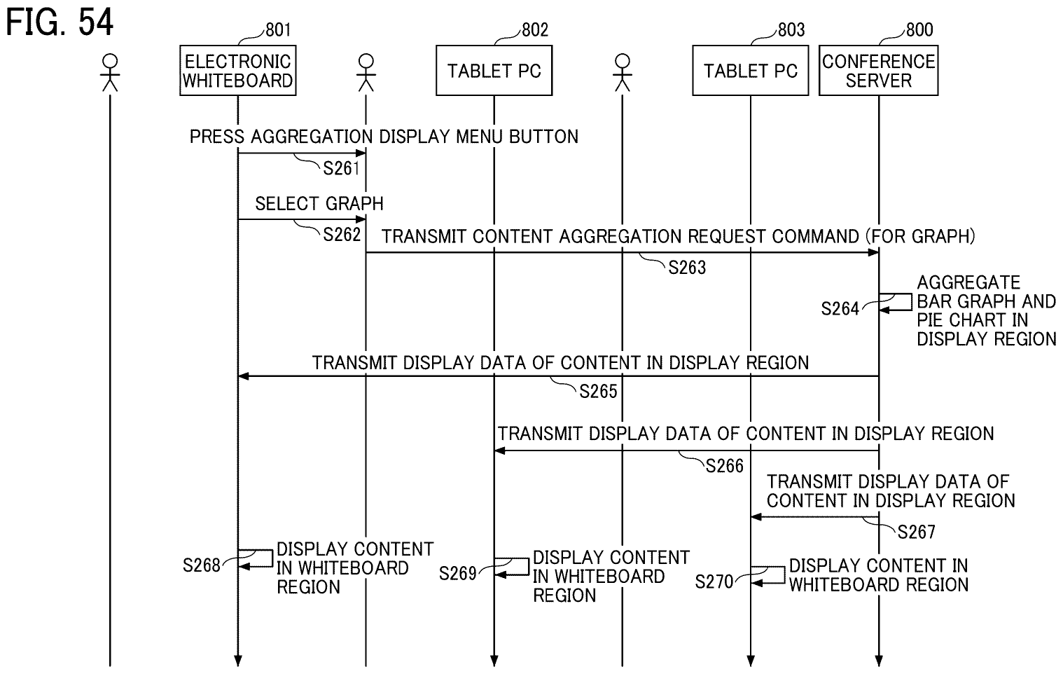

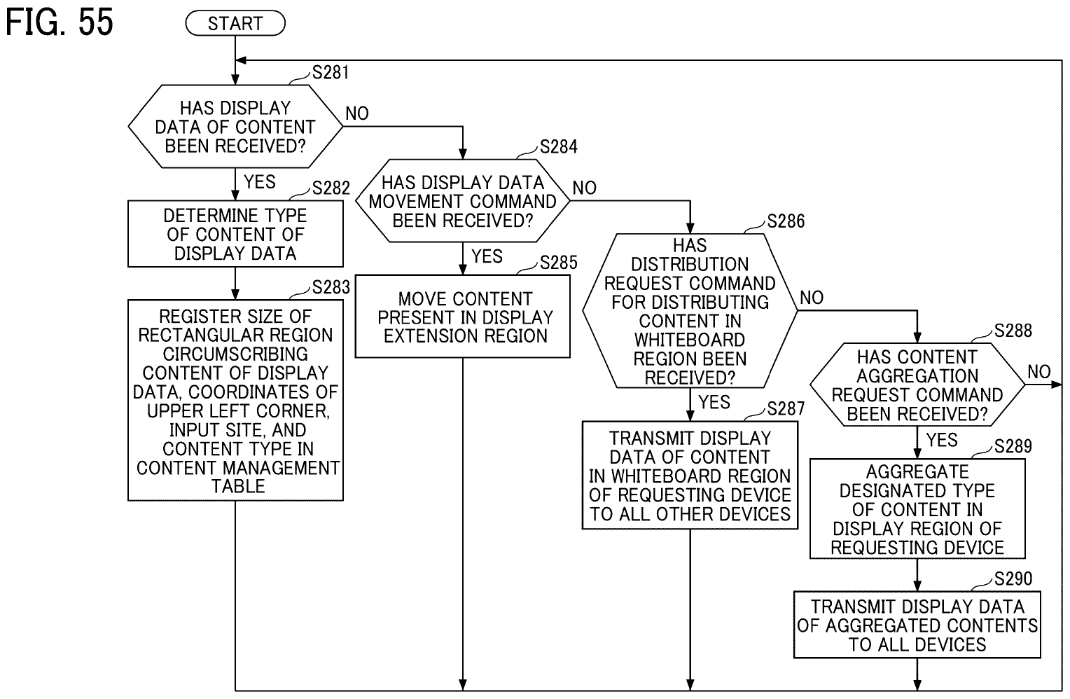

With reference to FIG. 54, a process for displaying the content 201 that is the bar graph and the content 205 that is the pie chart in the whiteboard region 259 is described. FIG. 54 is a sequence diagram illustrating a process for arranging multiple contents in the whiteboard region 259.

In S261, when the user of the electronic whiteboard 801 attempts to handwrite the content 850 that is the action items, it becomes necessary for the user to check the content 201 that is the bar graph and the content 205 that is the pie chart. Then, the user of the electronic whiteboard 801 presses the aggregation display menu button 253 illustrated in FIG. 49.

In S262, the display control unit 837 of the electronic whiteboard 801 performs control for displaying the condition setting screen 260 illustrated in FIG. 11. The user selects a “graph (image)” from among the types of contents.

In S263, the whiteboard control unit 833 of the electronic whiteboard 801 performs control for transmitting a content aggregation request command including the information indicating the graph (image) selected as the type of content to the conference server 800.

In S264, when the conference server 800 receives the command, the aggregation processing unit 815 aggregates the content 201 that is the bar graph and the content 205 that is the pie chart, which are the contents whose type is the graph (image), in the display region 251. At this point, since the two contents 201 and 205 do not fit within the display region 251, the aggregation processing unit 815 reduces the sizes of the contents 201 and 205 so that the contents 201 and 205 fit within the display region 251.

In S265 to S267, the whiteboard control unit 812 performs control for transmitting the display data of the contents 201 and 205 in the display region 251 to the electronic whiteboard 801 and the tablet PCs 802 and 803.

In S268 to S270, when the electronic whiteboard 801 and the tablet PCs 802 and 803 receive the display data of the contents 201 and 205, each of the display control unit 837 of the electronic whiteboard 801 and the display control units 847 of the tablet PCs 802 and 803 performs control for displaying the contents in the whiteboard region 259.

In this way, when the user of the electronic whiteboard 801 performs the operation of the aggregation display, the contents corresponding to the designated type are aggregated and displayed on the displays of all the devices participating in the conference.

FIG. 55 is a flowchart of operations performed by the conference server 800.

In S281, the conference server 800 determines whether display data of a content has been received. In the case where the result of the determination in S281 is Yes (YES in S281), the process proceeds to S282. In the case where the result of the determination in S281 is No (NO in S281), the process proceeds to S284.

In S282, the type-determination unit 813 of the conference server 800 determines the type of the content of the display data. In S283, the content management unit 814 of the conference server 800 causes the content management table to store the size of the rectangular region circumscribing the content of the display data, the coordinates of the upper-left corner of the rectangular region, the content input site, and the type of content.

In S284, the whiteboard control unit 812 of the conference server 800 determines whether a display data movement command has been received. In the case where the result of the determination in S284 is Yes (YES in S284), the process proceeds to S285. In the case where the result of the determination in S284 is No (NO in S284), the process proceeds to S286.

In S285, the whiteboard control unit 812 of the conference server 800 moves the contents present in the display extension region 252.

In S286, the whiteboard control unit 812 of the conference server 800 determines whether a distribution request command for distributing the contents in the whiteboard region has been received. In the case where the result of the determination in S286 is Yes (YES in S286), the process proceeds to S287. In the case where the result of the determination in S286 is No (NO in S286), the process proceeds to S288.

In S287, the whiteboard control unit 812 of the conference server 800 performs control for transmitting the display data of the contents in the whiteboard region 259 of the request source device to all the devices except the request source device.

In S288, the whiteboard control unit 812 of the conference server 800 determines whether a content aggregation request command for aggregating the contents has been received. In the case where the result of the determination in S288 is Yes (YES in S288), the process proceeds to S289. In the case where the result of the determination in S288 is No (NO in S288), the process proceeds to S281.

In S289, the aggregation processing unit 815 of the conference server 800 aggregates contents corresponding to the designated type in the display region 251 of the request source device.

In S290, the whiteboard control unit 812 of the conference server 800 performs control for transmitting the display data of the aggregated contents to all the devices.

In the display system according to the present embodiment, when each user inputs contents to a device used by the user and the synchronization button is pressed, all the contents input to the device can be displayed on the other devices.

### Fourth Embodiment

In the third embodiment, when the contents in the whiteboard region 259 displayed on one of the devices are to be displayed on the other devices, the user needs to press the synchronization button of the whiteboard. In response to the pressing of the synchronization button, the one of the devices transmits a content distribution request command for distributing the contents in the whiteboard region to the conference server 800. The conference server 800 transmits the display data of the contents to the other devices.

In the present embodiment, a case is described in which contents displayed in the whiteboard region 259 by one device are displayed on another device in response to an operation performed by a user of the other device who desires to display the contents on the other device, without requiring any operation by a user of the device on which the contents are displayed.

The configuration of the system, and the hardware and functional configurations of the conference server 800, the electronic whiteboard 801, and the tablet PCs 802 and 803, are substantially the same as those of the corresponding system and devices in the third embodiment.

It is assumed that the electronic whiteboard 801 and the tablet PCs 802 and 803 perform transmission and reception of audio data and image data input via the respective cameras. It is also assumed that, when the user of the electronic whiteboard 801 presses the synchronization button of the whiteboard, the content 201 that is the bar graph illustrated in FIG. 50, which is displayed on the whiteboard, is displayed on the other devices as well.

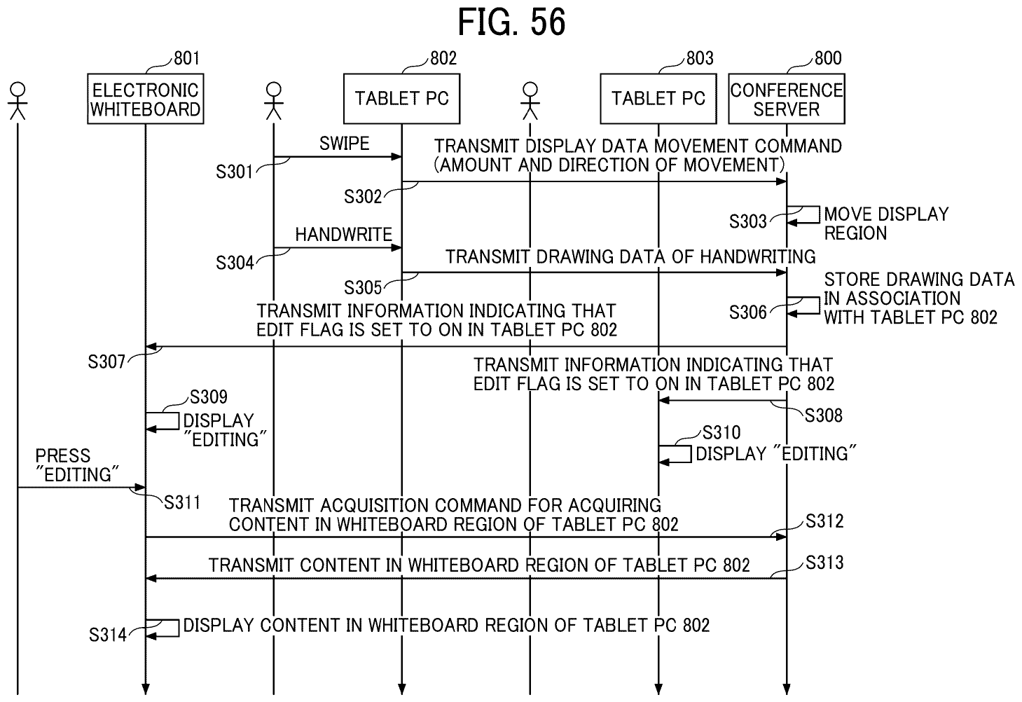

FIG. 56 is a sequence diagram illustrating a transmission process using an edit flag.

The user of each device proceeds with the discussion while referring to the content 201. During the discussion, the user of the tablet PC 802 performs a swipe operation for moving the content 201 that is the bar graph in order to input handwriting.

In S301 and S302, when the swipe operation is performed on the tablet PC 802, the operation reception unit 846 of the tablet PC 802 transmits a display data movement command including the amount and direction of the movement of the content 201 to the conference server 800.

In S303, when the conference server 800 receives the command, the whiteboard control unit 812 moves the display region 251 of the tablet PC in the display extension region 252 in the direction opposite to the direction of the swipe operation.

In S304, the user inputs relevant information by hand in the space that has become blank. Although the user newly adds a content in this case, the user may edit an existing content.

In S305, the whiteboard control unit 843 of the tablet PC 802 performs control for transmitting the drawing data of the handwriting to the conference server 800.

In S306, the whiteboard control unit 812 of the conference server 800 performs control for storing the content of the drawing data and the tablet PC 802 in association with each other. In other words, the type-determination unit 813 of the conference server 800 determines that the content of the drawing data is a drawing (handwriting) using the type-determination model. The content management unit 814 of the conference server 800 causes the content management table in the conference data storage unit 811 to store the coordinates of the upper-left corner of the rectangular region circumscribing the content of the drawing data, the size of the rectangular region (i.e., the number of display pixels in the lateral and vertical directions), and the content input site that is the site B together with the type of content that is the drawing (handwriting).

In S307 and S308, the whiteboard control unit 812 of the conference server 800 performs control for transmitting, to the electronic whiteboard 801 and the tablet PC 803, information indicating that the handwriting is made on the whiteboard by the tablet PC 802 in order to cause the other devices to display, in association with the device from which the input by hand is being received, that the input by hand is being received. The information indicating that the handwriting is made is information indicating that an edit flag is set to on. In S309, when the electronic whiteboard 801 receives the information, the display control unit 837 performs control for displaying “EDITING” under the image display section 257 for the tablet PC 802.

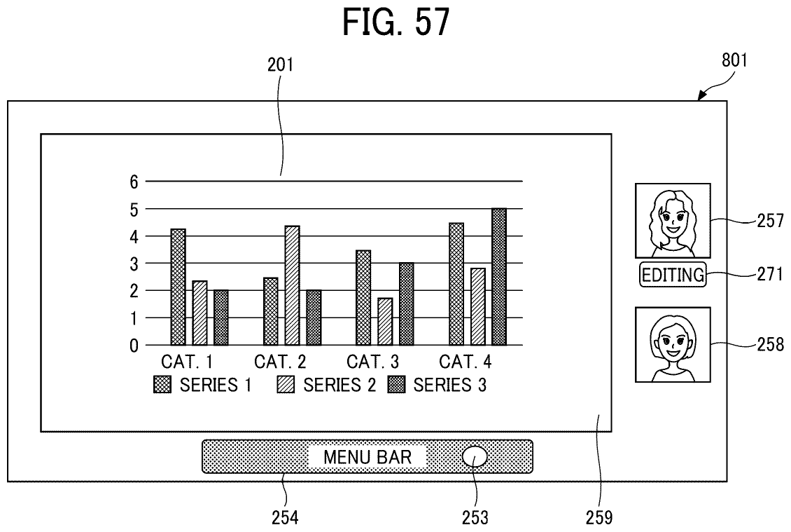

FIG. 57 is a diagram illustrating an example of a screen that the electronic whiteboard 801 causes the display 480 to display. The differences from FIG. 50 are described below with reference to FIG. 57. In FIG. 57, an “EDITING” indication 271 is displayed under the image displayed based on the image data transmitted from the tablet PC 802.

In S310, when the tablet PC 803 receives the information, the display control unit 847 also performs control for displaying the “EDITING” under the image displayed based on the image data transmitted from the tablet PC 802.

In S311, the user of the electronic whiteboard 801 presses the “EDITING” indication 271.

In S312, in response to the pressing, the whiteboard control unit 833 performs control for transmitting to the conference server 800 an acquisition command for acquiring the content that is displayed in the whiteboard region 259 of the tablet PC 802 and has been input or is being input.

In S313, when the conference server 800 receives the command, the whiteboard control unit 812 performs control for transmitting, to the electronic whiteboard 801, the display data of the content that has been input or is being input and is associated with the whiteboard region 259 of the tablet PC 802.

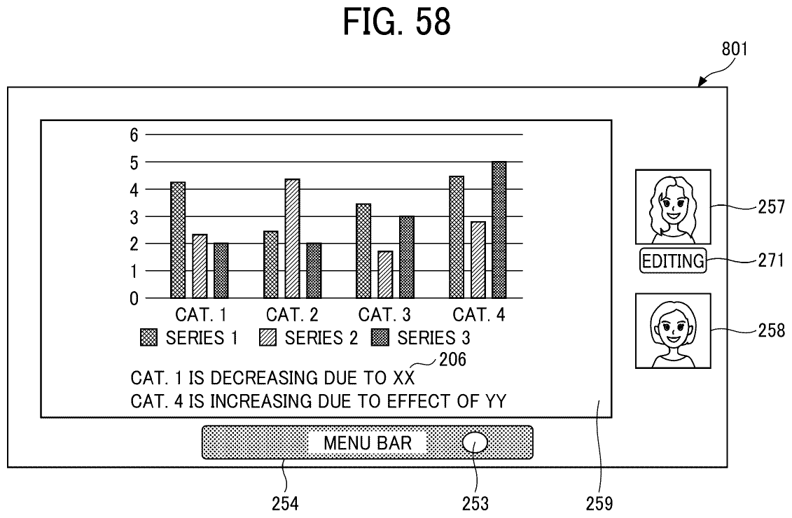

In S314, the display control unit 837 of the electronic whiteboard 801 performs control for displaying the received display data as the content in the whiteboard region 259. In FIG. 58, a content 206 displayed in the whiteboard region 259 by the electronic whiteboard 801 is illustrated.

FIG. 58 is a diagram illustrating the content 206 that the electronic whiteboard 801 causes the display 480 to display. In comparison with FIG. 57, the content 206 representing the drawing data of the handwriting made by the user of the tablet PC 802 is presented in FIG. 58. The drawing data may have been input already or may be being input. The contents 201 and 206 in the whiteboard region of the tablet PC 802 are displayed in the whiteboard region 259 of the electronic whiteboard 801.

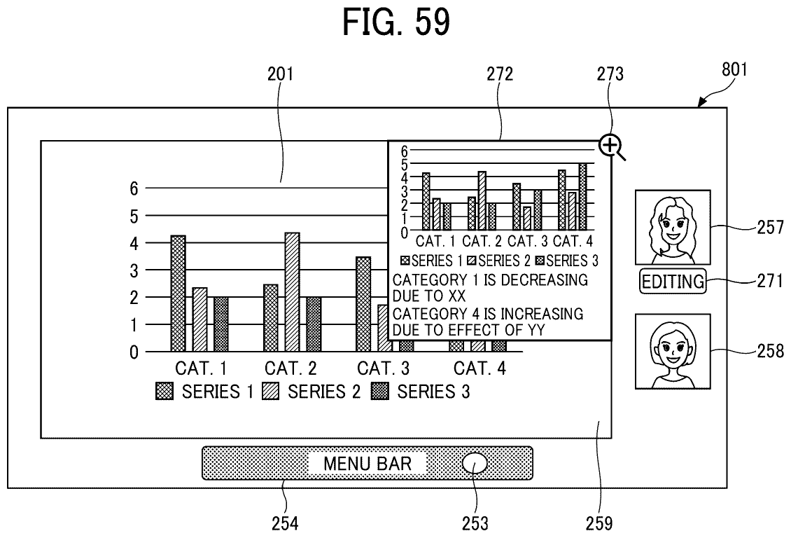

In FIG. 58, the content 206 of the tablet PC 802 is displayed in the whiteboard region 259 of the electronic whiteboard 801 by overwriting the content already displayed in the whiteboard region. However, as illustrated in FIG. 59, the content displayed in the whiteboard region 259 of the electronic whiteboard 801 may be retained without being overwritten.

FIG. 59 is a diagram illustrating a thumbnail 272 in which the whiteboard region 259 of the tablet PC 802 is presented in a reduced size. The thumbnail 272 is an image obtained by reducing the whiteboard region 259 of the tablet PC 802 in size. At the upper-right corner of the thumbnail 272, an “ENLARGE” icon 273 (an example of a display component) is displayed. When the user presses the “ENLARGE” icon 273, the electronic whiteboard 801 causes the contents on the whiteboard of the tablet PC 802 to be displayed at full size on the whiteboard of the electronic whiteboard 801 as illustrated in FIG. 58. The thumbnail may be presented not only when the user of the electronic whiteboard 801 presses the “EDITING” indication 271, but also when the pointer is hovered over the “EDITING” indication 271. In the following description, the operations such as pressing the “EDITING” indication 271 and hovering the pointer over the “EDITING” indication 271 are collectively referred to as a “display selection” operation.

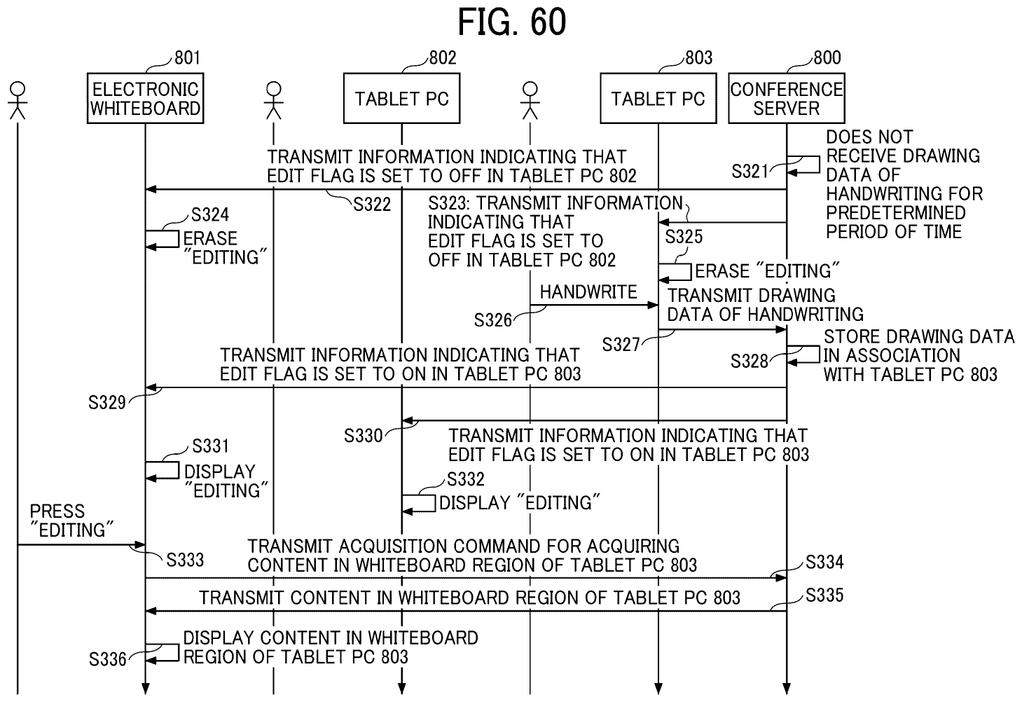

FIG. 60 is a sequence diagram illustrating a process for erasing the edit flag.

In 321, when the whiteboard control unit 812 of the conference server 800 does not receive the drawing data of the handwriting from the tablet PC 802 for a predetermined period of time, the whiteboard control unit 812 determines that the handwriting has ended.

In S322 and S323, the whiteboard control unit 812 of the conference server 800 performs control for transmitting, to the electronic whiteboard 801 and the tablet PC 803, information indicating that the handwriting made on the whiteboard by the tablet PC 802 has ended, such as information indicating that the edit flag is set to off.

In S324, in response to receiving the information, the electronic whiteboard 801 erases the “EDITING” indication 271 that the display control unit 837 causes to be displayed under the image displayed based on the image data transmitted from the tablet PC 802.

In S325, in response to receiving the information, the tablet PC 803 also erases the “EDITING” that the display control unit 847 causes to be displayed under the image displayed based on the image data transmitted from the tablet PC 802.

In S326, the user of the tablet PC 803 performs a swipe operation for moving the content 205 that is the pie char upward within the whiteboard region 259, and handwrites relevant information in the space that has become blank.

In S327, the whiteboard control unit 843 of the tablet PC 803 performs control for transmitting the drawing data of the handwriting to the conference server 800.

In S328, the whiteboard control unit 812 of the conference server 800 performs control for storing the drawing data and the tablet PC 803 in association with each other. In other words, the type-determination unit 813 of the conference server 800 determines that the content of the drawing data is a drawing (handwriting) using the type-determination model. The content management unit 814 of the conference server 800 causes the content management table in the conference data storage unit 811 to store the coordinates of the upper-left corner of the rectangular region circumscribing the content of the drawing data, the size of the rectangular region (i.e., the number of display pixels in the lateral and vertical directions), and the content input site that is the site C together with the type of content that is the drawing (handwriting).

In S329 and S330, the whiteboard control unit 812 of the conference server 800 performs control for transmitting, to the electronic whiteboard 801 and the tablet PC 802, information indicating that the handwriting is made on the whiteboard by the tablet PC 803, such as information indicating that the edit flag is set to on.

In S331, when the electronic whiteboard 801 receives the information, the display control unit 837 performs control for displaying an “EDITING” indication 274 under the image display section 258 for the tablet PC 803.

In S332, when the tablet PC 802 receives the information, the display control unit 847 also performs control for displaying “EDITING” under the image display section for the tablet PC 803.

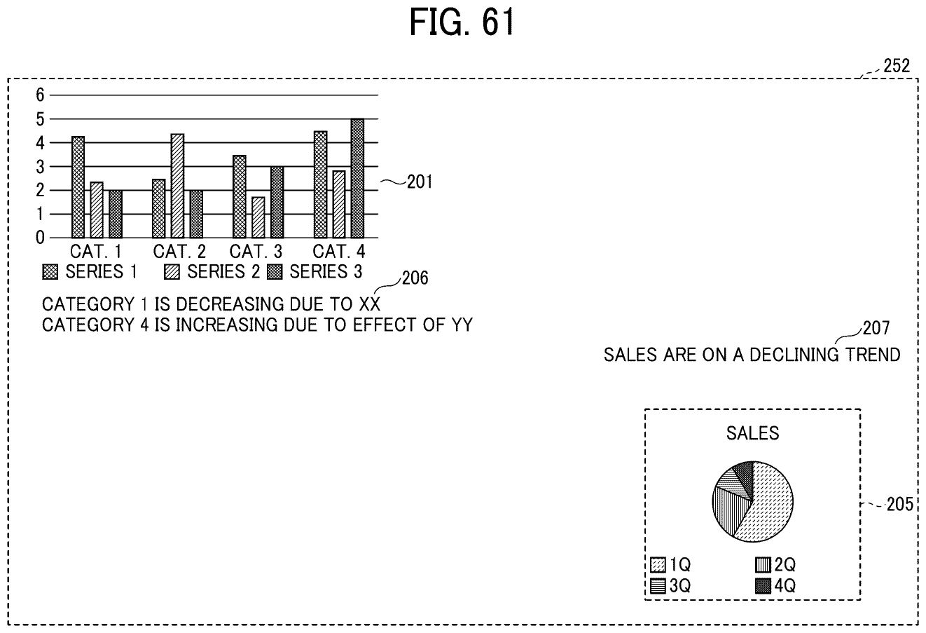

FIG. 61 is a diagram illustrating how the contents are arranged in the display extension region 252. A content 207 representing the drawing data of the handwriting added by the user of the tablet PC 803 is additionally displayed. The content 206 is the handwriting made by the user of the tablet PC 802 as illustrated in FIG. 58.

In S333, the user of the electronic whiteboard 801 presses the “EDITING” indication 274 displayed under the image display section 258 for the tablet PC 803.

In S334, the whiteboard control unit 833 performs control for transmitting an acquisition command for acquiring the content in the whiteboard region 259 of the tablet PC 803 to the conference server 800.

In S335, when the conference server 800 receives the command, the whiteboard control unit 812 performs control for transmitting, to the electronic whiteboard 801, the display data of the content associated with the whiteboard region 259 of the tablet PC 803.

In S336, the display control unit 837 of the electronic whiteboard 801 performs control for displaying the received display data as the content.

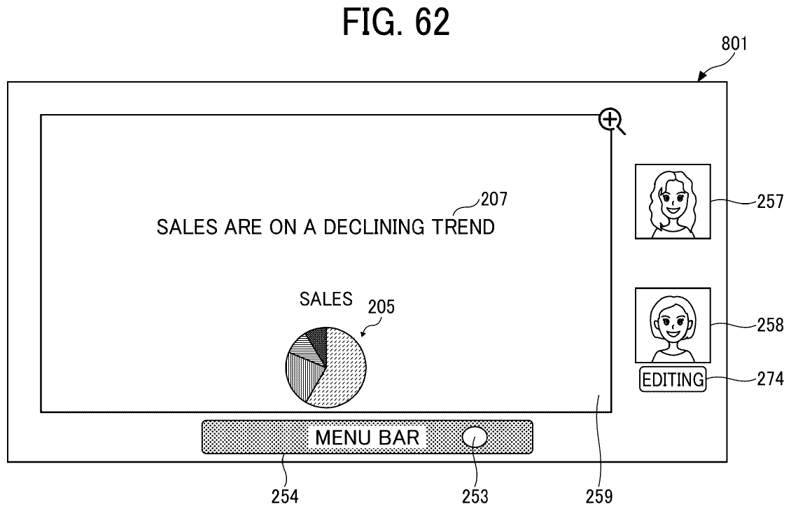

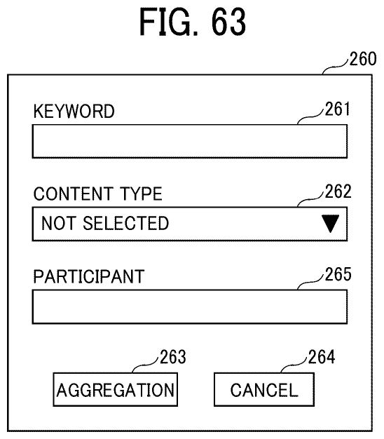

FIG. 62 is a diagram illustrating the contents that the electronic whiteboard 801 displays in the whiteboard region 259. In FIG. 62, the electronic whiteboard 801 displays the contents 205 and 207 that have been acquired from the tablet PC 803 and are displayed on the whiteboard region 259 by the tablet PC 803. Accordingly, the electronic whiteboard 801 and the tablet PC 803 are synchronized. Further, the “EDITING” indication 274 is displayed under the image display section 258 in which the image is displayed based on the image data transmitted from the tablet PC 803. Instead of displaying the contents acquired from the tablet PC 803 over the entire of the whiteboard region 259 as illustrated in FIG. 62, the contents may be displayed as a thumbnail. Specifically, while the content 201 is displayed in the whiteboard region 259, the contents 205 and 207 present outside the whiteboard region 259 may be presented only as a thumbnail. The thumbnail may be presented not only when the user of the electronic whiteboard 801 presses the “EDITING” indication 271, but also when the pointer is hovered over the “EDITING” indication 274, that is, when the “EDITING” indication 274 is selected.

At this point, the user of the tablet PC 803 has not yet performed an operation for displaying the content 206 representing the drawing data of the handwriting in FIG. 58 made by the user of the tablet PC 802. Moreover, the user of the tablet PC 802 has not yet performed an operation for displaying the content 207 representing the drawing data of the handwriting in FIG. 62 made by the user of the tablet PC 803 either. In view of the above, the user of the electronic whiteboard 801 decides to consolidate both sets of the information on the handwriting and send the consolidated information to tablet PCs 802 and 803. The user of the electronic whiteboard 801 presses the aggregation display menu button 253. In response to the pressing, the condition setting screen is displayed. The user can also set the image of the whiteboard region 259 of the electronic whiteboard 801 to be displayed as it is. In this case, the thumbnail presenting the contents 205 and 207 to be displayed by selecting the “EDITING” indication is also displayed to each user on each tablet PC (without the decision of sending by the user of the electronic whiteboard 801).

FIG. 63 is a diagram illustrating the condition setting screen 260 that the electronic whiteboard 801 displays. The keyword field 261 is an input field for entering a keyword for searching for a content. The user is allowed to enter a request, question, or keyword in the keyword field 261. In the type-designation field 262, the type of content to be displayed is displayed, for example, in a pull-down menu. A participant field 265 is a designation field for designating a participant and displaying images representing drawing data of handwriting made by the participant. The aggregation button 263 is a button for aggregating the contents in the display extension region 252.

The condition setting screen 260 illustrated in FIG. 63 includes the participant field 265, which is added to the condition setting screen illustrated in FIG. 11.

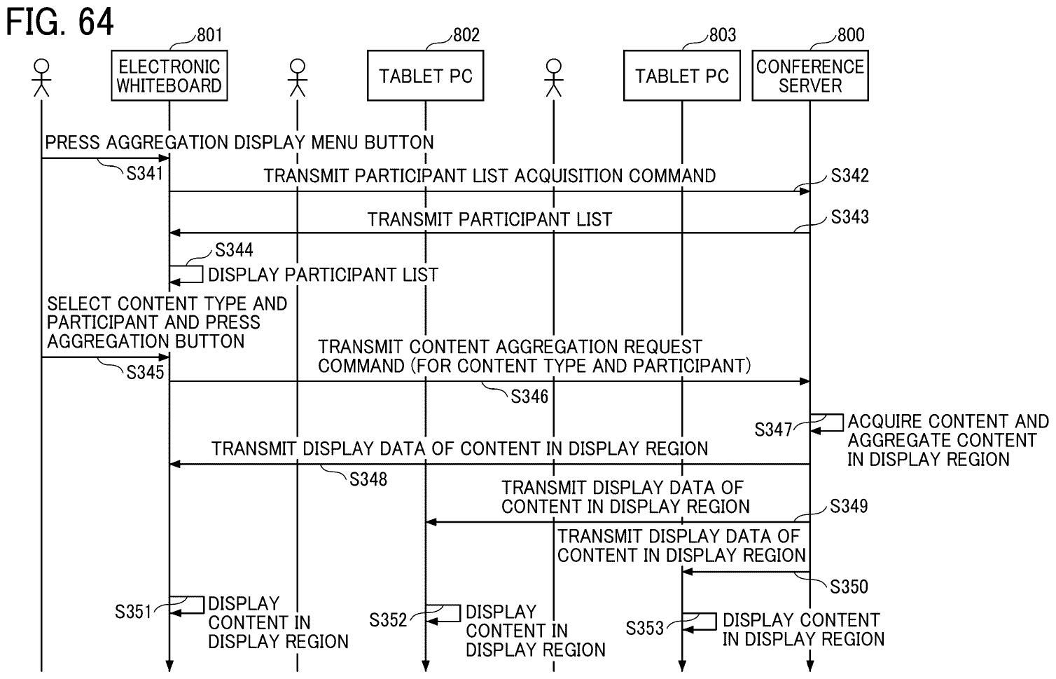

FIG. 64 is a sequence diagram illustrating a process for transmitting the contents to the electronic whiteboard 801 and the tablet PCs 802 and 803.

In S341, the user of the electronic whiteboard 801 presses the aggregation display menu button 253.

In S342, the electronic whiteboard 801 displays the condition setting screen 260 in FIG. 63, and the conference control unit 830 performs control for transmitting a participant list acquisition command for acquiring a list of participants to the conference server 800.

In S343, when the conference server 800 receives the command, the conference control unit 810 performs control for acquiring the names of the participants in the conference from the conference data storage unit 811 and transmitting the list of participants to the electronic whiteboard 801.

In S344, the electronic whiteboard 801 receives the list of participants. When the user of the electronic whiteboard 801 touches the participant field, the display control unit 837 performs control for displaying a list of the names of the participants received from the conference server 800 in the participant field 265 in a pull-down manner.

In S345, the user of the electronic whiteboard 801 selects the users of the tablet PCs 802 and 803, selects the drawing (handwriting) as the type of content, and presses the aggregation button 263.

In S346, the whiteboard control unit 833 of the electronic whiteboard 801 transmits a content aggregation request command including the information on the selected items to the conference server 800.

In S347, when the conference server 800 receives the command, the aggregation processing unit 815 refers to the content management table in the conference data storage unit 811, and aggregates the contents of drawing (handwriting) whose content input site is the site B and the contents of drawing (handwriting) whose content input site is the site C in the display region 251. Note that the conference control unit 810 of the conference server 800 performs control for storing the names of the participants and the sites of the participants in association with each other in the conference data storage unit 811.

In S348 to S350, the whiteboard control unit 812 of the conference server 800 performs control for transmitting the display data of the contents in the display region 251 to the electronic whiteboard 801 and the tablet PCs 802 and 803.

In S351 to S353, when receiving the display data of the contents, the display control unit 837 of the electronic whiteboard 801 and the display control units 847 of the tablet PCs 802 and 803 each perform control for displaying the display data as the contents in the whiteboard region 259.

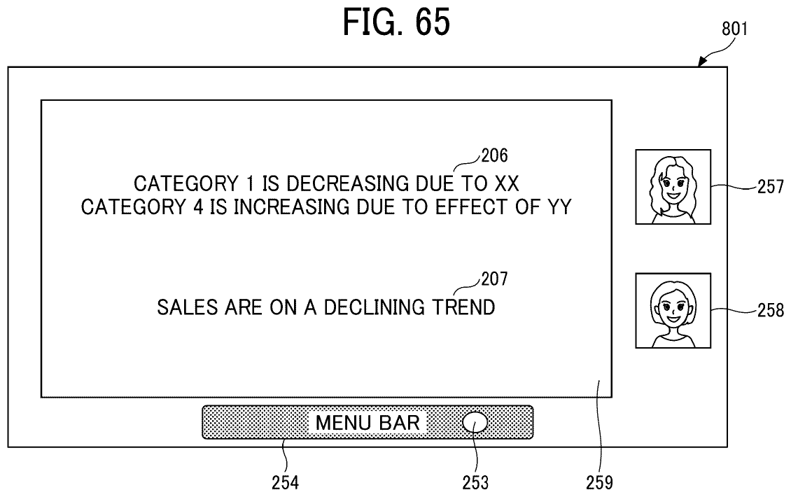

FIG. 65 is a diagram illustrating the contents that the electronic whiteboard 801 displays in the whiteboard region 259. The same screen as in FIG. 65 is also displayed on the tablet PCs 802 and 803. In FIG. 65, the contents are arranged in descending order based on the area of each content. The content 206 is input by the user of the tablet PC 802 by hand, and the content 207 representing the drawing data is input by the user of the tablet PC 803 by hand. In this way, the contents corresponding to the type selected by the user of the electronic whiteboard 801 and associated with each user can be aggregated and displayed.

In the display system according to the present embodiment, when each user inputs contents to a device used by the user, the contents input to the device can be displayed on the other devices by the user of another device pressing an “EDITING” indication (button). The contents that correspond to the type selected by a user and are associated with each user can be aggregated and displayed.

### Fifth Embodiment

In the present embodiment, a case is described in which the user instructs the electronic whiteboard 801 to perform the aggregation display by voice, instead of the operation of the menu displayed on the display.

The configuration of the system, and the hardware configurations of the conference server 800, the electronic whiteboard 801, and the tablet PCs 802 and 803, are substantially the same as those of the corresponding system and devices in the third embodiment.

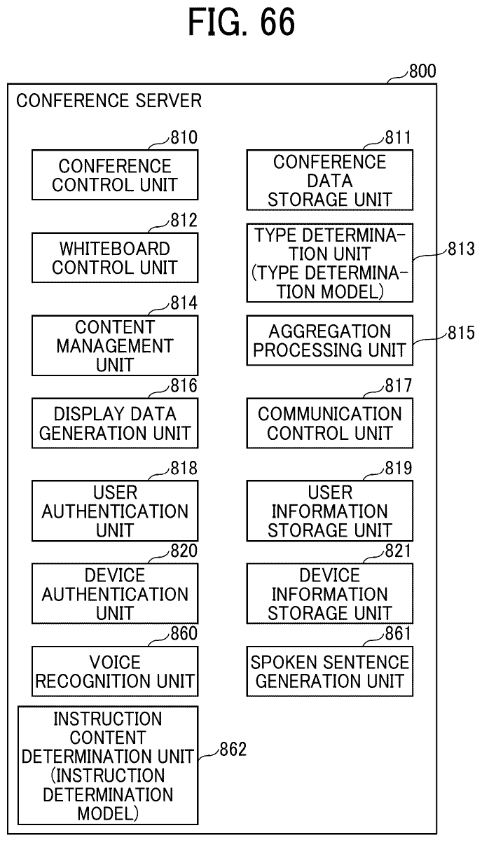

FIG. 66 is a block diagram illustrating a functional configuration of the conference server 800 according to the present embodiment. The differences from FIG. 45 are described below with reference to FIG. 66. The conference server 800 of FIG. 66 additionally includes a voice recognition unit 860, a spoken sentence generation unit 861, and an instruction content determination unit 862. The rest of the functional units are substantially the same as the corresponding functional units in FIG. 45.

The voice recognition unit 860 decodes encoded audio data received from another device, and outputs text corresponding to the audio data through voice recognition.

The spoken sentence generation unit 861 generates a sentence based on the data of the text output from the voice recognition unit 860.

The instruction content determination unit 862 determines an instruction content based on the sentence generated by the spoken sentence generation unit 861. The instruction content determination unit 862 uses a method of instruction tuning for learning a specific instruction to increase the accuracy of the determination of the instruction content. The instruction tuning is a method for fine-tuning a large language model (LLM) using a labeled data set of instruction contents and outputs corresponding the instruction contents.

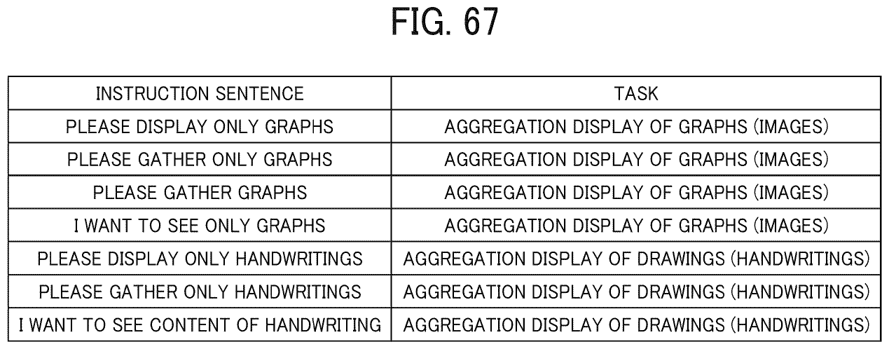

FIG. 67 is a diagram illustrating examples of correspondence between instruction sentences used for the instruction tuning and outputs (tasks) corresponding to the instruction sentences. Thus, when an instruction sentence is provided, the task is identified.

First, as in the third embodiment, a remote conference is performed among the electronic whiteboard 801, the tablet PCs 802, and 803 using audio data, image data, and a whiteboard. The contents as illustrated in FIG. 1 are arranged in the display extension region 252. In this state, when the user of the electronic whiteboard 801 speaks “Please display only graphs,” the audio transmission/reception unit 831 of the electronic whiteboard 801 encodes, in accordance with the AAC system, audio data obtained by performing A/D conversion on the audio signals input from the microphone 440, and transmits the encoded audio data to the conference server 800. The conference server 800 decodes the audio data. The voice recognition unit 860 outputs text corresponding to the audio data through voice recognition. The spoken sentence generation unit 861 generates a sentence based on the data of the text.

The instruction content determination unit 862 determines an instruction content (task) based on the sentence generated by the spoken sentence generation unit 861. The instruction content determination unit 862 identifies a task of the aggregation display of graphs (images) based on the correspondence in FIG. 67.

The aggregation processing unit 815 refers to the content management table in the conference data storage unit 811, and aggregates the bar graph (content 201) and the pie chart (content 205) in the display region 251. The whiteboard control unit 812 of the conference server 800 performs control for transmitting the display data of the contents in the display region 251 to the electronic whiteboard 801 and the tablet PCs 802 and 803. When receiving the display data of the contents, the electronic whiteboard 801 and the tablet PCs 802 and 803 each display the display data as the contents in the whiteboard region 259. An example of the display on the electronic whiteboard 801 at this time is substantially the same as that of FIG. 19.

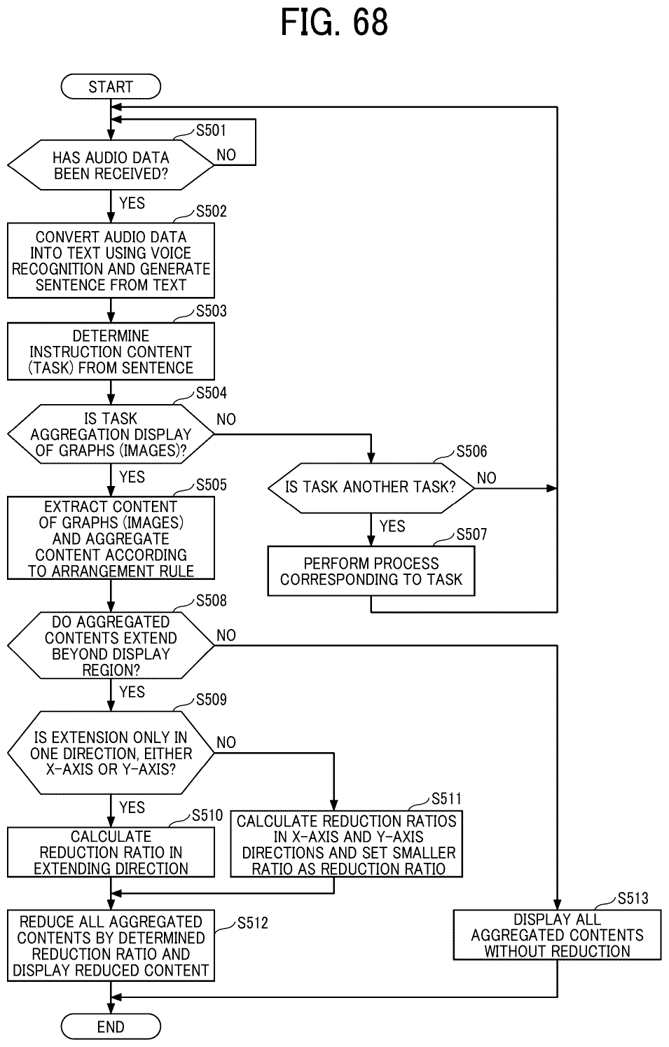

FIG. 68 is a flowchart of a process performed by the conference server 800 when receiving an instruction of aggregation display by voice.

In S501, the communication control unit 817 of the conference server 800 determines whether audio data has been received.

In the case where it is determined that audio data is received (YES in S501), in S502, the voice recognition unit 860 of the conference server 800 converts the audio data into text through voice recognition and generates a sentence based on the text.

In S503, the instruction content determination unit 862 of the conference server 800 refers to the correspondence in FIG. 67 and determines an instruction content (task) based on the sentence.

In S504, the instruction content determination unit 862 of the conference server 800 determines whether the task is aggregation display of graphs (images). In the case where the result of the determination in S504 is Yes (YES in S504), the process proceeds to S505. In the case where the result of the determination in S504 is No (NO in S504), the process proceeds to S506.

In S505, the content management unit 814 of the conference server 800 extracts the contents of the graph (image) and aggregates the contents in accordance with the arrangement rule.

In S506, the instruction content determination unit 862 of the conference server 800 determines whether the task is other than the aggregation display of graphs (images). In the case where it is determined that the task is other than the aggregation display of graphs (images), in S507, the conference server 800 performs a process corresponding to the task. Then, the process returns to S501.

In S508, the whiteboard control unit 812 of the conference server 800 determines whether the aggregated contents extend beyond the display region 251. In the case where the result of the determination in S508 is Yes (YES in S508), the process proceeds to S509. In the case where the result of the determination in S508 is No (NO in S508), the process proceeds to S513.

In S509, the aggregation processing unit 815 of the conference server 800 determines whether the aggregated contents extend beyond the display region 251 only in one direction, either the X-axis direction or the Y-axis direction. In the case where the result of the determination in S509 is Yes (YES in S509), the process proceeds to S510. In the case where the result of the determination in S509 is No (NO in S509), the process proceeds to step S511.

In S510, the aggregation processing unit 815 of the conference server 800 calculates a reduction ratio in the direction in which the aggregated contents extend.

In S511, the aggregation processing unit 815 of the conference server 800 calculates reduction ratios in the X-axis and Y-axis directions and sets the smaller of the two ratios as the reduction ratio.

In S512, the aggregation processing unit 815 of the conference server 800 reduces the sizes of all the aggregated contents by the determined reduction ratio and displays the contents in the display region 251.

In S513, the whiteboard control unit 812 of the conference server 800 displays all the aggregated contents without reduction.

In the display system according to the present embodiment, multiple contents can be aggregated by voice.

### Applied Cases

The embodiments described above are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

For example, in one aspect of the present disclosure, the user handwrites on an electronic whiteboard. However, alternatively or additionally, characters input using a keyboard or an operation by voice may also be used. The scrolling may be performed by an operation by voice.

The electronic whiteboard 2 of the first embodiment may communicate with the VR goggles, and the VR goggles may display the contents aggregated in the display region 251.

In one aspect of the present disclosure, the amount of scrolling of the display region is determined by an operation performed by the user. However, the amount of scrolling may be fixed in units of pages. That is, the amount of scrolling by one operation corresponds to the movement of one screen. Alternatively, the electronic whiteboard 2 may automatically determine a minimum amount of scrolling required to cause the display region 251 to return to a blank state, and may automatically scroll by the determined amount. In this case, when the user performs a swipe operation for scrolling, the display region 251 is scrolled by the minimum amount that causes the display region 251 to return to a blank state, regardless of the amount of scrolling.

The electronic whiteboard may also be referred to as an electronic information board or an interactive board. The embodiments described above can be suitably applied not only to an electronic whiteboard but also to any information processing apparatus having a touch panel. Examples of the information processing apparatus having a touch panel include a PC, a tablet terminal, and a smartphone each having a touch panel. These are general-purpose information processing apparatuses. However, when an application that functions as a display device is executed on any one of the information processing apparatuses, the user can operate the information processing apparatus as a display device.

The functional configuration illustrated in, for example, FIG. 5 is divided according to functions in order to facilitate understanding of the processing units executed by the electronic whiteboard 2. No limitation to the scope of the present disclosure is intended by how the processing units are divided or by the names of the processing units. The processing units executed by the electronic whiteboard 2 may be divided into a greater number of processing units in accordance with the contents of the processing units. In addition, a single processing unit can be divided to include a greater number of processing units.

Further, in the embodiments described above, the electronic whiteboard 2 detects the coordinates of a position contacted by the tip of the pen using the touch panel. In another example, the electronic whiteboard 2 may detect the coordinates of a position contacted by the tip of the pen using ultrasonic waves. The pen transmits an ultrasonic wave together with light emission, and the electronic whiteboard 2 calculates a distance based on an arrival time of the ultrasonic wave. The electronic whiteboard 2 can specify the position contacted by the pen based on the direction of the ultrasonic wave and the distance. The electronic whiteboard 2 displays display data as an image on a display. In the case of such a method, the electronic whiteboard 2 may use a projector instead of a display, and projects the trajectory of the pen to the projector as an image of drawing data.

Each of the functions of the embodiments described above may be implemented by one or more processing circuits or circuitry. The “processing circuit or circuitry” herein includes a programmed processor to execute each function by software, such as a processor implemented by an electronic circuit, and devices, such as an application-specific integrated circuit (ASIC), a digital signal processor (DSP), a field-programmable gate array (FPGA), and circuit modules known in the art arranged to perform the recited functions.

Embodiments of the present disclosure provide significant improvements in computer capabilities and functionality. These enhancements allow users to take advantage of a computer that provides more efficient and robust interaction with a table, which is a way to store and present information on an information processing apparatus. Further, embodiments of the present disclosure provide a better user experience through the use of a more efficient, powerful, and robust user interface. Such a user interface provides a better interaction between a human and a machine.

Aspects of the present disclosure are, for example, as follows.

According to Aspect 1, a display method performed by an information processing apparatus that scrolls a display region to display contents input to a display extension region includes extracting one or more contents from the contents input to the display extension region based on the types of the contents and aggregating the extracted one or more contents in the display region.

According to Aspect 2, the display method of Aspect 1 further includes receiving selection of the types of the contents from a user, extracting the one or more contents corresponding to the types of the contents received from the user from among the contents input to the display extension region, and aggregating the extracted one or more contents in the display region.

According to Aspect 3, the display method of Aspect 2 further includes displaying a list of only the types of the contents present in the display extension region and receiving the selection of the types of the contents out of the list of the types of the contents.

According to Aspect 4, the display method of any one of Aspects 1 to 3 further includes, in the case where the one or more contents aggregated in the display region do not fit within the display region, reducing the sizes of the one or more contents aggregated in the display region so that the one or more contents aggregated in the display region fit within the display region.

According to Aspect 5, in the display method of Aspect 2, the one or more contents include position information corresponding to a position of each of the one or more contents based on a predetermined origin and size information corresponding to the size of each of the one or more contents. The display method includes displaying the one or more contents corresponding to the types of the contents selected by the user so that the one or more contents fit within the display region using the position information and the size information.

According to Aspect 6, in the display method of Aspect 5, the position information is information indicating a predetermined edge portion of each of the one or more contents.

According to Aspect 7, in the display method of Aspect 6, the size information is information calculated based on the information indicating the predetermined edge portion of each of the one or more contents and information indicating another edge portion of each of the one or more contents.

According to Aspect 8, in the display method of Aspect 7, the size information is information calculated based on a difference between the information indicating the predetermined edge portion of each of the one or more contents and the information indicating the other edge portion of each of the one or more contents.

According to Aspect 9, in the display method of Aspect 8, the size information includes, in addition to the information indicating the predetermined edge portion and the information indicating the other edge portion, information indicating still another edge portion different from the predetermined edge portion and the other edge portion, and the size information includes second size information calculated based on the information indicating the predetermined edge portion and the information indicating still the other edge portion.

According to Aspect 10, in the display method of Aspect 9, the second size information is information calculated based a difference between the information indicating the predetermined edge portion and the information indicating still the other edge portion.

According to Aspect 11, the display method of Aspect 10 further includes arranging each of the one or more contents according to a predetermined rule and displaying each of the one or more contents in the display region.

According to Aspect 12, in the display method of Aspect 11, the predetermined rule is changing the size of each of the one or more contents based on the size information of each of the one or more contents and displaying each of the one or more contents in the display region.

According to Aspect 13, the display method of Aspect 2 further includes grouping the one or more contents corresponding to the types of the contents received from the user.

According to Aspect 14, the display method of any one of Aspects 1 to 13 further includes, when the contents are input to the display region, determining the types of the contents input to the display region and registering, in association with the contents, the determined types of the contents in a content management table.

According to Aspect 15, the display method of Aspect 3 includes receiving input of a keyword from the user, extracting the one or more contents that match the keyword and correspond to the types of the contents received from the user from among the contents input to the display extension region, and aggregating the extracted one or more contents in the display region.

According to Aspect 16, the display method of Aspect 1 further includes communicating with multiple devices, transmitting the display data of the one or more contents aggregated in the display region to the multiple devices, and causing the multiple devices to display the one or more contents based on the display data.

According to Aspect 17, the display method of Aspect 1 further includes holding, in association with the contents, identification information of the user who adds or edits the contents, when selection of the types of the contents and selection of the identification information of the user who adds or edits the contents are received, extracting the one or more contents that are associated with the user and correspond to the types of the contents received from the user from among the contents input to the display extension region, and aggregating the extracted one or more contents in the display region.

According to Aspect 18, the display method of Aspect 16 further includes, when the information processing apparatus detects a device from which input to the display extension region is being received, causing other devices to display, in association with the device from which the input is being received, information indicating that the input is being received.

According to Aspect 19, in the display method of Aspect 18, the input is input by hand.

According to Aspect 20, the display method of Aspect 18 or 19 includes receiving image data obtained by capturing images of users of the multiple devices from the multiple devices and causing the other devices to display, in association with the image data transmitted from the device from which the input is being received, the information indicating that the input is being received.

According to Aspect 21, the display method of Aspect 18 or 19 includes, when the device accepts selection of the display of the information indicating that the input is being received and the information processing apparatus receives a request for acquiring the contents that the device from which the input is being received is displaying in a whiteboard region from the other devices, transmitting the display data of the contents in the whiteboard region of the device from which the input is being received to the other devices that accept the selection of the display, reducing the sizes of the contents representing the display data, causing the other devices to display the contents based on the display data, and displaying a display component for receiving enlargement, and when receiving pressing of the display component, enlarging the sizes of the contents representing the display data and displaying the contents based on the display data.

According to Aspect 22, the display method of Aspect 18 or 19 includes, when the device accepts selection of the display of the information indicating that the input is being received, transmitting the display data of the contents that have been input or are being input from the device from which the input is being received to the other devices that accept the selection of the display, and causing the other devices to display the contents that have been input or are being input.

According to Aspect 23, the display method of Aspect 18 or 19 includes, when the device accepts selection of the display of the information indicating that the input by hand is being received and the information processing apparatus receives a request for acquiring the contents that the device from which the input is being received is displaying in a whiteboard region from the other devices, transmitting the display data of the contents in the whiteboard region of the device from which the input is being received to the other devices that accept the selection of the display and causing the other devices to display the whiteboard based on the display data.

According to Aspect 24, an information providing method includes displaying the contents using the display method of Aspect 1.

According to Aspect 25, the information providing method of Aspect 24 further includes causing a device that communicates with the information processing apparatus to display the one or more contents extracted based on a request, a question, or a keyword input to the device by a user.

According to Aspect 26, the information providing method of Aspect 25 further includes aggregating the one or more contents extracted based on the request, the question, or the keyword in the display region and then causing the device that communicates with the information processing apparatus to display the one or more contents.

According to Aspect 27, the information providing method of Aspect 26 includes causing the device that communicates with the information processing apparatus to display the one or more contents related to the request, the question, or the keyword so that the ratio of the one or more contents occupying the display region becomes high.

According to Aspect 28, the information providing method of Aspect 24 includes aggregating and displaying the one or more contents related to the request, the question, or the keyword on both sides or in the center of the display region.

According to Aspect 29, in the information providing method of Aspect 25, the request, the question, or the keyword is input by voice.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A method comprising:
displaying contents input to a display extension region in response to scrolling of a display region;
extracting one or more contents from the contents input to the display extension region based on one or more types of the contents; and
aggregating the one or more contents in the display region.

2. The method according to claim 1, wherein the extracting includes:
receiving selection of the types of the contents from a user; and
extracting the one or more contents corresponding to the types selected by the user from among the contents input to the display extension region.

3. The method according to claim 2, further comprising:
displaying a list of the types of the contents present in the display extension region; and
receiving the selection of the types out of the list.

4. The method according to claim 1, further comprising,
in a case that the one or more contents aggregated in the display region do not fit within the display region, reducing sizes of the one or more contents to fit the one or more contents within the display region.

5. The method according to claim 2, wherein
each of the one or more contents includes:
position information indicating a position of the content relative to an origin; and
size information indicating a size of the content, and
the aggregating includes displaying the one or more contents corresponding to the types of the contents selected by the user to fit the one or more contents within the display region using the position information and the size information.

6. The method according to claim 5, wherein
the position information of each of the one or more contents indicates a predetermined edge portion of the content.

7. The method according to claim 6, wherein
the size information is calculated based on the information indicating the predetermined edge portion of the content and information indicating another edge portion of the content.

8. The method according to claim 7, wherein
the size information is calculated based on a difference between the information indicating the predetermined edge portion and the information indicating the another edge portion.

9. The method according to claim 8, wherein:
the size information includes, in addition to the information indicating the predetermined edge portion and the information indicating the another edge portion, information indicating still another edge portion different from the predetermined edge portion and the another edge portion; and
the size information includes second size information calculated based on the information indicating the predetermined edge portion and the information indicating the still another edge portion.

10. The method according to claim 9, wherein
the second size information is calculated based a difference between the information indicating the predetermined edge portion and the information indicating the still another edge portion.

11. The method according to claim 10, further comprising:
arranging the one or more contents according to a predetermined rule; and
displaying the one or more contents in the display region.

12. The method according to claim 11, wherein
the predetermined rule is changing the size of each of the one or more contents based on the size information of each of the one or more contents and displaying the one or more contents in the display region.

13. The method according to claim 2, further comprising
grouping the one or more contents corresponding to the types selected by the user.

14. The method according to claim 1, further comprising,
in a case that a content is input to the display region, determining a type of a content input to the display region and registering, in association with the content, the determined type in a content management table.

15. The method according to claim 3, comprising:
receiving input of a keyword from the user;
extracting the one or more contents that match the keyword and correspond to the types selected by the user from among the contents input to the display extension region; and
aggregating the extracted one or more contents in the display region.

16. The method according claim 1, further comprising:
communicating with a plurality of devices;
transmitting display data of the one or more contents aggregated in the display region to the plurality of devices to allow the plurality of devices to display the one or more of the contents based on the display data.

17. The method according to claim 1, further comprising:
storing, in association with the contents, identification information of a user who adds or edits the contents;
in a case that selection of the type of the contents and selection of the identification information of the user who adds or edits the contents are received, extracting the one or more contents that are associated with the user and correspond to the type selected by the user from among the contents input to the display extension region; and
aggregating the extracted one or more contents in the display region.

18. The method according to claim 16, further comprising,
in a case that a device from which input to the display extension region is being received is detected, causing other devices to display, in association with the device, information indicating that the input is being received.

19. The method according to claim 18, wherein
the input includes hand drafted input.

20. The method according to claim 18, comprising:
receiving image data obtained by capturing images of users of the plurality of devices from the plurality of devices; and
causing the other devices to display, in association with the image data transmitted from the device from which the input is being received, the information indicating that the input is being received.

21. The method according to claim 18, further comprising:
in a case that the device receives selection of display of the information indicating that the input is being received and a request for acquiring the contents that the device is displaying in a whiteboard region is received from the other devices, transmitting display data of the contents in the whiteboard region of the device to the other devices that receive the selection of the display;
reducing sizes of the contents representing the display data;
causing the other devices to display the contents based on the display data;
displaying a display component for receiving enlargement; and
in response to receiving pressing of the display component, enlarging the contents representing the display data and displaying the contents based on the display data.

22. The method according to claim 18, comprising,
in a case that the device receives selection of display of the information indicating that the input is being received, transmitting display data of the contents that have been input or are being input from the device to the other devices that receive the selection of the display and causing the other devices to display the contents that have been input or are being input.

23. The method according to claim 18, comprising:
in a case that the device receives selection of display of the information indicating that hand drafted input is being received and a request for acquiring the contents that the device is displaying in a whiteboard region is received from the other devices, transmitting display data of the contents in the whiteboard region of the device to the other devices that receive the selection of the display; and
causing the other devices to display the contents based on the display data.

24. The method according to claim 1, further comprising
causing a device that communicates with an information processing apparatus to display the one or more contents extracted based on a request, a question, or a keyword input to the device by a user.

25. The method according to claim 24, further comprising
causing the device to display the one or more contents having been aggregated.

26. The method according to claim 25, wherein
the causing the device includes causing the device to display the one or more contents related to the request, the question, or the keyword such that a ratio of the one or more contents that have a higher relationship to the request, the question, or the keyword and occupy the display region to the entire display region becomes higher than that of the another one or more contents that have a less relationship to the request, the question, or the keyword and occupy the display region to the entire display region.

27. The method according to claim 25, wherein
the aggregating includes aggregating and displaying the one or more contents related to the request, the question, or the keyword on both sides or in a center of the display region.

28. The method according to claim 24, wherein
the request, the question, or the keyword is input by voice.

29. A display system comprising:
a first information processing apparatus comprising first circuitry configured to display contents input to a display extension region in response to scrolling of a display region; and
a second information processing apparatus communicable with the first information processing apparatus via a network,
the second information processing apparatus comprising second circuitry configured to display a virtual whiteboard synchronized with the display region and a virtual space in which the contents moved to the display extension region are arranged, the second circuitry being further configured to:
extract one or more contents from the contents arranged in the virtual space based on one or more types of the contents; and
aggregate the one or more contents on the virtual whiteboard, and the first circuitry being further configured to:
receive display data of the one or more contents aggregated on the virtual whiteboard from the second information processing apparatus; and
display the one or more contents based on the display data.

30. The display system according to claim 29, wherein:
the second information processing apparatus is communicable with a communication terminal via the network; and
the second circuitry is further configured to:
arrange a screen image representing screen data transmitted from the communication terminal in the virtual space;
copy the screen image onto the virtual whiteboard; and
share the screen image with the first information processing apparatus.

31. The display system according to claim 30, wherein
the second circuitry is further configured to:
receive swipe information on an operation of swiping the contents displayed by the first information processing apparatus based on the screen data to the display extension region;
move the contents representing the screen data copied to the virtual whiteboard to the virtual space different from the virtual whiteboard based on the swipe information; and
cause the virtual whiteboard to return to a blank state.

32. The display system according to claim 29, further comprising
a head-mounted display communicably connected to the second information processing apparatus via a network, the display comprising third circuitry configured to:
receive the display data of the one or more contents aggregated in the display region; and
cause the one of more contents to be displayed based on the display data.

33. The display system according to claim 32, wherein
the third circuitry is configured to cause the one or more contents to be displayed so that the one or more contents fit within the display region according to size information calculated based on information indicating a predetermined edge portion of each of the one or more contents and information indicating another edge portion of each of the one or more contents.

34. The display system according to claim 32, wherein
the third circuitry is configured to:
cause a list of types of the contents present in the display extension region to be displayed; and
receive selection of the types of the contents from a user.

35. A display system comprising:
a first information processing apparatus comprising first circuitry configured to display contents input to a display extension region in response to scrolling of a display region; and
a second information processing apparatus communicably connected to the first information processing apparatus via a network,
the first circuitry being configured to:
receive from the second information processing apparatus display data of the contents input to the display extension region;
extract one or more contents including the contents representing the display data received from the second information processing apparatus from among the contents input to the display extension region based on one or more types of the contents;
aggregate the one or more contents in the display region; and
cause the one or more contents to be displayed.

36. An information processing apparatus comprising
circuitry configured to;
display contents input to a display extension region in response to scrolling of a display region;
extract one or more contents from the contents input to the display extension region based on one or more types of the contents;
aggregate the one or more contents in the display region; and
cause the one or more contents to be displayed.
